(19) United States
(12) Patent Application Publication
(10) Pub. No.: US 2026/0147187 A1
(43) Pub. Date: May 28, 2026

(54) IMAGE CAPTURING OPTICAL LENS ASSEMBLY, IMAGING APPARATUS AND ELECTRONIC DEVICE

(71) Applicant: LARGAN PRECISION CO., LTD., Taichung City (TW)

(72) Inventors: Cheng-Chen LIN, Taichung City (TW); Chun-Yen CHEN, Taichung City (TW); Yu-Han SHIH, Taichung City (TW)

(21) Appl. No.: 19/392,284

(22) Filed: Nov. 18, 2025

(30) Foreign Application Priority Data
Nov. 22, 2024 (TW) 113145232

(51) Int. Cl. G02B 13/00; G02B 9/64

(52) U.S. Cl. CPC G02B 13/0045; G02B 9/64

(57) ABSTRACT

An image capturing optical lens assembly includes eight lens elements, which are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface towards the object side and an image-side surface towards the image side. The object-side surface of the second lens element is concave in a paraxial region thereof. The image-side surface of the second lens element is convex in a paraxial region thereof. The third lens element has positive refractive power. The image-side surface of the fifth lens element is concave in a paraxial region thereof. The eighth lens element has negative refractive power.

### RELATED APPLICATIONS

This application claims priority to Taiwan Application Serial Number 113145232, filed Nov. 22, 2024, which is herein incorporated by reference.

### BACKGROUND

### Technical Field

The present disclosure relates to an image capturing optical lens assembly and an imaging apparatus. More particularly, the present disclosure relates to an image capturing optical lens assembly and an imaging apparatus with compact size applicable to electronic devices.

### Description of Related Art

With recent technology of semiconductor process advances, performances of image sensors are enhanced, so that the smaller pixel size can be achieved. Therefore, optical lens assemblies with high image quality have become an indispensable part of many modern electronics. With rapid developments of technology, applications of electronic devices equipped with optical lens assemblies increase and there is a wide variety of requirements for optical lens assemblies. However, in a conventional optical lens assembly, it is hard to balance among image quality, sensitivity, aperture size, volume or field of view. Thus, there is a demand for an image capturing system lens assembly that meets the aforementioned needs.

### SUMMARY

According to one aspect of the present disclosure, an image capturing optical lens assembly includes eight lens elements, which are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface towards the object side and an image-side surface towards the image side. Preferably, the object-side surface of the second lens element is concave in a paraxial region thereof. Preferably, the image-side surface of the second lens element is convex in a paraxial region thereof. Preferably, the third lens element has positive refractive power. Preferably, the image-side surface of the fifth lens element is concave in a paraxial region thereof. Preferably, the eighth lens element has negative refractive power. Preferably, the image-side surface of the eighth lens element is concave in a paraxial region thereof. Preferably, the image-side surface of the eighth lens element includes at least one inflection point. When an axial distance between the first lens element and the second lens element is T12, an axial distance between the fourth lens element and the fifth lens element is T45, an axial distance between the fifth lens element and the sixth lens element is T56, an axial distance between the image-side surface of the eighth lens element and an image surface is BL, a focal length of the image capturing optical lens assembly is f, and a curvature radius of the object-side surface of the second lens element is R3, the following conditions are preferably satisfied: 0<T45/T56<0.75; 0.20<BL/T12<0.95; and −1.30<R3/f<−0.25.

According to one aspect of the present disclosure, an imaging apparatus includes the image capturing optical lens assembly of the aforementioned aspect and an image sensor, wherein the image sensor is disposed on the image surface of the image capturing optical lens assembly.

According to one aspect of the present disclosure, an image capturing optical lens assembly includes eight lens elements, which are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface towards the object side and an image-side surface towards the image side. Preferably, the object-side surface of the second lens element is concave in a paraxial region thereof. Preferably, the image-side surface of the second lens element is convex in a paraxial region thereof. Preferably, the third lens element has positive refractive power. Preferably, the object-side surface of the third lens element is convex in a paraxial region thereof. Preferably, the fifth lens element has negative refractive power. Preferably, the image-side of the fifth lens element is concave in a paraxial region thereof. Preferably, the eighth lens element has negative refractive power. When an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, an axial distance between the fifth lens element and the sixth lens element is T56, an axial distance between the sixth lens element and the seventh lens element is T67, an axial distance between the seventh lens element and the eighth lens element is T78, a maximum among T12, T23, T34, T45, T56, T67, T78 is ATmax, a central thickness of the first lens element is CT1, a central thickness of the second lens element is CT2, a central thickness of the third lens element is CT3, a central thickness of the fourth lens element is CT4, a central thickness of the fifth lens element is CT5, a central thickness of the sixth lens element is CT6, a central thickness of the seventh lens element is CT7, a central thickness of the eighth lens element is CT8, a maximum among CT1, CT2, CT3, CT4, CT5, CT6, CT7, CT8 is CTmax, a focal length of the image capturing optical lens assembly is f, and a curvature radius of the object-side surface of the seventh lens element is R13, the following conditions are preferably satisfied: 0<T45/T56<1.00; 0<(T23+T34+T45)/T12<0.65; −1.80<f/R13<0.30; and 0.15<CTmax/ATmax<1.20.

According to one aspect of the present disclosure, an electronic device includes an imaging apparatus. The imaging apparatus includes an image capturing optical lens assembly of the aforementioned aspect and an image sensor, wherein the image sensor is disposed on an image surface of the image capturing optical lens assembly.

### BRIEF DESCRIPTION OF THE DRAWINGS

The present disclosure can be more fully understood by reading the following detailed description of the embodiment, with reference made to the accompanying drawings as follows:

FIG. 1 is a schematic view of an imaging apparatus according to the 1st embodiment of the present disclosure.

FIG. 2 shows spherical aberration curves, astigmatic field curves and a distortion curve of the imaging apparatus according to the 1st embodiment.

FIG. 3 is a schematic view of an imaging apparatus according to the 2nd embodiment of the present disclosure.

FIG. 4 shows spherical aberration curves, astigmatic field curves and a distortion curve of the imaging apparatus according to the 2nd embodiment.

FIG. 5 is a schematic view of an imaging apparatus according to the 3rd embodiment of the present disclosure.

FIG. 6 shows spherical aberration curves, astigmatic field curves and a distortion curve of the imaging apparatus according to the 3rd embodiment.

FIG. 7 is a schematic view of an imaging apparatus according to the 4th embodiment of the present disclosure.

FIG. 8 shows spherical aberration curves, astigmatic field curves and a distortion curve of the imaging apparatus according to the 4th embodiment.

FIG. 9 is a schematic view of an imaging apparatus according to the 5th embodiment of the present disclosure.

FIG. 10 shows spherical aberration curves, astigmatic field curves and a distortion curve of the imaging apparatus according to the 5th embodiment.

FIG. 11 is a schematic view of an imaging apparatus according to the 6th embodiment of the present disclosure.

FIG. 12 shows spherical aberration curves, astigmatic field curves and a distortion curve of the imaging apparatus according to the 6th embodiment.

FIG. 13 is a schematic view of an imaging apparatus according to the 7th embodiment of the present disclosure.

FIG. 14 shows spherical aberration curves, astigmatic field curves and a distortion curve of the imaging apparatus according to the 7th embodiment.

FIG. 15 is a schematic view of an imaging apparatus according to the 8th embodiment of the present disclosure.

FIG. 16 shows spherical aberration curves, astigmatic field curves and a distortion curve of the imaging apparatus according to the 8th embodiment.

FIG. 17 is a schematic view of an imaging apparatus according to the 9th embodiment of the present disclosure.

FIG. 18 shows spherical aberration curves, astigmatic field curves and a distortion curve of the imaging apparatus according to the 9th embodiment.

FIG. 19 is a schematic view of an imaging apparatus according to the 10th embodiment of the present disclosure.

FIG. 20 shows spherical aberration curves, astigmatic field curves and a distortion curve of the imaging apparatus according to the 10th embodiment.

FIG. 21 is a schematic view of an imaging apparatus according to the 11th embodiment of the present disclosure.

FIG. 22 shows spherical aberration curves, astigmatic field curves and a distortion curve of the imaging apparatus according to the 11th embodiment.

FIG. 23 is a schematic view of an imaging apparatus according to the 12th embodiment of the present disclosure.

FIG. 24 shows spherical aberration curves, astigmatic field curves and a distortion curve of the imaging apparatus according to the 12th embodiment.

FIG. 25 is a schematic view of an imaging apparatus according to the 13th embodiment of the present disclosure.

FIG. 26 shows spherical aberration curves, astigmatic field curves and a distortion curve of the imaging apparatus according to the 13th embodiment.

FIG. 27 is a schematic view of the inflection points and the critical points of each lens element according to the 1st embodiment.

FIG. 28 is a schematic view of parameters according to the 1st embodiment.

FIG. 29 is a schematic view of an imaging apparatus according to the 14th embodiment of the present disclosure.

FIG. 30A is a schematic view of one side of an electronic device according to the 15th embodiment of the present disclosure.

FIG. 30B is a schematic view of another side of the electronic device of FIG. 30A.

FIG. 30C is a system schematic view of the electronic device of FIG. 30A.

FIG. 31 is a schematic view of one side of an electronic device according to the 16th embodiment of the present disclosure.

FIG. 32 is a schematic view of one side of an electronic device according to the 17th embodiment of the present disclosure.

FIG. 33A is a schematic view of one side of an electronic device according to the 18th embodiment of the present disclosure.

FIG. 33B is a schematic view of another side of the electronic device according to the 18th embodiment of FIG. 33A.

FIG. 34 is a schematic view of one side of an electronic device according to the 19th embodiment of the present disclosure.

FIG. 35 is a schematic view of one side of an electronic device according to the 20th embodiment of the present disclosure.

FIG. 36 is a schematic view of an arrangement of a light path folding element in the image capturing optical lens assembly of the present disclosure.

### DETAILED DESCRIPTION

An image capturing optical lens assembly includes eight lens elements, which are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface towards the object side and an image-side surface towards the image side.

The object-side surface of the second lens element can be concave in a paraxial region thereof, so that it is favorable for correcting spherical aberration by controlling the shape of the object-side surface of the second lens element. The image-side surface of the second lens element can be convex in a paraxial region thereof, so that it is favorable for avoiding the light divergence and correcting astigmatism.

The third lens element can have positive refractive power, so that it is favorable for avoiding the excessive total track length by adjusting field of view and balancing the refractive power on the object end of the image capturing optical lens assembly. The object-side surface of the third lens element can be convex in a paraxial region thereof, so that it is favorable for correcting aberrations by enhancing the light converging ability of the third lens element.

The fifth lens element can be negative refractive power, so that it is favorable for enlarging the image surface by adjusting the light traveling direction. The image-side surface of the fifth lens element can be concave in a paraxial region thereof, so that it is favorable for enlarging the image surface by balancing the light traveling direction.

The seventh lens element can have positive refractive power, so that it is favorable for balancing the refractive power on the image end of the image capturing optical lens assembly so as to correct aberrations. The image-side surface of the seventh lens element can be convex in a paraxial region thereof, so that it is favorable for compressing the volume of the image end of the image capturing optical lens assembly by adjusting the exiting direction of light from the seventh lens element.

The eighth lens element can have negative refractive power, so that it is favorable for decreasing the back focal length of the image capturing optical lens assembly by controlling the light traveling direction. The image-side surface of the eighth lens element can be concave in a paraxial region thereof, so that it is favorable for compressing the back focal length and correcting field curves.

The image-side surface of the eighth lens element can include at least one inflection point. Therefore, it is favorable for adjusting the light path in the peripheral area so as to prevent the image from vignette in the peripheral area thereof and correct aberrations.

The image-side surface of the eighth lens element can include at least one critical point. Therefore, it is favorable for controlling the exiting angle of light from the peripheral area thereof so as to improve the curvature and distortion of the image surface and enhance the image quality.

When an axial distance between the fourth lens element and the fifth lens element is T45, and an axial distance between the fifth lens element and the sixth lens element is T56, the following condition is satisfied: 0<T45/T56<1.00. Therefore, the space arrangement of the fifth lens element can be adjusted for aligning with the entire surface design, and the difficulty of the assembling can be reduced. Further, the following condition can be satisfied: 0<T45/T56<0.75. Further, the following condition can be satisfied: 0<T45/T56<0.60. Further, the following condition can be satisfied: 0.01<T45/T56<0.45. Further, the following condition can be satisfied: 0.03≤T45/T56≤0.37.

When an axial distance between the first lens element and the second lens element is T12, and an axial distance between the image-side surface of the eighth lens element and the image surface is BL, the following condition is satisfied: 0.20<BL/T12<0.95. Therefore, it is favorable for reducing the back focal length, and avoiding excessive volume of the image capturing optical lens assembly causing the difficulty to reduce the equipment. Further, the following condition can be satisfied: 0.25<BL/T12<0.90. Further, the following condition can be satisfied: 0.30<BL/T12<0.85. Further, the following condition can be satisfied: 0.35≤BL/T12≤0.81.

When a focal length of the image capturing optical lens assembly is f, and a curvature radius of the object-side surface of the second lens element is R3, the following condition is satisfied: −1.30<R3/f<−0.25. Therefore, it is favorable for correcting spherical aberration of the image capturing optical lens assembly by adjusting the curvature degree of the shape of the object-side surface of the second lens element. Further, the following condition can be satisfied: −1.00<R3/f<−0.30. Further, the following condition can be satisfied: −0.80<R3/f<−0.40. Further, the following condition can be satisfied: −0.75≤R3/f≤−0.48.

When the axial distance between the first lens element and the second lens element is T12, an axial distance between the second lens element and the third lens element is T23, an axial distance between the third lens element and the fourth lens element is T34, and the axial distance between the fourth lens element and the fifth lens element is T45, the following condition is satisfied: 0<(T23+T34+T45)/T12<0.65. Therefore, it is favorable for guiding the light from the object end of the image capturing optical lens assembly and restricting the distance between the first lens element and the second lens element by adjusting the arrangement of the space between the adjacent lens elements so as to compress the total track length. Further, the following condition can be satisfied: 0<(T23+T34+T45)/T12<0.50. Further, the following condition can be satisfied: 0.03<(T23+T34+T45)/T12<0.35. Further, the following condition can be satisfied: 0.05≤(T23+T34+T45)/T12≤0.28.

When the focal length of the image capturing optical lens assembly is f, and a curvature radius of the object-side surface of the seventh lens element is R13, the following condition is satisfied: −1.80<f/R13<0.30. Therefore, it is favorable for obtaining balance between enlarging the image surface and reducing the back focal length by adjusting the surface and refractive power of the object-side surface of the seventh lens element. Further, the following condition can be satisfied: −1.60<f/R13<0.10. Further, the following condition can be satisfied: −1.40<f/R13<0. Further, the following condition can be satisfied: −1.25<f/R13<−0.15. Further, the following condition can be satisfied: −1.06≤f/R13≤0.05.

When the axial distance between the first lens element and the second lens element is T12, the axial distance between the second lens element and the third lens element is T23, the axial distance between the third lens element and the fourth lens element is T34, the axial distance between the fourth lens element and the fifth lens element is T45, the axial distance between the fifth lens element and the sixth lens element is T56, an axial distance between the sixth lens element and the seventh lens element is T67, an axial distance between the seventh lens element and the eighth lens element is T78, a maximum among T12, T23, T34, T45, T56, T67, T78 is ATmax, a central thickness of the first lens element is CT1, a central thickness of the second lens element is CT2, a central thickness of the third lens element is CT3, a central thickness of the fourth lens element is CT4, a central thickness of the fifth lens element is CT5, a central thickness of the sixth lens element is CT6, a central thickness of the seventh lens element is CT7, a central thickness of the eighth lens element is CT8, a maximum among CT1, CT2, CT3, CT4, CT5, CT6, CT7, CT8 is CTmax, the following condition is satisfied: 0.15<CTmax/ATmax<1.20. Therefore, it is favorable for increasing the space utilization rate and also avoiding excessive total track length. Further, the following condition can be satisfied: 0.25<CTmax/ATmax<1.10. Further, the following condition can be satisfied: 0.36≤CTmax/ATmax≤0.98.

When half of a maximum field of view of the image capturing optical lens assembly is HFOV, the following condition is satisfied: 0.70<tan(HFOV)<1.45. Therefore, it is favorable for meeting the requirement of field of view of the device so as to satisfy further variable applications. Further, the following condition can be satisfied: 0.80<tan(HFOV)<1.35.

The image capturing optical lens assembly can further include an aperture stop located between the first lens element and the fifth lens element. Therefore, it is favorable for obtaining the balance among the image size, expansion of field of view and the peripheral illumination. Further, the aperture stop can be further located between the second lens element and the fourth lens element.

When the focal length of the image capturing optical lens assembly is f, and an entrance pupil diameter of the image capturing optical lens assembly is EPD, the following condition is satisfied: 1.20<f/EPD<2.00. Therefore, the image capturing optical lens assembly can obtain the arrangement of larger aperture, and it is favorable for obtaining the balance between the illumination and the depth of field. Further, the following condition can be satisfied: 1.40<f/EPD<1.90.

When a focal length of the third lens element is f3, and a focal length of the fourth lens element is f4, the following condition is satisfied: −0.30<f3/f4<2.60. Therefore, the proportion between the third lens element and the fourth lens element can be controlled, it is favorable for balancing the convergence or divergence of light so as to enhance the light converging quality of the entire field of view. Further, the following condition can be satisfied: −0.10<f3/f4<2.30. Further, the following condition can be satisfied: 0<f3/f4<2.00.

When an Abbe number of the third lens element is V3, and an Abbe number of the seventh lens element is V7, the following condition is satisfied: 0.20<V7/V3<0.90. Therefore, it is favorable for reducing aberrations, such as chromatic aberration, etc. by matching the material of the third lens element and the seventh lens element so as to enhance the image quality.

When the entrance pupil diameter of the image capturing optical lens assembly is EPD, and the maximum image height of the image capturing optical lens assembly is ImgH, the following condition is satisfied: 0.35<EPD/ImgH<0.90. Therefore, the diameter of the light aperture can be enlarged for increasing the light amount so as to increase the image brightness. Further, the following condition can be satisfied: 0.40<EPD/ImgH<0.80.

When the focal length of the image capturing optical lens assembly is f, and the maximum image height of the image capturing optical lens assembly is ImgH, the following condition is satisfied: 0.50<f/ImgH<1.50. Therefore, it is favorable for obtaining the balance among the specifications, such as total track length, aperture, field of view and image size, etc. Further, the following condition can be satisfied: 0.70<f/ImgH<1.30. Further, the following condition can be satisfied: 0.60<f/ImgH<1.40.

When a focal length of the first lens element is f1, and a focal length of the eighth lens element is f8, the following condition is satisfied: −0.25<f8/f1<0.65. Therefore, it is favorable for balancing the arrangement of refractive power of the image capturing optical lens assembly, and favorable for obtaining the balance between the field of view and the volume. Further, the following condition can be satisfied: −0.10<f8/f1<0.55.

When a curvature radius of the image-side surface of the second lens element is R4, and a curvature radius of the object-side surface of the third lens element is R5, the following condition is satisfied: −1.30<R4/R5<−0.40. Therefore, it is favorable for correcting spherical aberration and coma aberration by cooperating the second lens element and the third lens element so as to enhance the image clarity. Further, the following condition can be satisfied: −1.20<R4/R5<−0.50.

When the curvature radius of the object-side surface of the second lens element is R3, and a curvature radius of the object-side surface of the fourth lens element is R7, the following condition is satisfied: −1.50<(R3+R7)/(R3−R7)<0. Therefore, it is favorable for balancing the light path on the object end of the image capturing optical lens assembly so as to correct aberrations. Further, the following condition can be satisfied: −1.35<(R3+R7)/(R3−R7)<0.

When the focal length of the image capturing optical lens assembly is f, and a focal length of the second lens element is f2, the following condition is satisfied: −0.40<f/f2<0.30. Therefore, it is favorable for balancing aberrations, such as spherical aberration and chromatic aberration, etc. generated by the first lens element. Further, the following condition can be satisfied: −0.30<f/f2<0.20.

When the focal length of the image capturing optical lens assembly is f, the curvature radius of the object-side surface of the second lens element is R3, the curvature radius of the image-side surface of the second lens element is R4, and a curvature radius of the image-side surface of the eighth lens element is R16, the following condition is satisfied: 0.80<(|R3|+|R4|+R16)/f<2.70. Therefore, it is favorable for correcting spherical aberration and image curvature by matching the surface shape of the second lens element and the eighth lens element. Further, the following condition can be satisfied: 1.10<(|R3|+|R4|+R16)/f<2.50. Further, the following condition can be satisfied: 1.30<(|R3|+|R4|+R16)/f<2.20. Further, the following condition can be satisfied: 1.44≤(|R3|+|R4|+R16)/f≤1.94.

When a maximum effective radius of the object-side surface of the seventh lens element is Y7R1, and a maximum effective radius of the image-side surface of the eighth lens element is Y8R2, the following condition is satisfied: 1.40<Y8R2/Y7R1<2.20. Therefore, it is favorable for adjusting the light traveling direction in the peripheral area on the image end of the image capturing optical lens assembly so as to enlarge the image surface. Further, the following condition can be satisfied: 1.50<Y8R2/Y7R1<2.00.

When a displacement in parallel with an optical axis from an axial vertex on the image-side surface of the third lens element to a maximum effective radius position on the image-side surface of the third lens element is SAG3R2, and the central thickness of the third lens element is CT3, the following condition is satisfied: −0.50<SAG3R2/CT3<0.30. Therefore, it is favorable for compressing the volume in the peripheral area of the image capturing optical lens assembly by controlling the curvature degree of the surface shape in the peripheral area of the image side of the third lens element. Further, the following condition can be satisfied: −0.40<SAG3R2/CT3<0.20.

When a displacement in parallel with an optical axis from an axial vertex on the object-side surface of the seventh lens element to a maximum effective radius position on the object-side surface of the seventh lens element is SAG7R1, and the central thickness of the seventh lens element is CT7, the following condition is satisfied: −2.00<SAG7R1/CT7<−0.50. Therefore, it is favorable for effectively controlling the curvature degree of the surface shape in the peripheral area of the object side of the third lens element, so that the light deflection angle on the image end of the image capturing optical lens assembly can be adjusted and the formability of the lens element can be ensured. Further, the following condition can be satisfied: −1.95<SAG7R1/CT7<−0.60.

When a curvature radius of the object-side surface of the fifth lens element is R9, and the curvature radius of the image-side surface of the eighth lens element is R16, the following condition is satisfied: −0.60<R16/R9<0.30. Therefore, it is favorable for adjusting the light traveling path by cooperating the fifth lens element and the eighth lens element so as to reduce distortion, decrease effect of the back focal length and enhance the light convergence quality. Further, the following condition can be satisfied: −0.40<R16/R9<0.20.

When an axial distance between the aperture stop and the image-side surface of the eighth lens element is SD, and the axial distance between the image-side surface of the eighth lens element and an image surface is BL, the following condition is satisfied: 0.05<BL/SD<0.35. Therefore, it is favorable for controlling the volume under the specification requirement of the image capturing optical lens assembly, and is favorable for compressing the total track length under desirable image quality. Further, the following condition can be satisfied: 0.10<BL/SD<0.30.

When the central thickness of the third lens element is CT3, and the central thickness of the fifth lens element is CT5, the following condition is satisfied: 0.80<CT3/CT5<4.00. Therefore, it is favorable for reducing the volume of the image capturing optical lens assembly, and also reducing the manufacturing tolerance. Further, the following condition can be satisfied: 0.90<CT3/CT5<3.50.

When the axial distance between the sixth lens element and the seventh lens element is T67, the axial distance between the seventh lens element and the eighth lens element is T78, the central thickness of the first lens element is CT1, and the central thickness of the eighth lens element is CT8, and the following condition is satisfied: 0.20<(T67+T78)/(CT1+CT8)<2.00. Therefore, it is favorable for controlling the total track length and balancing the space arrangement of the lens elements so as to optimize assembling of the image capturing optical lens assembly and increase the yield rate. Further, the following condition can be satisfied: 0.30<(T67+T78)/(CT1+CT8)<1.80.

When the Abbe number of the third lens element is V3, and an Abbe number of the fourth lens element is V4, the following condition is satisfied: 0.60<V3/V4<1.40. Therefore, it is favorable for balancing the light converging ability at difference wavebands and correcting chromatic aberration by adjusting the light path of the image capturing optical lens assembly. Further, the following condition can be satisfied: 0.70<V3/V4<1.30.

When an axial distance between the aperture stop and the image surface is SL, and an axial distance between the object-side surface of the first lens element and the image surface is TL, the following condition is satisfied: 0.55<SL/TL<0.80. Therefore, the location of the aperture stop can be adjusted for enhancing the relative illumination in the peripheral field of view and the image quality, so that it is favorable for obtaining the balance among the illumination, the depth of field and the image size.

When a distance in parallel with an optical axis between a maximum effective radius position on the object-side surface of the first lens element and a maximum effective radius position on the image-side surface of the first lens element is ET1, and a distance in parallel with the optical axis between a maximum effective radius position on the object-side surface of the eighth lens element and a maximum effective radius position on the image-side surface of the eighth lens element is ET8, the following condition is satisfied: 0.35<ET8/ET1<2.50. Therefore, it is favorable for controlling the light traveling directions in the peripheral area of the object end and the image end of the image capturing optical lens assembly, and also favorable for controlling the size of the outer diameter. Further, the following condition can be satisfied: 0.40<ET8/ET1<2.40.

When an incident angle between a chief ray in a maximum field of view of the image capturing optical lens assembly and an image surface is CRA, the following condition is satisfied: 0.50<tan(CRA)<1.00. Therefore, too low illumination in the peripheral area of the image can be avoided, and it is favorable for enhancing the image clarity and the response efficiency of the image sensor. Further, the following condition can be satisfied: 0.55<tan(CRA)<0.90.

When a displacement in parallel with an optical axis from an axial vertex on the object-side surface of the second lens element to a maximum effective radius position on the object-side surface of the second lens element is SAG2R1, and the central thickness of the second lens element is CT2, the following condition is satisfied: −2.00<SAG2R1/CT2<−0.50. Therefore, it is favorable for obtaining the balance between the field of view and the manufacturing by effectively controlling the curvature degree of the shape in the peripheral area of the object-side surface of the second lens element. Further, the following condition can be satisfied: −1.90<SAG2R1/CT2<−0.70.

When a displacement in parallel with the optical axis from an axial vertex on the object-side surface of the eighth lens element to a maximum effective radius position on the object-side surface of the eighth lens element is SAG8R1, and the central thickness of the eighth lens element is CT8, the following condition is satisfied: −3.00<SAG8R1/CT8<0.10. Therefore, it is favorable for correcting the distortion and field curvature by controlling the curvature degree of the shape in the peripheral area of the object-side surface of the eighth lens element. Further, the following condition can be satisfied: −2.80<SAG8R1/CT8<0.

Each of the aforementioned features of the image capturing optical lens assembly can be utilized in various combinations for achieving the corresponding effects.

According to the image capturing optical lens assembly of the present disclosure, the lens elements thereof can be made of glass or plastic materials. When the lens elements are made of glass materials, the distribution of the refractive power of the image capturing optical lens assembly may be more flexible to design. The glass lens element can either be made by grinding or molding. When the lens elements are made of plastic materials, manufacturing costs can be effectively reduced. Furthermore, surfaces of each lens element can be arranged to be aspheric (ASP), since the aspheric surface of the lens element is easy to form a shape other than a spherical surface so as to have more controllable variables for eliminating aberrations thereof, and to further decrease the required amount of lens elements in the image capturing optical lens assembly. Therefore, the total track length of the image capturing optical lens assembly can also be reduced. The aspheric surfaces may be formed by a plastic injection molding method, a glass molding method or other manufacturing methods.

According to the image capturing optical lens assembly of the present disclosure, additives can be selectively added into any one (or more) material of the lens elements so as to change the transmittance of the lens element in a particular wavelength range. Therefore, the stray light and chromatic aberration can be reduced. For example, the additives can have the absorption ability for light in a wavelength range of 600 nm-800 nm in the image capturing optical lens assembly so as to reduce extra red light or infrared light, or the additives can have the absorption ability for light in a wavelength range of 350 nm-450 nm in the image capturing optical lens assembly so as to reduce blue light or ultraviolet light. Therefore, additives can prevent the image from interfering by light in a particular wavelength range. Furthermore, the additives can be homogeneously mixed with the plastic material, and the lens elements can be made by the injection molding method. Moreover, the additives can be coated on the lens surfaces to provide the aforementioned effects.

According to the image capturing optical lens assembly of the present disclosure, when a surface of the lens element is aspheric, it indicates that entire optical effective region of the surface of the lens element or a part thereof is aspheric.

According to the image capturing optical lens assembly of the present disclosure, when the lens elements have surfaces being convex and the convex surface position is not defined, it indicates that the aforementioned surfaces of the lens elements can be convex in the paraxial region thereof. When the lens elements have surfaces being concave and the concave surface position is not been defined, it indicates that the aforementioned surfaces of the lens elements can be concave in the paraxial region thereof. In the image capturing optical lens assembly of the present disclosure, if the lens element has positive refractive power or negative refractive power, or the focal length of the lens element, all can be referred to the refractive power, or the focal length, in the paraxial region of the lens element.

According to the image capturing optical lens assembly of the present disclosure, a critical point is a non-axial point of the lens surface where its tangent is perpendicular to the optical axis; an inflection point is a point on a lens surface with a curvature changing from positive to negative or from negative to positive.

According to the image capturing optical lens assembly of the present disclosure, the image surface thereof, based on the corresponding image sensor, can be flat or curved. In particular, the image surface can be a concave curved surface facing towards the object side. Furthermore, the image capturing optical lens assembly of the present disclosure can selectively include at least one image correcting element (such as a field flattener) inserted between the lens element closest to the image surface and the image surface, thus the effect of correcting image aberrations (such as field curvature) can be achieved. The optical properties of the aforementioned image correcting element, such as curvature, thickness, refractive index, position, surface shape (convex or concave, spherical or aspheric, diffraction surface and Fresnel surface, etc.) can be adjusted corresponding to the demands of the imaging apparatus. Generally, a preferred configuration of the image correcting element is to dispose a thin plano-concave element having a concave surface toward the object side on the position closed to the image surface.

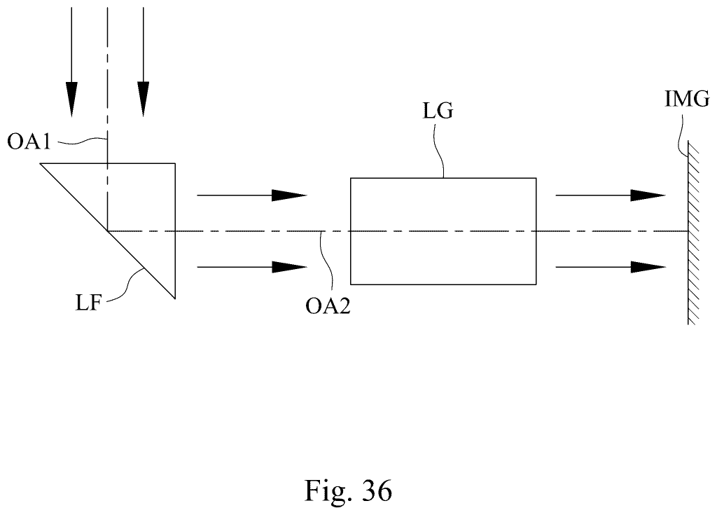

According to the image capturing optical lens assembly of the present disclosure, at least one element with light path folding function can be selectively disposed between the imaged object and the image surface, such as a prism or a mirror, etc., wherein the surface of the prism or the reflective surface of the mirror can be planar surface, spherical surface, aspheric surface or freedom curvature surface etc. Therefore, it is favorable for providing high flexible space arrangement of the image capturing optical lens assembly, so that the compactness of the electronic device would not be restricted by the optical total track length of the photographing system lens assembly. Furthermore, FIG. 36 is a schematic view of an arrangement of a light path folding element LF in the image capturing optical lens assembly of the present disclosure. In FIG. 36, the image capturing optical lens assembly includes, in order from an imaged object (not shown in drawings) to an image surface IMG, a first optical axis OA1, the light path folding element LF and a second optical axis OA2, wherein the light path folding element LF can be disposed between the imaged object and a lens group LG of the image capturing optical lens assembly as shown in FIG. 36. The image capturing optical lens assembly can also selectively include three or more light path folding elements, and the type, number and the location of the light path folding element of the present disclosure will not be limited thereto.

Furthermore, according to the image capturing optical lens assembly of the present disclosure, the image capturing optical lens assembly can include at least one stop, such as an aperture stop, a glare stop or a field stop, for eliminating stray light and thereby improving image resolution thereof.

According to the image capturing optical lens assembly of the present disclosure, an aperture control unit can be properly configured. The aperture control unit can be a mechanical element or a light controlling element, and the dimension and the shape of the aperture control unit can be electrically controlled. The mechanical element can include a moveable component such a blade group or a shielding plate. The light controlling element can include a screen component such as a light filter, an electrochromic material, a liquid crystal layer or the like. The amount of incoming light or the exposure time of the image can be controlled by the aperture control unit to enhance the image moderation ability. In addition, the aperture control unit can be the aperture stop of the image capturing optical lens assembly according to the present disclosure, so as to moderate the image quality by changing f-number such as changing the depth of field or the exposure speed.

According to the image capturing optical lens assembly of the present disclosure, one or more optical element can be properly configured so as to limit the way of light passing through the optical lens system. The aforementioned optical element can be a filter, a polarizer, etc., and it is not limited thereto. Moreover, the aforementioned optical element can be a single piece of element, a complex assembly or presented in a form of membrane, which is not limited thereto. The aforementioned optical element can be disposed at the object side, at the image side or between the lens elements of the image capturing optical lens assembly so as to allow the specific light to pass through, which will meet the requirements of applications.

The image capturing optical lens assembly according to the present disclosure can include at least one optical lens element, an optical element or a carrier. A low reflection layer is disposed on at least one surface of at least one optical lens element, the optical element or the carrier, wherein the low reflection layer is favorable for effectively reducing the stray light formed by the reflection of light on the interface. The low reflection layer can be disposed on the non-optically effective area of the object-side surface or the image-side surface of the optical lens element, or can be disposed on the connecting surface between the object-side surface or the image-side surface; wherein the optical element can be at least one of a light blocking element, an annular spacer element, a barrel element, a cover glass, a blue glass, a filter or a color filter, a light path folding element, a prism or a mirror, etc.; wherein the carrier can be a lens group lens mount, a micro lens disposed on the image sensor, the peripheral of the image sensor substrate or a glass sheet for protecting the image sensor, etc.

According to the image capturing optical lens assembly of the present disclosure, the image capturing optical lens assembly of the present disclosure can be applied to 3D (three-dimensional) image capturing applications, in products such as digital cameras, mobile devices, digital tablets, smart TVs, surveillance systems, motion sensing input devices, driving recording systems, rearview camera systems, wearable devices, unmanned aerial vehicles, and other electronic imaging products.

According to the present disclosure, an imaging apparatus including the aforementioned image capturing optical lens assembly and an image sensor is provided, wherein the image sensor is disposed on the image surface of the image capturing optical lens assembly. By satisfying the specific conditions, it is favorable for obtaining the compactness of the image capturing optical lens assembly, and maintaining high image quality. Moreover, the imaging apparatus can further include a barrel member, a holder member or a combination thereof.

According to the present disclosure, an electronic device including the aforementioned imaging apparatus is provided. Therefore, the image quality can be increased. Moreover, the electronic device can further include a control unit, a display, a storage unit, a random-access memory unit (RAM) or a combination thereof.

According to the above description of the present disclosure, the following specific embodiments are provided for further explanation.

### 1st Embodiment

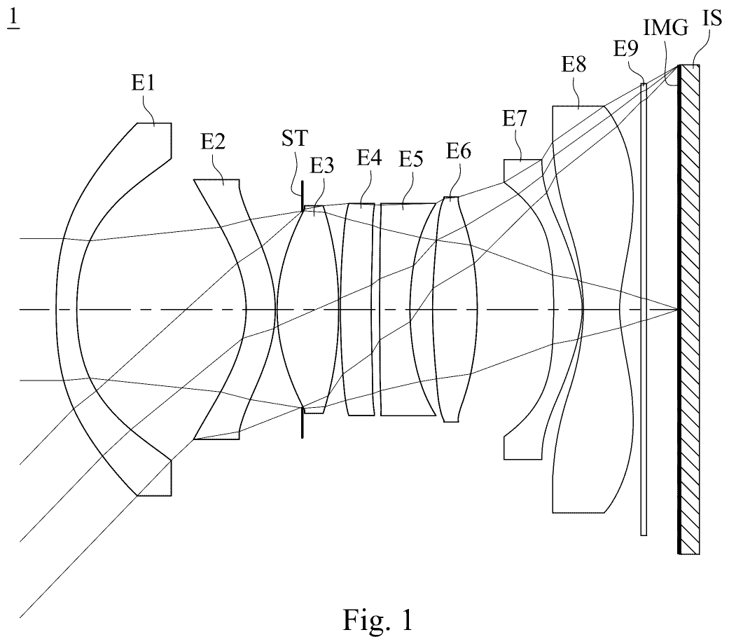

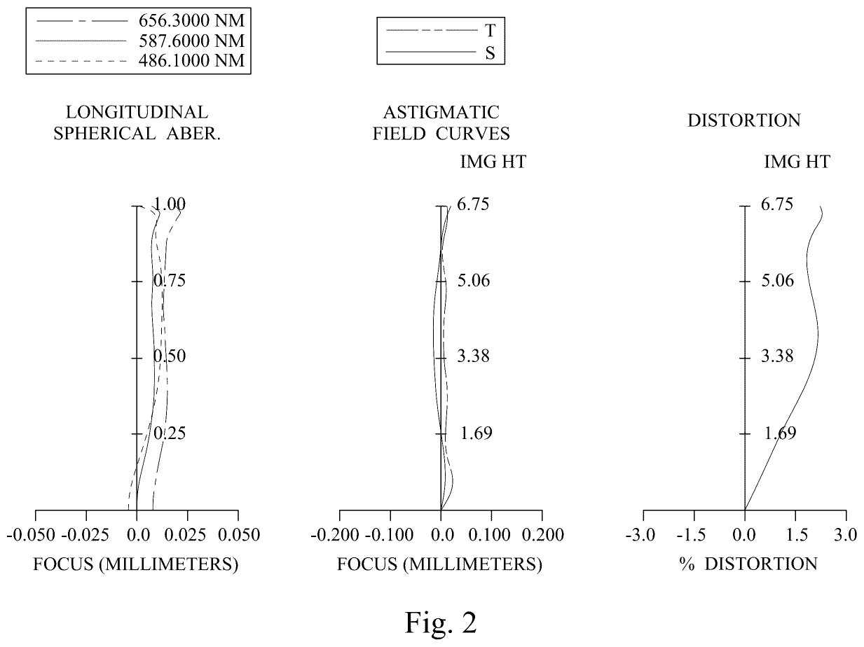

FIG. 1 is a schematic view of an imaging apparatus 1 according to the 1st embodiment of the present disclosure. FIG. 2 shows spherical aberration curves, astigmatic field curves and a distortion curve of the imaging apparatus 1 according to the 1st embodiment. In FIG. 1, the imaging apparatus 1 includes an image capturing optical lens assembly (its reference numeral is omitted) and an image sensor IS. The image capturing optical lens assembly includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the image capturing optical lens assembly. The image capturing optical lens assembly includes eight lens elements (E1, E2, E3, E4, E5, E6, E7, E8) without additional one or more lens elements inserted between the first lens element E1 and the eighth lens element E8, and there is an air gap along an optical axis between each two adjacent lens elements of the eight lens elements.

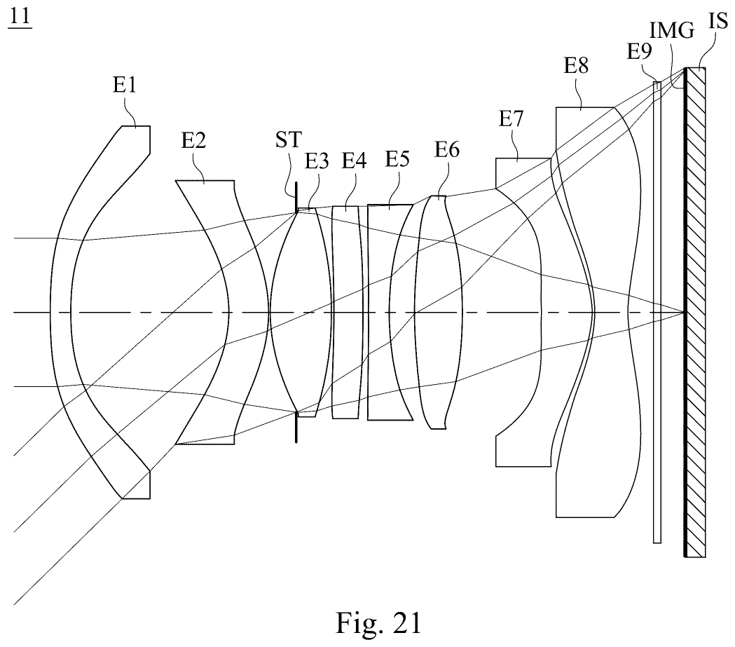

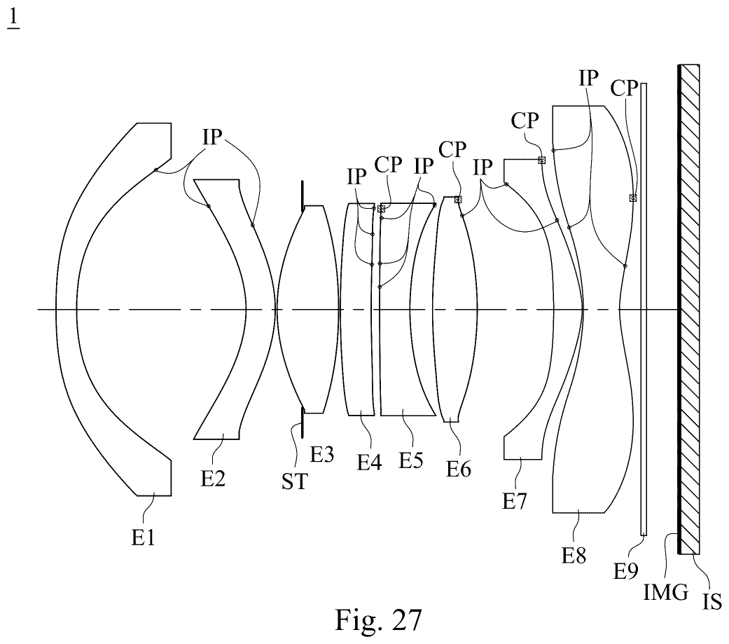

The first lens element E1 with negative refractive power has an object-side surface being convex in a paraxial region thereof and an image-side surface being concave in a paraxial region thereof. The first lens element E1 is made of a plastic material, and has the object-side surface and the image-side surface being both aspheric. Furthermore, FIG. 27 is a schematic view of the inflection points IP and the critical points CP of each lens element according to the 1st embodiment. In FIG. 21, the image-side surface of the first lens element E1 includes one inflection point IP (as shown in FIG. 27).

The second lens element E2 with negative refractive power has an object-side surface being concave in a paraxial region thereof and an image-side surface being convex in a paraxial region thereof. The second lens element E2 is made of a plastic material, and has the object-side surface and the image-side surface being both aspheric. Furthermore, the object-side surface of the second lens element includes one inflection point IP (as shown in FIG. 27), and the image-side surface of the second lens element includes one inflection point IP (as shown in FIG. 27).

The third lens element E3 with positive refractive power has an object-side surface being convex in a paraxial region thereof and an image-side surface being convex in a paraxial region thereof. The third lens element E3 is made of a plastic material, and has the object-side surface and the image-side surface being both aspheric.

The fourth lens element E4 with positive refractive power has an object-side surface being convex in a paraxial region thereof and an image-side surface being concave in a paraxial region thereof. The fourth lens element E4 is made of a plastic material, and has the object-side surface and the image-side surface being both aspheric. Furthermore, the image-side surface of the fourth lens element E4 includes three inflection points IP (as shown in FIG. 27).

The fifth lens element E5 with negative refractive power has an object-side surface being convex in a paraxial region thereof and an image-side surface being concave in a paraxial region thereof. The fifth lens element E5 is made of a plastic material, and has the object-side surface and the image-side surface being both aspheric. Furthermore, the object-side surface of the fifth lens element E5 includes three inflection points IP (as shown in FIG. 27) and one critical point CP (as shown in FIG. 27), and the image-side surface of the fifth lens element E5 includes one inflection point IP (as shown in FIG. 27).

The sixth lens element E6 with positive refractive power has an object-side surface being convex in a paraxial region thereof and an image-side surface being convex in a paraxial region thereof. The sixth lens element E6 is made of a plastic material, and has the object-side surface and the image-side surface being both aspheric. Furthermore, the image-side surface of the sixth lens element E6 includes one inflection point IP (as shown in FIG. 27) and one critical point CP (as shown in FIG. 27).

The seventh lens element E7 with positive refractive power has an object-side surface being concave in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes one inflection point IP (as shown in FIG. 27), and the image-side surface of the seventh lens element E7 includes one inflection point IP (as shown in FIG. 27) and one critical point CP (as shown in FIG. 27).

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes two inflection points IP (as shown in FIG. 27), and the image-side surface of the eighth lens element E8 includes one inflection point IP (as shown in FIG. 27) and one critical point CP (as shown in FIG. 27).

The filter E9 is made of a glass material, which is located between the eighth lens element E8 and the image surface IMG in order, and will not affect the focal length of the image capturing optical lens assembly.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,
X is the displacement in parallel with an optical axis from the intersection point of the aspheric surface and the optical axis to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient.

In the image capturing optical lens assembly according to the 1st embodiment, when a focal length of the image capturing optical lens assembly is f, an f-number of the image capturing optical lens assembly is Fno, and half of a maximum field of view of the image capturing optical lens assembly is HFOV, these parameters have the following values: f=6.35 mm; Fno=1.62; and HFOV=46.1 degrees.

In the image capturing optical lens assembly according to the 1st embodiment, when the maximum field of view of the image capturing optical lens assembly is FOV, the following condition is satisfied: FOV=92.2 degrees.

In the image capturing optical lens assembly according to the 1st embodiment, when the focal length of the image capturing optical lens assembly is f, and an entrance pupil diameter of the image capturing optical lens assembly is EPD, the following condition is satisfied: f/EPD=1.62.

In the image capturing optical lens assembly according to the 1st embodiment, when half of a maximum field of view of the image capturing optical lens assembly is HFOV, the following condition is satisfied: tan(HFOV)=1.04.

In the image capturing optical lens assembly according to the 1st embodiment, when the entrance pupil diameter of the image capturing optical lens assembly is EPD, and a maximum image height of the image capturing optical lens assembly is ImgH (which is half of a diagonal length of an effective photosensitive area of the image sensor IS), the following condition is satisfied: EPD/ImgH=0.58.

In the image capturing optical lens assembly according to the 1st embodiment, when the focal length of the image capturing optical lens assembly is f, and the maximum image height of the image capturing optical lens assembly is ImgH, the following condition is satisfied: f/ImgH=0.94.

In the image capturing optical lens assembly according to the 1st embodiment, when an axial distance between the aperture stop ST and the image surface IMG is SL, and an axial distance between the object-side surface of the first lens element E1 and the image surface IMG is TL, the following condition is satisfied: SL/TL=0.60.

In the image capturing optical lens assembly according to the 1st embodiment, when an axial distance between the image-side surface of the eighth lens element E8 and the image surface IMG is BL, and an axial distance between the aperture stop ST and the image-side surface of the eighth lens element E8 is SD, the following condition is satisfied: BL/SD=0.19.

In the image capturing optical lens assembly according to the 1st embodiment, when the focal length of the image capturing optical lens assembly is f, and a focal length of the second lens element E2 is f2, the following condition is satisfied: f/f2=−0.06.

In the image capturing optical lens assembly according to the 1st embodiment, when a focal length of the first lens element E1 is f1, and a focal length of the eighth lens element E8 is f8, the following condition is satisfied: f8/f1=0.12.

In the image capturing optical lens assembly according to the 1st embodiment, when a focal length of the third lens element E3 is f3, and a focal length of the fourth lens element E4 is f4, the following condition is satisfied: f3/f4=0.04.

In the image capturing optical lens assembly according to the 1st embodiment, when the focal length of the image capturing optical lens assembly is f, and a curvature radius of the object-side surface of the second lens element E2 is R3, the following condition is satisfied: R3/f=−0.50.

In the image capturing optical lens assembly according to the 1st embodiment, when the focal length of the image capturing optical lens assembly is f, and a curvature radius of the object-side surface of the seventh lens element E7 is R13, the following condition is satisfied: f/R13=−0.39.

In the image capturing optical lens assembly according to the 1st embodiment, when a curvature radius of the image-side surface of the second lens element E2 is R4, and a curvature radius of the object-side surface of the third lens element E3 is R5, the following condition is satisfied: R4/R5=−0.79.

In the image capturing optical lens assembly according to the 1st embodiment, when a curvature radius of the object-side surface of the fifth lens element E5 is R9, and a curvature radius of the image-side surface of the eighth lens element E8 is R16, the following condition is satisfied: R16/R9=0.08.

In the image capturing optical lens assembly according to the 1st embodiment, when the curvature radius of the object-side surface of the second lens element is R3, and a curvature radius of the object-side surface of the fourth lens element is R7, the following condition is satisfied: (R3+R7)/(R3−R7)=−0.78.

In the image capturing optical lens assembly according to the 1st embodiment, when the focal length of the image capturing optical lens assembly is f, the curvature radius of the object-side surface of the second lens element E2 is R3, the curvature radius of the image-side surface of the second lens element E2 is R4, and a curvature radius of the image-side surface of the eighth lens element E8 is R16, the following condition is satisfied: (|R3|+|R4|+R16)/f=1.60.

In the image capturing optical lens assembly according to the 1st embodiment, when the axial distance between the first lens element E1 and the second lens element E2 is T12, the axial distance between the second lens element E2 and the third lens element E3 is T23, the axial distance between the third lens element E3 and the fourth lens element E4 is T34, the axial distance between the fourth lens element E4 and the fifth lens element E5 is T45, the axial distance between the fifth lens element E5 and the sixth lens element E6 is T56, the axial distance between the sixth lens element E6 and the seventh lens element E7 is T67, the axial distance between the seventh lens element E7 and the eighth lens element E8 is T78, the maximum among T12, T23, T34, T45, T56, T67, T78 is ATmax, the central thickness of the first lens element E1 is CT1, the central thickness of the second lens element E2 is CT2, the central thickness of the third lens element E3 is CT3, the central thickness of the fourth lens element E4 is CT4, the central thickness of the fifth lens element E5 is CT5, the central thickness of the sixth lens element E6 is CT6, the central thickness of the seventh lens element E7 is CT7, the central thickness of the eighth lens element E8 is CT8, and the maximum among CT1, CT2, CT3, CT4, CT5, CT6, CT7, CT8 is CTmax, the following condition is satisfied: CTmax/ATmax=0.36. According to the 1st embodiment, the axial distance between two adjacent lens elements, which means the distance on the optical axis between two adjacent surfaces of the two adjacent lens elements.

In the image capturing optical lens assembly according to the 1st embodiment, when the central thickness of the third lens element E3 is CT3, and the central thickness of the fifth lens element E5 is CT5, the following condition is satisfied: CT3/CT5=2.03.

In the image capturing optical lens assembly according to the 1st embodiment, when the axial distance between the sixth lens element E6 and the seventh lens element E7 is T67, the axial distance between the seventh lens element E7 and the eighth lens element E8 is T78, the central thickness of the first lens element E1 is CT1, and the central thickness of the eighth lens element E8 is CT8, the following condition is satisfied: (T67+T78)/(CT1+CT8)=1.37.

In the image capturing optical lens assembly according to the 1st embodiment, when the axial distance between the image-side surface of the eighth lens element E8 and the image surface IMG is BL, and the axial distance between the first lens element E1 and the second lens element E2 is T12, the following condition is satisfied: BL/T12=0.35.

In the image capturing optical lens assembly according to the 1st embodiment, when the axial distance between the fourth lens element E4 and the fifth lens element E5 is T45, and the axial distance between the fifth lens element E5 and the sixth lens element E6 is T56, the following condition is satisfied: T45/T56=0.37.

In the image capturing optical lens assembly according to the 1st embodiment, when the axial distance between the first lens element E1 and the second lens element E2 is T12, the axial distance between the second lens element E2 and the third lens element E3 is T23, the axial distance between the third lens element E3 and the fourth lens element E4 is T34, and the axial distance between the fourth lens element E4 and the fifth lens element E5 is T45, the following condition is satisfied: (T23+T34+T45)/T12=0.07.

In the image capturing optical lens assembly according to the 1st embodiment, when an Abbe number of the third lens element E3 is V3, and an Abbe number of the fourth lens element E4 is V4, the following condition is satisfied: V3/V4=0.99.

In the image capturing optical lens assembly according to the 1st embodiment, when the Abbe number of the third lens element E3 is V3, and an Abbe number of the seventh lens element E7 is V7, the following condition is satisfied: V7/V3=0.46.

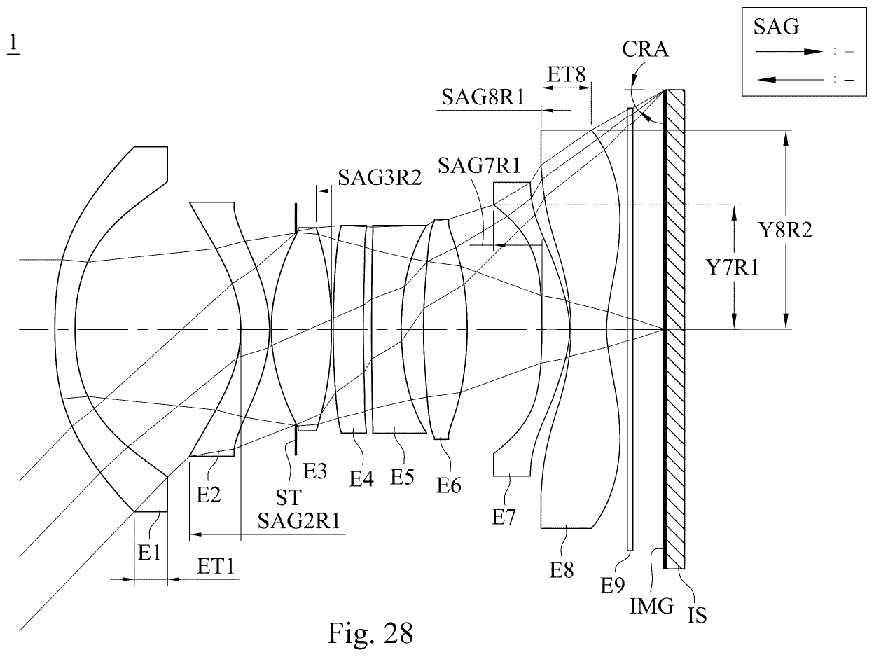

FIG. 28 is a schematic view of parameters according to the 1st embodiment. In FIG. 28, when an incident angle between a chief ray in a maximum field of view of the image capturing optical lens assembly and the image surface IMG is CRA (as shown in FIG. 28), the following condition is satisfied: tan(CRA)=0.76.

FIG. 28 is a schematic view of parameters according to the 1st embodiment. In FIG. 28, when a distance in parallel with the optical axis between a maximum effective radius position on the object-side surface of the first lens element E1 and a maximum effective radius position on the image-side surface of the first lens element E1 is ET1 (as shown in FIG. 28), and a distance in parallel with the optical axis between a maximum effective radius position on the object-side surface of the eighth lens element E8 and a maximum effective radius position on the image-side surface of the eighth lens element E8 is ET8 (as shown in FIG. 28), the following condition is satisfied: ET8/ET1=1.51.

FIG. 28 is a schematic view of parameters according to the 1st embodiment. In FIG. 28, when a displacement in parallel with an optical axis from an axial vertex on the object-side surface of the second lens element E2 to a maximum effective radius position on the object-side surface of the second lens element E2 is SAG2R1 (as shown in FIG. 28), and the central thickness of the second lens element E2 is CT2, and the following condition is satisfied: SAG2R1/CT2=−1.80.

FIG. 28 is a schematic view of parameters according to the 1st embodiment. In FIG. 28, when a displacement in parallel with an optical axis from an axial vertex on the image-side surface of the third lens element E3 to a maximum effective radius position on the image-side surface of the third lens element E3 is SAG3R2 (as shown in FIG. 28), and the central thickness of the third lens element E3 is CT3, the following condition is satisfied: SAG3R2/CT3=−0.25.

FIG. 28 is a schematic view of parameters according to the 1st embodiment. In FIG. 28, when a displacement in parallel with an optical axis from an axial vertex on the object-side surface of the seventh lens element E7 to a maximum effective radius position on the object-side surface of the seventh lens element E7 is SAG7R1 (as shown in FIG. 28), and the central thickness of the seventh lens element E7 is CT7, the following condition is satisfied: SAG7R1/CT7=−1.74.

FIG. 28 is a schematic view of parameters according to the 1st embodiment. In FIG. 28, when a displacement in parallel with the optical axis from an axial vertex on the object-side surface of the eighth lens element E8 to a maximum effective radius position on the object-side surface of the eighth lens element E8 is SAG8R1 (as shown in FIG. 28), and the central thickness of the eighth lens element E8 is CT8, the following condition is satisfied: SAG8R1/CT8=−0.85.

FIG. 28 is a schematic view of parameters according to the 1st embodiment. In FIG. 28, when a maximum effective radius of the object-side surface of the seventh lens element EP is Y7R1 (as shown in FIG. 28), and a maximum effective radius of the image-side surface of the eighth lens element E8 is Y8R2 (as shown in FIG. 28), the following condition is satisfied: Y8R2/Y7R1=1.60.

The detailed optical data of the 1st embodiment are shown in Table 1A and the aspheric surface data are shown in Table 1B below.

TABLE 1A
1st Embodiment
f = 6.35 mm, Fno = 1.62, HFOV = 46.1 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 13.8031 | ASP | 0.570 | Plastic | 1.535 | 55.9 | −23.94 |
| 2 | | 6.5451 | ASP | 4.676 | | | | |
| 3 | Lens 2 | −3.1676 | ASP | 0.806 | Plastic | 1.551 | 44.8 | −111.84 |
| 4 | | −3.6411 | ASP | 0.746 | | | | |
| 5 | Ape. Stop | Plano | | −0.696 | | | | |
| 6 | Lens 3 | 4.6374 | ASP | 1.698 | Plastic | 1.544 | 56.0 | 6.50 |
| 7 | | −12.9386 | ASP | 0.050 | | | | |
| 8 | Lens 4 | 25.9784 | ASP | 0.849 | Plastic | 1.511 | 56.8 | 167.45 |
| 9 | | 36.8958 | ASP | 0.232 | | | | |
| 10 | Lens 5 | 43.5266 | ASP | 0.836 | Plastic | 1.680 | 18.2 | −11.89 |
| 11 | | 6.7641 | ASP | 0.627 | | | | |
| 12 | Lens 6 | 13.6554 | ASP | 1.233 | Plastic | 1.544 | 56.0 | 10.19 |
| 13 | | −9.0287 | ASP | 2.110 | | | | |
| 14 | Lens 7 | −16.4121 | ASP | 0.786 | Plastic | 1.614 | 26.0 | 4.25 |
| 15 | | −2.2904 | ASP | 0.035 | | | | |
| 16 | Lens 8 | −4.5440 | ASP | 0.998 | Plastic | 1.614 | 26.0 | −2.98 |
| 17 | | 3.3186 | ASP | 0.588 | | | | |

| | | | | | | | |
|---|---|---|---|---|---|---|---|
| 18 | Filter | Plano | 0.160 | Glass | 1.517 | 64.2 | — |
| 19 | | Plano | 0.901 | | | | |
| 20 | Image | Plano | — | | | | |

Reference wavelength is 587.6 nm (d-line).

TABLE 1B
Aspheric Coefficients

| Surface # | 1 | 2 | 3 | 4 | 6 | 7 |
|---|---|---|---|---|---|---|
| k= | 1.23193E+00 | 4.96633E−01 | −4.92939E+00 | −5.29648E+00 | −1.32810E+00 | 9.35721E+00 |
| A4= | 5.894677E−03 | 7.141474E−03 | −6.929073E−03 | −5.367323E−03 | −2.876683E−03 | −5.988482E−03 |
| A6= | −4.774103E−04 | −4.223092E−04 | 7.066701E−04 | 7.919313E−04 | 6.060968E−04 | 1.658997E−03 |
| A8= | 3.753773E−05 | 2.973500E−05 | −3.280127E−05 | −5.161637E−05 | −7.242791E−05 | −2.378539E−04 |
| A10= | −2.449840E−06 | −1.258432E−06 | 9.376250E−07 | 2.724701E−06 | 5.817381E−06 | 1.945280E−05 |
| A12= | 1.113345E−07 | 1.163825E−08 | −1.492302E−08 | −6.267989E−08 | −2.746309E−07 | −7.094420E−07 |
| A14= | −3.354219E−09 | | | | | |
| A16= | 6.161770E−11 | | | | | |
| A18= | −5.139823E−13 | | | | | |
| Surface # | 8 | 9 | 10 | 11 | 12 | 13 |
| k= | 2.66248E+01 | −9.00000E+01 | 1.79538E+01 | 5.93132E−01 | 1.15783E+01 | −1.64279E+01 |
| A4= | 1.319431E−03 | 1.457827E−03 | −7.047826E−03 | −7.344799E−03 | −4.126929E−03 | −3.522183E−03 |
| A6= | −9.321243E−04 | −1.800510E−03 | 2.366422E−03 | 2.958392E−03 | 7.003314E−04 | 4.338136E−04 |
| A8= | 3.907263E−04 | 6.413124E−04 | −3.641183E−04 | −5.623059E−04 | −1.854390E−04 | −1.501794E−04 |
| A10= | −9.535958E−05 | −1.407301E−04 | 2.033694E−05 | 6.497537E−05 | 4.420324E−05 | 4.256914E−05 |
| A12= | 1.261396E−05 | 1.750002E−05 | 1.270756E−06 | −3.500233E−06 | −9.862693E−06 | −8.939577E−06 |
| A14= | −8.049609E−07 | −9.607760E−07 | −1.538185E−07 | −6.066664E−09 | 1.585966E−06 | 1.165482E−06 |
| A16= | 1.973274E−08 | 1.343530E−08 | | 4.869687E−09 | −1.450567E−07 | −8.069614E−08 |
| A18= | | | | | 7.014252E−09 | 2.429657E−09 |
| A20= | | | | | −1.454968E−10 | |

| Surface # | 14 | 15 | 16 | 17 |
|---|---|---|---|---|
| k= | 1.46060E+01 | −9.04319E+00 | −3.10322E+01 | −1.41219E+01 |
| A4= | −6.071682E−03 | 1.611103E−03 | 2.493595E−03 | −4.977087E−03 |
| A6= | 3.019809E−03 | −8.673848E−04 | −5.347142E−03 | 3.237516E−04 |
| A8= | −1.489002E−03 | −3.316620E−04 | 1.537120E−03 | −7.388081E−06 |
| A10= | 3.625822E−04 | 1.869255E−04 | −2.178245E−04 | −1.006379E−06 |
| A12= | −5.401324E−05 | −3.849786E−05 | 1.843789E−05 | 9.714759E−08 |
| A14= | 4.871902E−06 | 4.498371E−06 | −9.826136E−07 | −3.044459E−09 |
| A16= | −2.395996E−07 | −3.217485E−07 | 3.278988E−08 | −1.834815E−11 |
| A18= | 4.885030E−09 | 1.393224E−08 | −6.449894E−10 | 3.724011E−12 |
| A20= | | −3.356735E−10 | 6.349753E−12 | −9.138471E−14 |
| A22= | | 3.458283E−12 | −1.838665E−14 | 7.364076E−16 |

In Table 1A, the curvature radius, the thickness and the focal length are shown in millimeters (mm). Surface numbers 0-20 represent the surfaces sequentially arranged from the object side to the image side along the optical axis. In Table 1B, k represents the conic coefficient of the equation of the aspheric surface profiles. A4-A22 represent the aspheric coefficients ranging from the 4th order to the 22nd order. The tables presented below for each embodiment correspond to schematic parameter and aberration curves of each embodiment, and term definitions of the tables are the same as those in Table 1A and Table 1B of the 1st embodiment. Therefore, an explanation in this regard will not be provided again.

### 2nd Embodiment

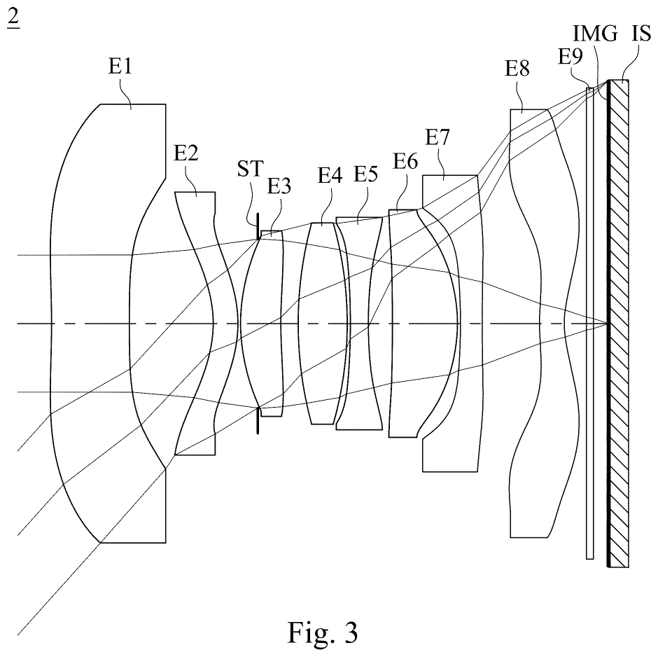

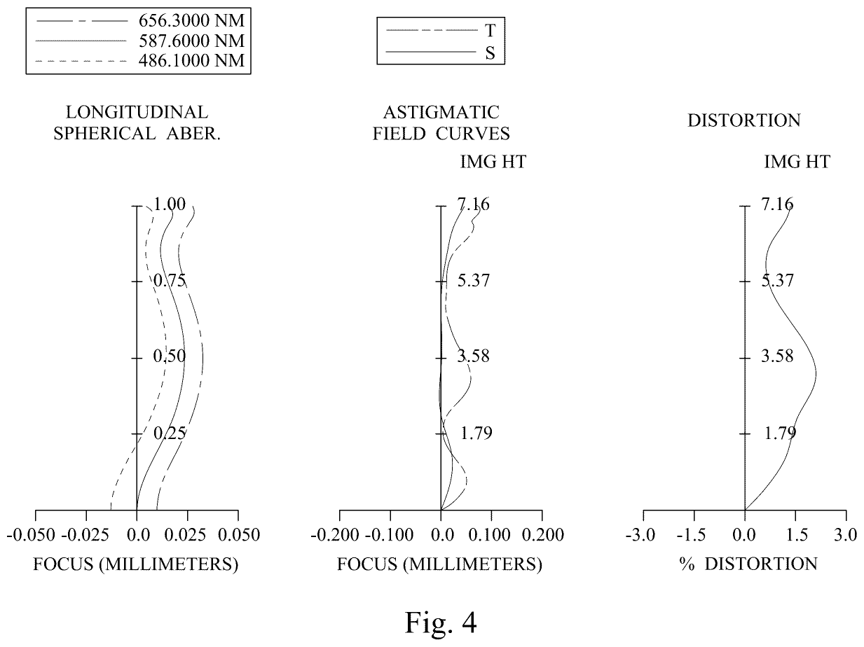

FIG. 3 is a schematic view of an imaging apparatus 2 according to the 2nd embodiment of the present disclosure. FIG. 4 shows spherical aberration curves, astigmatic field curves and a distortion curve of the imaging apparatus 2 according to the 2nd embodiment. In FIG. 3, the imaging apparatus 2 includes an image capturing optical lens assembly (its reference numeral is omitted) and an image sensor IS. The image capturing optical lens assembly includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the image capturing optical lens assembly. The image capturing optical lens assembly includes eight lens elements (E1, E2, E3, E4, E5, E6, E7, E8) without additional one or more lens elements inserted between the first lens element E1 and the eighth lens element E8, and there is an air gap along an optical axis between each two adjacent lens elements of the eight lens elements.

The first lens element E1 with negative refractive power has an object-side surface being concave in a paraxial region thereof and an image-side surface being concave in a paraxial region thereof. The first lens element E1 is made of a plastic material, and has the object-side surface and the image-side surface being both aspheric. Furthermore, the object-side surface of the first lens element E1 includes one inflection point and one critical point.

The second lens element E2 with positive refractive power has an object-side surface being concave in a paraxial region thereof and an image-side surface being convex in a paraxial region thereof. The second lens element E2 is made of a plastic material, and has the object-side surface and the image-side surface being both aspheric. Furthermore, the object-side surface of the second lens element E2 includes one inflection point, and the image-side surface of the second lens element E2 includes one inflection point and one critical point.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the object-side surface of the third lens element E3 includes one inflection point, and the image-side surface of the third lens element E3 includes one inflection point and one critical point.

The fourth lens element E4 with positive refractive power has an object-side surface being convex in a paraxial region thereof and an image-side surface being convex in a paraxial region thereof. The fourth lens element E4 is made of a glass material, and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of a plastic material, and has the object-side surface and the image-side surface being both aspheric. Furthermore, the image-side surface of the fifth lens element E5 includes one inflection point.

The sixth lens element E6 with positive refractive power has an object-side surface being concave in a paraxial region thereof and an image-side surface being convex in a paraxial region thereof. The sixth lens element E6 is made of a plastic material, and has the object-side surface and the image-side surface being both aspheric. Furthermore, the object-side surface of the sixth lens element E6 includes two inflection points and the image-side surface of the sixth lens element E6 includes one inflection point.

The seventh lens element E7 with negative refractive power has an object-side surface being concave in a paraxial region thereof and an image-side surface being concave in a paraxial region thereof. The seventh lens element E7 is made of a plastic material, and has the object-side surface and the image-side surface being both aspheric. Furthermore, the object-side surface of the seventh lens element E7 includes one inflection point, and the image-side surface of the seventh lens element E7 includes two inflection points and one critical point.

The eighth lens element E8 with negative refractive power has an object-side surface being convex in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes three inflection points and two critical points, and the image-side surface of the eighth lens element E8 includes three inflection points and one critical point.

The filter E9 is made of a glass material, which is located between the eighth lens element E8 and the image surface IMG in order, and will not affect the focal length of the image capturing optical lens assembly.

The detailed optical data of the 2nd embodiment are shown in Table 2A and the aspheric surface data are shown in Table 2B below.

TABLE 2A
2nd Embodiment
f = 6.34 mm, Fno = 1.57, HFOV = 48.1 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | −29.8963 | ASP | 2.296 | Plastic | 1.566 | 37.4 | −37.97 |
| 2 | | 78.5633 | ASP | 2.473 | | | | |
| 3 | Lens 2 | −3.4786 | ASP | 0.730 | Plastic | 1.544 | 56.0 | 486.99 |
| 4 | | −3.6874 | ASP | 0.585 | | | | |
| 5 | Ape. Stop | Plano | | −0.507 | | | | |
| 6 | Lens 3 | 5.1007 | ASP | 1.186 | Plastic | 1.544 | 56.0 | 14.65 |
| 7 | | 13.0119 | ASP | 0.514 | | | | |
| 8 | Lens 4 | 11.2555 | (SPH) | 1.448 | Glass | 1.729 | 54.7 | 7.79 |
| 9 | | −10.8480 | (SPH) | 0.090 | | | | |
| 10 | Lens 5 | −20.5502 | ASP | 0.531 | Plastic | 1.615 | 25.3 | −13.62 |
| 11 | | 14.3050 | ASP | 0.710 | | | | |
| 12 | Lens 6 | −136.6806 | ASP | 1.918 | Plastic | 1.544 | 56.0 | 8.45 |
| 13 | | −4.4698 | ASP | 0.092 | | | | |
| 14 | Lens 7 | −13.8896 | ASP | 0.641 | Plastic | 1.639 | 23.5 | −19.85 |
| 15 | | 147.3331 | ASP | 1.689 | | | | |
| 16 | Lens 8 | 6.9489 | ASP | 0.730 | Plastic | 1.587 | 28.3 | −10.01 |
| 17 | | 3.0607 | ASP | 0.650 | | | | |

| | | | | | | | |
|---|---|---|---|---|---|---|---|
| 18 | Filter | Plano | 0.210 | Glass | 1.517 | 64.2 | — |
| 19 | | Plano | 0.448 | | | | |
| 20 | Image | Plano | — | | | | |

Reference wavelength is 587.6 nm (d-line).

TABLE 2B
Aspheric Coefficients

| Surface # | 1 | 2 | 3 | 4 | 6 | 7 |
|---|---|---|---|---|---|---|
| k= | 1.81830E+01 | −9.00000E+01 | −6.79584E+00 | −7.25693E+00 | −1.27670E+00 | −8.73325E+01 |
| A4= | 2.341496E−03 | 3.744778E−03 | −6.772230E−03 | −7.861506E−03 | −4.416755E−03 | −3.735128E−03 |
| A6= | −5.451723E−05 | 1.300963E−04 | 8.703912E−04 | 1.866581E−03 | 1.316203E−03 | 5.435811E−04 |
| A8= | 4.343018E−07 | −4.330158E−05 | −3.351025E−05 | −2.461834E−04 | −2.162867E−04 | −1.089081E−04 |
| A10= | 8.362030E−08 | 5.316359E−06 | 1.558157E−07 | 2.781873E−05 | 2.283744E−05 | 1.383197E−05 |
| A12= | −5.291519E−09 | −3.036325E−07 | 1.314794E−08 | −1.840682E−06 | −1.204684E−06 | −9.169358E−07 |
| A14= | 1.563956E−10 | 6.194312E−09 | | 5.494599E−08 | | |
| A16= | −2.421088E−12 | | | | | |
| A18= | 1.621665E−14 | | | | | |
| Surface # | 10 | 11 | 12 | 13 | 14 | 15 |
| k= | 3.96793E+01 | −1.66424E−01 | −7.23807E+01 | 8.24992E−02 | −2.44257E+01 | 9.00000E+01 |
| A4= | −1.912337E−04 | 1.543803E−03 | −2.951309E−03 | 1.141370E−02 | 8.234080E−03 | 2.715765E−03 |
| A6= | 1.228511E−03 | 1.257182E−03 | 8.206100E−04 | −5.910019E−03 | −3.873037E−03 | −6.036852E−04 |
| A8= | −5.312891E−04 | −4.482118E−04 | −1.376530E−04 | 2.258734E−03 | 8.029489E−04 | −1.436271E−05 |
| A10= | 9.420627E−05 | 7.251771E−05 | 3.984056E−06 | −5.856651E−04 | −1.380766E−04 | 1.106410E−05 |
| A12= | −8.772471E−06 | −7.034080E−06 | 2.962950E−06 | 9.548741E−05 | 1.553352E−05 | −1.096102E−06 |
| A14= | 3.302858E−07 | 3.916267E−07 | −6.962623E−07 | −9.321442E−06 | −9.841119E−07 | 5.027428E−08 |
| A16= | | −1.000682E−08 | 7.092382E−08 | 4.962115E−07 | 2.616290E−08 | −1.125725E−09 |
| A18= | | | −2.706053E−09 | −1.095631E−08 | | 9.844697E−12 |

| Surface # | 16 | 17 |
|---|---|---|
| k= | −7.19519E+01 | −6.54955E+00 |
| A4= | −1.430108E−02 | −1.100976E−02 |
| A6= | 9.791516E−04 | 1.500281E−03 |
| A8= | −8.440905E−05 | −1.663622E−04 |
| A10= | 1.158149E−05 | 1.245127E−05 |
| A12= | −9.418811E−07 | −6.130549E−07 |
| A14= | 4.257362E−08 | 1.966363E−08 |
| A16= | −1.097725E−09 | −3.942907E−10 |
| A18= | 1.527099E−11 | 4.475155E−12 |
| A20= | −8.952639E−14 | −2.192990E−14 |

In the 2nd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 2nd embodiment, so an explanation in this regard will not be provided again.

Moreover, these parameters can be calculated from Table 2A and Table 2B as the following values and satisfy the following conditions in Table 2C:

TABLE 2C
2nd Embodiment

| | | | |
|---|---|---|---|
| f [mm] | 6.34 | (R3 + R7)/(R3 − R7) | −0.53 |
| Fno | 1.57 | (\|R3\| + \|R4\| + R16)/f | 1.61 |
| HFOV [deg.] | 48.1 | CTmax/ATmax | 0.93 |
| FOV [deg.] | 96.2 | CT3/CT5 | 2.23 |
| f/EPD | 1.57 | (T67 + T78)/(CT1 + CT8) | 0.59 |
| tan(HFOV) | 1.11 | BL/T12 | 0.53 |
| EPD/ImgH | 0.56 | T45/T56 | 0.13 |
| f/ImgH | 0.89 | (T23 + T34 + T45)/T12 | 0.28 |
| SL/TL | 0.63 | V3/V4 | 1.02 |
| BL/SD | 0.14 | V7/V3 | 0.42 |
| f/f2 | 0.01 | tan(CRA) | 0.70 |
| f8/f1 | 0.26 | ET8/ET1 | 0.57 |
| f3/f4 | 1.88 | SAG2R1/CT2 | −1.55 |
| R3/f | −0.55 | SAG3R2/CT3 | 0.02 |
| f/R13 | −0.46 | SAG7R1/CT7 | −1.75 |
| R4/R5 | −0.72 | SAG8R1/CT8 | −1.17 |
| R16/R9 | −0.15 | Y8R2/Y7R1 | 1.85 |

### 3rd Embodiment

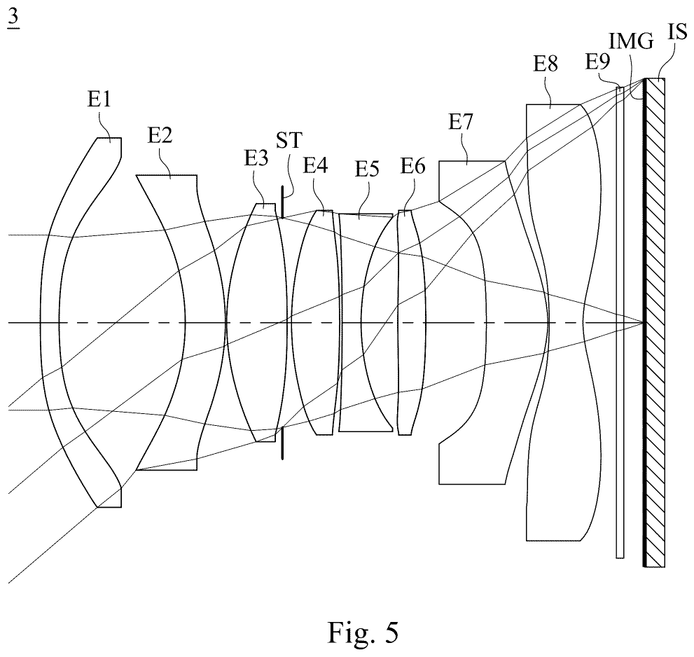

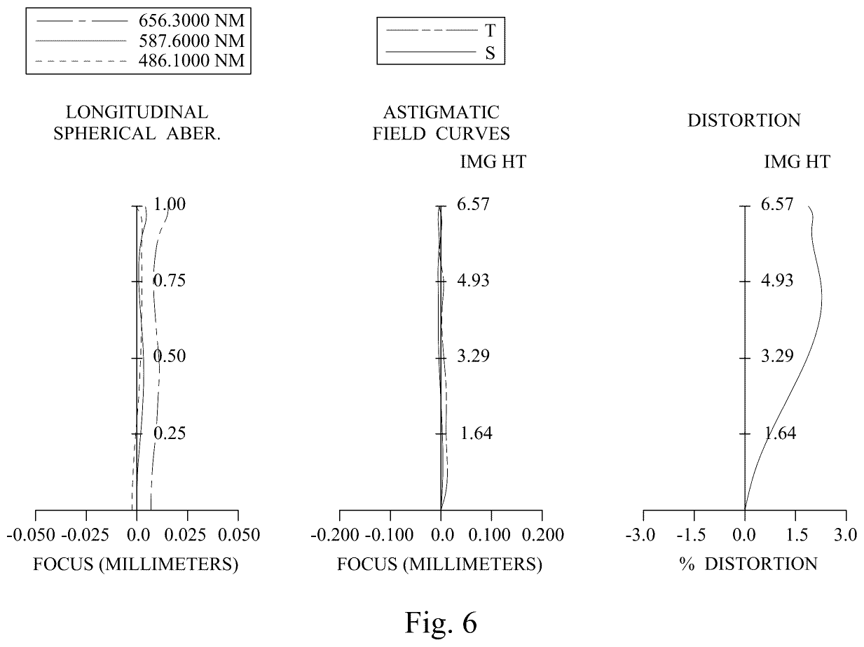

FIG. 5 is a schematic view of an imaging apparatus 3 according to the 3rd embodiment of the present disclosure. FIG. 6 shows spherical aberration curves, astigmatic field curves and a distortion curve of the imaging apparatus 3 according to the 3rd embodiment. In FIG. 5, the imaging apparatus 3 includes an image capturing optical lens assembly (its reference numeral is omitted) and an image sensor IS. The image capturing optical lens assembly includes, in order from an object side to an image side along an optical path, a first lens element E1, a second lens element E2, a third lens element E3, an aperture stop ST, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the image capturing optical lens assembly. The image capturing optical lens assembly includes eight lens elements (E1, E2, E3, E4, E5, E6, E7, E8) without additional one or more lens elements inserted between the first lens element E1 and the eighth lens element E8, and there is an air gap along an optical axis between each two adjacent lens elements of the eight lens elements.

The first lens element E1 with negative refractive power has an object-side surface being convex in a paraxial region thereof and an image-side surface being concave in a paraxial region thereof. The first lens element E1 is made of a plastic material, and has the object-side surface and the image-side surface being both aspheric. Furthermore, the image-side surface of the first lens element E1 includes one inflection point.

The second lens element E2 with negative refractive power has an object-side surface being concave in a paraxial region thereof and an image-side surface being convex in a paraxial region thereof. The second lens element E2 is made of a glass material, and has the object-side surface and the image-side surface being both aspheric. Furthermore, the object-side surface of the second lens element E2 includes one inflection point, and the image-side surface of the second lens element E2 includes one inflection point and one critical point.

The third lens element E3 with positive refractive power has an object-side surface being convex in a paraxial region thereof and an image-side surface being convex in a paraxial region thereof. The third lens element E3 is made of a glass material, and has the object-side surface and the image-side surface being both aspheric. Furthermore, the image-side surface of the third lens element E3 includes one inflection point.

The fourth lens element E4 with positive refractive power has an object-side surface being convex in a paraxial region thereof and an image-side surface being convex in a paraxial region thereof. The fourth lens element E4 is made of a plastic material, and has the object-side surface and the image-side surface being both aspheric. Furthermore, the image-side surface of the fourth lens element E4 includes one inflection point.

The fifth lens element E5 with negative refractive power has an object-side surface being concave in a paraxial region thereof and an image-side surface being concave in a paraxial region thereof. The fifth lens element E5 is made of a plastic material, and has the object-side surface and the image-side surface being both aspheric.

The sixth lens element E6 with positive refractive power has an object-side surface being convex in a paraxial region thereof and an image-side surface being convex in a paraxial region thereof. The sixth lens element E6 is made of a glass material, and has the object-side surface and the image-side surface being both aspheric. Furthermore, the object-side surface of the sixth lens element E6 includes two inflection points and two critical points, and the image-side surface of the sixth lens element E6 includes one inflection point.

The seventh lens element E7 with positive refractive power has an object-side surface being concave in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes one inflection point, and the image-side surface of the seventh lens element E7 includes three inflection points.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes two inflection points, and the image-side surface of the eighth lens element E8 includes one inflection point and one critical point.

The filter E9 is made of a glass material, which is located between the eighth lens element E8 and the image surface IMG in order, and will not affect the focal length of the image capturing optical lens assembly.

The detailed optical data of the 3rd embodiment are shown in Table 3A and the aspheric surface data are shown in Table 3B below.

TABLE 3A
3rd Embodiment
f = 7.55 mm, Fno = 1.60, HFOV = 40.5 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 27.0421 | ASP | 0.507 | Plastic | 1.529 | 45.4 | −44.04 |
| 2 | | 12.4360 | ASP | 3.403 | | | | |
| 3 | Lens 2 | −5.6818 | ASP | 1.081 | Glass | 1.606 | 43.9 | −415.26 |
| 4 | | −6.2303 | ASP | 0.036 | | | | |
| 5 | Lens 3 | 6.1047 | ASP | 1.628 | Glass | 1.547 | 62.7 | 9.45 |
| 6 | | −30.4005 | ASP | −0.124 | | | | |
| 7 | Ape. Stop | Plano | | 0.243 | | | | |
| 8 | Lens 4 | 7.5646 | ASP | 1.298 | Plastic | 1.544 | 56.0 | 10.65 |
| 9 | | −23.2563 | ASP | 0.067 | | | | |
| 10 | Lens 5 | −259.8726 | ASP | 0.511 | Plastic | 1.615 | 25.3 | −9.10 |
| 11 | | 5.7306 | ASP | 0.993 | | | | |
| 12 | Lens 6 | 33.5992 | ASP | 0.753 | Glass | 1.729 | 54.7 | 19.20 |
| 13 | | −23.7756 | ASP | 1.634 | | | | |
| 14 | Lens 7 | −17.9648 | ASP | 1.655 | Plastic | 1.587 | 28.3 | 5.44 |
| 15 | | −2.8053 | ASP | 0.039 | | | | |
| 16 | Lens 8 | −10.6037 | ASP | 0.911 | Plastic | 1.584 | 28.2 | −3.63 |
| 17 | | 2.7388 | ASP | 0.900 | | | | |

| | | | | | | | |
|---|---|---|---|---|---|---|---|
| 18 | Filter | Plano | 0.200 | Glass | 1.517 | 64.2 | — |
| 19 | | Plano | 0.563 | | | | |
| 20 | Image | Plano | — | | | | |

Reference wavelength is 587.6 nm (d-line).

TABLE 3B
Aspheric Coefficients

| Surface # | 1 | 2 | 3 | 4 | 5 | 6 |
|---|---|---|---|---|---|---|
| k= | 1.82615E+01 | 4.14551E−01 | −7.68331E+00 | −7.24247E+00 | −1.00570E+00 | 5.77012E+01 |
| A4= | 5.638137E−03 | 6.956242E−03 | −4.035815E−03 | −2.718421E−03 | −1.039248E−03 | −4.056542E−03 |
| A6= | −3.811756E−04 | −3.617855E−04 | 1.587806E−04 | 2.124049E−04 | 1.203637E−04 | 3.789840E−04 |
| A8= | 2.412562E−05 | 2.026458E−05 | −1.650179E−06 | −3.704861E−06 | −1.195793E−05 | −2.079083E−05 |
| A10= | −1.564325E−06 | −1.163992E−06 | 1.693271E−07 | 1.686931E−07 | 2.218336E−07 | 9.327210E−07 |
| A12= | 7.134753E−08 | 2.234897E−08 | −6.689285E−09 | 5.537858E−09 | 3.437271E−08 | −4.104214E−09 |
| A14= | −2.075115E−09 | | | | | |
| A16= | 3.839018E−11 | | | | | |
| A18= | −3.561812E−13 | | | | | |
| Surface # | 8 | 9 | 10 | 11 | 12 | 13 |
| k= | −6.38986E−02 | 9.33405E+00 | 9.00000E+01 | 8.35047E−01 | −7.92855E+01 | 1.83509E+01 |
| A4= | −9.436215E−04 | 3.614377E−03 | −1.703652E−03 | −4.504882E−03 | −2.451974E−03 | −2.522327E−03 |
| A6= | 3.922190E−05 | −2.312350E−03 | −3.945053E−04 | 1.519179E−03 | −8.892384E−05 | −5.960727E−05 |
| A8= | −8.959104E−07 | 5.535574E−04 | 2.424489E−04 | −2.283066E−04 | −3.747073E−05 | −7.722192E−05 |
| A10= | 1.617956E−06 | −7.143959E−05 | −4.173053E−05 | 2.501056E−05 | 2.761791E−05 | 3.129075E−05 |
| A12= | −1.435359E−09 | 5.197846E−06 | 3.252747E−06 | −1.976759E−06 | −7.917721E−06 | −6.170189E−06 |
| A14= | | −1.618587E−07 | −1.077095E−07 | 1.076914E−07 | 1.429986E−06 | 7.260462E−07 |
| A16= | | | | −2.380252E−09 | −1.571082E−07 | −4.727113E−08 |
| A18= | | | | | 1.017771E−08 | 1.450362E−09 |
| A20= | | | | | −2.917828E−10 | |

| Surface # | 14 | 15 | 16 | 17 |
|---|---|---|---|---|
| k= | 1.52114E+01 | −1.04984E+01 | −3.57550E+01 | −1.07803E+01 |
| A4= | −1.987688E−03 | 1.344996E−03 | −2.868791E−03 | −6.696117E−03 |
| A6= | −2.339068E−04 | −1.878207E−03 | −3.573549E−03 | 6.058712E−04 |
| A8= | −3.195966E−04 | 3.658278E−04 | 1.219764E−03 | −2.018330E−05 |
| A10= | 1.175494E−04 | −8.643953E−06 | −1.794396E−04 | −1.839397E−06 |
| A12= | −2.301513E−05 | −4.895244E−06 | 1.556186E−05 | 2.667252E−07 |
| A14= | 2.557892E−06 | 7.099663E−07 | −8.699309E−07 | −1.568412E−08 |
| A16= | −1.564373E−07 | −4.731405E−08 | 3.196922E−08 | 5.311380E−10 |
| A18= | 4.153329E−09 | 1.756461E−09 | −7.514279E−10 | −1.080653E−11 |
| A20= | | −3.537086E−11 | 1.029901E−11 | 1.243693E−13 |
| A22= | | 3.042392E−13 | −6.291552E−14 | 6.343362E−16 |

In the 3rd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 3rd embodiment, so an explanation in this regard will not be provided again.

Moreover, these parameters can be calculated from Table 3A and Table 3B as the following values and satisfy the following conditions in Table 3C:

TABLE 3C
3rd Embodiment

| | | | |
|---|---|---|---|
| f [mm] | 7.55 | (R3 + R7)/(R3 − R7) | −0.14 |
| Fno | 1.60 | (\|R3\| + \|R4\| + R16)/f | 1.94 |
| HFOV [deg.] | 40.5 | CTmax/ATmax | 0.49 |
| FOV [deg.] | 81.0 | CT3/CT5 | 3.19 |
| f/EPD | 1.60 | (T67 + T78)/(CT1 + CT8) | 1.18 |
| tan(HFOV) | 0.85 | BL/T12 | 0.49 |
| EPD/ImgH | 0.72 | T45/T56 | 0.07 |
| f/ImgH | 1.15 | (T23 + T34 + T45)/T12 | 0.07 |
| SL/TL | 0.60 | V3/V4 | 1.12 |
| BL/SD | 0.21 | V7/V3 | 0.45 |
| f/f2 | −0.02 | tan(CRA) | 0.66 |
| f8/f1 | 0.08 | ET8/ET1 | 2.24 |
| f3/f4 | 0.89 | SAG2R1/CT2 | −1.23 |
| R3/f | −0.75 | SAG3R2/CT3 | −0.20 |
| f/R13 | −0.42 | SAG7R1/CT7 | −0.77 |
| R4/R5 | −1.02 | SAG8R1/CT8 | −0.67 |
| R16/R9 | −0.01 | Y8R2/Y7R1 | 1.80 |

### 4th Embodiment

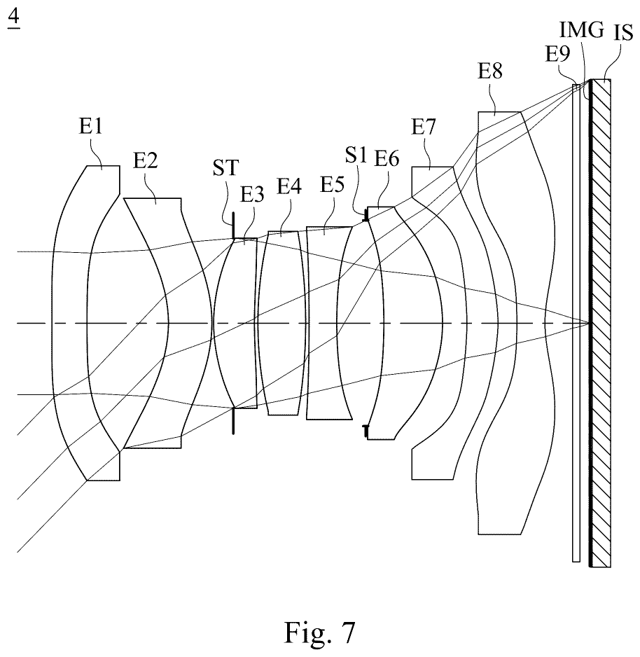

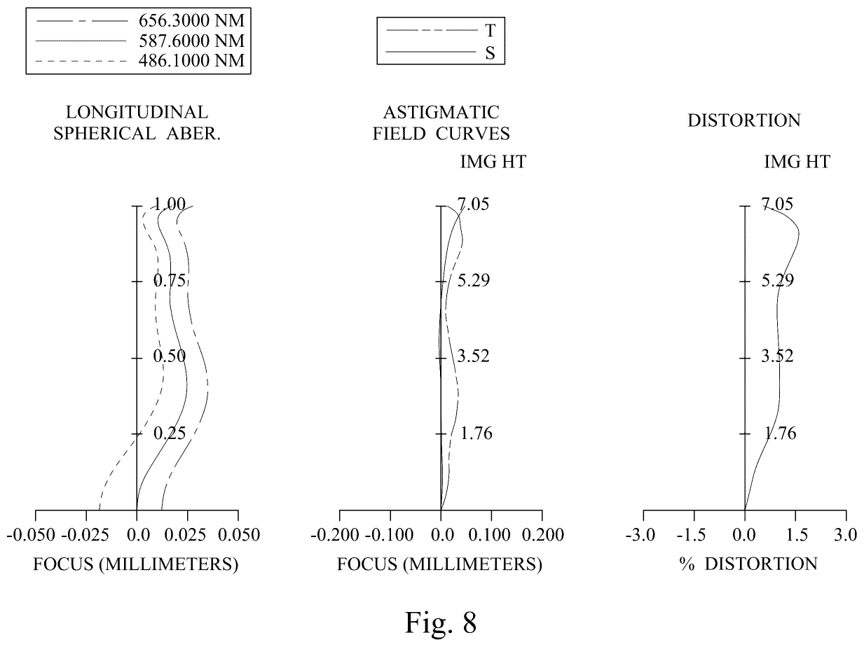

FIG. 7 is a schematic view of an imaging apparatus 4 according to the 4th embodiment of the present disclosure. FIG. 8 shows spherical aberration curves, astigmatic field curves and a distortion curve of the imaging apparatus 4 according to the 4th embodiment. In FIG. 7, the imaging apparatus 4 includes an image capturing optical lens assembly (its reference numeral is omitted) and an image sensor IS. The image capturing optical lens assembly includes, in order from an object side to an image side along an optical path, a first lens element E1, a second lens element E2, an aperture stop ST, a third lens element E3, a fourth lens element E4, a fifth lens element E5, a stop S1, a sixth lens element E6, a seventh lens element E7, an eighth lens element E8, a filter E9 and an image surface IMG, wherein the image sensor IS is disposed on the image surface IMG of the image capturing optical lens assembly. The image capturing optical lens assembly includes eight lens elements (E1, E2, E3, E4, E5, E6, E7, E8) without additional one or more lens elements inserted between the first lens element E1 and the eighth lens element E8, and there is an air gap along an optical axis between each two adjacent lens elements of the eight lens elements.

The first lens element E1 with negative refractive power has an object-side surface being concave in a paraxial region thereof and an image-side surface being concave in a paraxial region thereof. The first lens element E1 is made of a plastic material, and has the object-side surface and the image-side surface being both aspheric. Furthermore, the object-side surface of the first lens element E1 includes two inflection points and one critical point, and the image-side surface of the first lens element E1 includes one inflection point.

The second lens element E2 with negative refractive power has an object-side surface being concave in a paraxial region thereof and an image-side surface being convex in a paraxial region thereof. The second lens element E2 is made of a plastic material, and has the object-side surface and the image-side surface being both aspheric. Furthermore, the object-side surface of the second lens element E2 includes one inflection point, and the image-side surface of the second lens element E2 includes one inflection point.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the image-side surface of the third lens element E3 includes two inflection points.

The fourth lens element E4 with positive refractive power has an object-side surface being convex in a paraxial region thereof and an image-side surface being convex in a paraxial region thereof. The fourth lens element E4 is made of a glass material, and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of a plastic material, and has the object-side surface and the image-side surface being both aspheric.

The sixth lens element E6 with positive refractive power has an object-side surface being concave in a paraxial region thereof and an image-side surface being convex in a paraxial region thereof. The sixth lens element E6 is made of a plastic material, and has the object-side surface and the image-side surface being both aspheric. Furthermore, the image-side surface of the sixth lens element E6 includes one inflection point.

The seventh lens element E7 with positive refractive power has an object-side surface being concave in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes one inflection point, and the image-side surface of the seventh lens element E7 includes one inflection point.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes one inflection point and one critical point, and the image-side surface of the eighth lens element E8 includes three inflection points and one critical point.

The filter E9 is made of a glass material, which is located between the eighth lens element E8 and the image surface IMG in order, and will not affect the focal length of the image capturing optical lens assembly.

The detailed optical data of the 4th embodiment are shown in Table 4A and the aspheric surface data are shown in Table 4B below.

TABLE 4A
4th Embodiment
f = 6.79 mm, Fno = 1.64, HFOV = 45.9 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | −100.0000 | ASP | 1.015 | Plastic | 1.545 | 56.1 | −78.53 |
| 2 | | 75.0781 | ASP | 2.355 | | | | |
| 3 | Lens 2 | −3.6187 | ASP | 1.259 | Plastic | 1.544 | 56.0 | −297.53 |
| 4 | | −4.1552 | ASP | 0.618 | | | | |
| 5 | Ape. Stop | Plano | | −0.568 | | | | |
| 6 | Lens 3 | 4.5881 | ASP | 1.180 | Plastic | 1.544 | 56.0 | 11.82 |
| 7 | | 14.5560 | ASP | 0.100 | | | | |
| 8 | Lens 4 | 11.1150 | (SPH) | 1.380 | Glass | 1.589 | 61.3 | 11.24 |
| 9 | | −15.6297 | (SPH) | 0.100 | | | | |
| 10 | Lens 5 | −78.5760 | ASP | 0.800 | Plastic | 1.660 | 20.4 | −15.87 |
| 11 | | 12.1294 | ASP | 0.839 | | | | |
| 12 | Stop | Plano | | 0.525 | | | | |
| 13 | Lens 6 | −15.6007 | ASP | 1.697 | Plastic | 1.544 | 56.0 | 9.75 |
| 14 | | −4.1099 | ASP | 0.706 | | | | |
| 15 | Lens 7 | −7.1455 | ASP | 0.899 | Plastic | 1.615 | 25.4 | 14.36 |
| 16 | | −4.1375 | ASP | 0.545 | | | | |
| 17 | Lens 8 | −13.3937 | ASP | 0.813 | Plastic | 1.639 | 23.5 | −4.50 |
| 18 | | 3.7460 | ASP | 0.800 | | | | |

| | | | | | | | |
|---|---|---|---|---|---|---|---|
| 19 | Filter | Plano | 0.210 | Glass | 1.517 | 64.2 | — |
| 20 | | Plano | 0.311 | | | | |
| 21 | Image | Plano | — | | | | |

Reference wavelength is 587.6 nm (d-line).
Effective radius of Surface 12 (stop S1) is 2.974 mm.

TABLE 4B
Aspheric Coefficients

| Surface # | 1 | 2 | 3 | 4 | 6 | 7 |
|---|---|---|---|---|---|---|
| k= | −7.21281E+01 | 7.84011E+01 | −5.67907E+00 | −5.53054E+00 | −1.15270E+00 | −7.91393E+01 |
| A4= | 4.613368E−03 | 6.243401E−03 | −4.685955E−03 | −3.946562E−03 | −3.943255E−03 | −4.364942E−03 |
| A6= | −2.193823E−04 | −1.912081E−04 | 3.206312E−04 | 5.343392E−04 | 7.015657E−04 | 2.484681E−04 |
| A8= | 1.676670E−05 | 6.973259E−06 | 3.204040E−06 | −2.744813E−05 | −4.977372E−05 | 5.438757E−05 |
| A10= | −1.206079E−06 | 5.678183E−07 | −9.606579E−07 | 1.255998E−06 | 2.480421E−06 | −9.252102E−06 |
| A12= | 6.619358E−08 | −5.586843E−08 | 2.541922E−08 | −2.836778E−08 | 9.789764E−08 | 6.763324E−07 |
| A14= | −2.285459E−09 | | | | | |
| A16= | 3.260557E−11 | | | | | |
| Surface # | 10 | 11 | 13 | 14 | 15 | 16 |
| k= | −9.00000E+01 | 5.07429E+00 | 4.44108E+00 | 2.59641E−01 | −2.14299E+01 | −1.42826E+01 |
| A4= | −1.701294E−03 | 1.037140E−03 | −1.850910E−03 | 6.936995E−03 | 9.381561E−03 | 6.428622E−03 |
| A6= | 2.846196E−04 | −4.058729E−04 | 2.860975E−04 | −1.143006E−03 | −2.672346E−03 | −1.648027E−03 |
| A8= | −3.539681E−05 | 3.175703E−04 | −2.788272E−04 | 2.917772E−05 | 1.369522E−04 | −3.937022E−05 |
| A10= | 1.340943E−05 | −9.080295E−05 | 8.305922E−05 | 2.122615E−05 | 5.075872E−06 | 3.346193E−05 |
| A12= | −2.339443E−06 | 1.543669E−05 | −1.352947E−05 | −3.492068E−06 | −9.565262E−07 | −3.415874E−06 |
| A14= | 1.134752E−07 | −1.445511E−06 | 1.223522E−06 | 2.338305E−07 | 2.305416E−08 | 1.626395E−07 |
| A16= | | 5.413248E−08 | −4.558308E−08 | −4.823707E−09 | 7.782328E−10 | −3.879492E−09 |
| A18= | | | | | | 3.760216E−11 |

| Surface # | 17 | 18 |
|---|---|---|
| k= | 2.63825E+00 | −1.10138E+01 |
| A4= | −4.830789E−03 | −6.999828E−03 |
| A6= | −2.451915E−03 | 8.233353E−05 |
| A8= | 5.885130E−04 | 5.450209E−05 |
| A10= | −5.695801E−05 | −6.160316E−06 |
| A12= | 3.152424E−06 | 3.212997E−07 |
| A14= | −1.080394E−07 | −9.183875E−09 |
| A16= | 2.279595E−09 | 1.441965E−10 |
| A18= | −2.725114E−11 | −1.114637E−12 |
| A20= | 1.416418E−13 | 2.915600E−15 |

In the 4th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 4th embodiment, so an explanation in this regard will not be provided again.

Moreover, these parameters can be calculated from Table 4A and Table 4B as the following values and satisfy the following conditions in Table 4C:

TABLE 4C
4th Embodiment

| | | | |
|---|---|---|---|
| f [mm] | 6.79 | (R3 + R7)/(R3 − R7) | −0.51 |
| Fno | 1.64 | (\|R3\| + \|R4\| + R16)/f | 1.70 |
| HFOV [deg.] | 45.9 | CTmax/ATmax | 0.72 |
| FOV [deg.] | 91.8 | CT3/CT5 | 1.48 |
| f/EPD | 1.64 | (T67 + T78)/(CT1 + CT8) | 0.68 |
| tan(HFOV) | 1.03 | BL/T12 | 0.56 |
| EPD/ImgH | 0.59 | T45/T56 | 0.07 |
| f/ImgH | 0.96 | (T23 + T34 + T45)/T12 | 0.11 |
| SL/TL | 0.66 | V3/V4 | 0.91 |
| BL/SD | 0.15 | V7/V3 | 0.45 |
| f/f2 | −0.02 | tan(CRA) | 0.67 |
| f8/f1 | 0.06 | ET8/ET1 | 1.29 |
| f3/f4 | 1.05 | SAG2R1/CT2 | −1.03 |
| R3/f | −0.53 | SAG3R2/CT3 | 0.07 |
| f/R13 | −0.95 | SAG7R1/CT7 | −1.77 |
| R4/R5 | −0.91 | SAG8R1/CT8 | −1.37 |
| R16/R9 | −0.05 | Y8R2/Y7R1 | 1.68 |

### 5th Embodiment

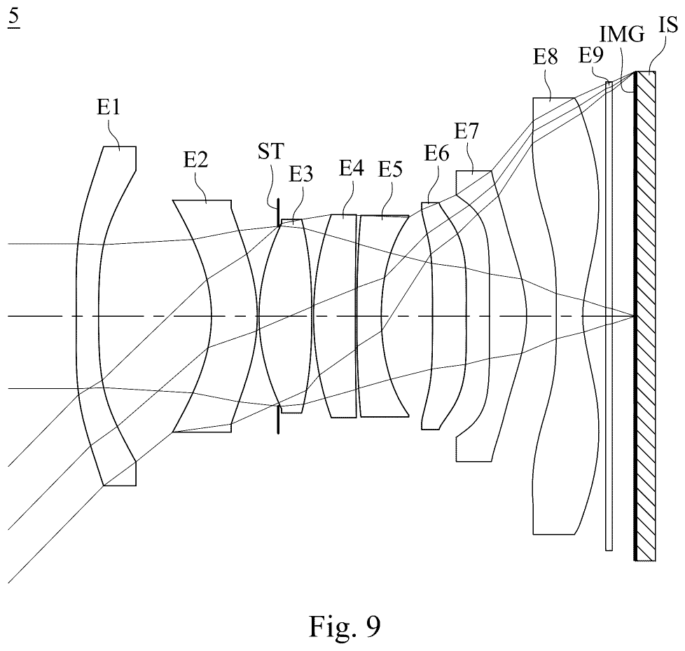

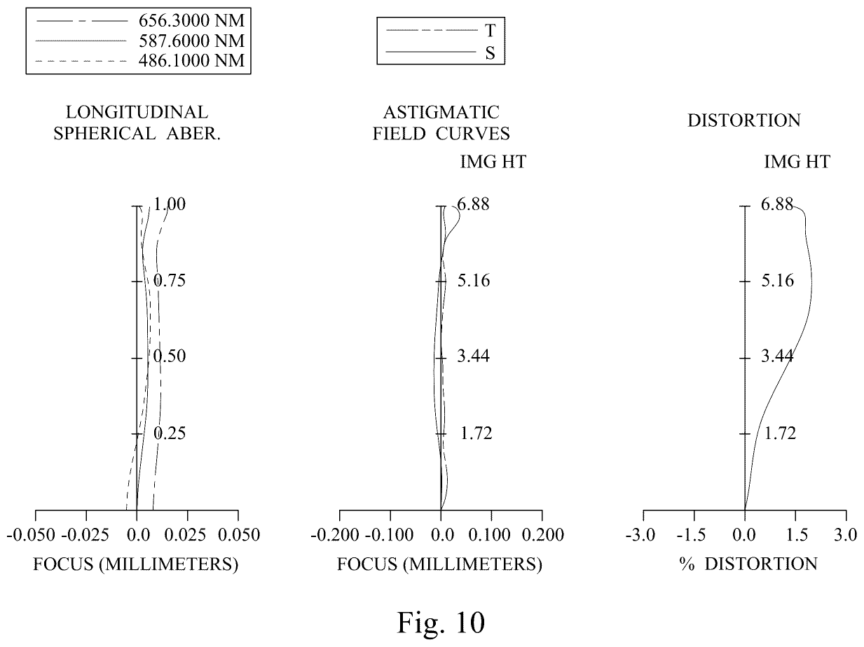

FIG. 9 is a schematic view of an imaging apparatus 5 according to the 5th embodiment of the present disclosure. FIG. 10 shows spherical aberration curves, astigmatic field curves and a distortion curve of the imaging apparatus 5 according to the 5th embodiment. In FIG. 9, the imaging apparatus 5 includes an image capturing optical lens assembly (its reference numeral is omitted) and an image sensor IS. The image capturing optical lens assembly includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the image capturing optical lens assembly. The image capturing optical lens assembly includes eight lens elements (E1, E2, E3, E4, E5, E6, E7, E8) without additional one or more lens elements inserted between the first lens element E1 and the eighth lens element E8, and there is an air gap along an optical axis between each two adjacent lens elements of the eight lens elements.

The first lens element E1 with negative refractive power has an object-side surface being concave in a paraxial region thereof and an image-side surface being concave in a paraxial region thereof. The first lens element E1 is made of a plastic material, and has the object-side surface and the image-side surface being both aspheric. Furthermore, the object-side surface of the first lens element E1 includes three inflection points and one critical point.

The second lens element E2 with negative refractive power has an object-side surface being concave in a paraxial region thereof and an image-side surface being convex in a paraxial region thereof. The second lens element E2 is made of a plastic material, and has the object-side surface and the image-side surface being both aspheric. Furthermore, the image-side surface of the second lens element E2 includes one inflection point.

The third lens element E3 with positive refractive power has an object-side surface being convex in a paraxial region thereof and an image-side surface being convex in a paraxial region thereof. The third lens element E3 is made of a plastic material, and has the object-side surface and the image-side surface being both aspheric.

The fourth lens element E4 with positive refractive power has an object-side surface being convex in a paraxial region thereof and an image-side surface being concave in a paraxial region thereof. The fourth lens element E4 is made of a plastic material, and has the object-side surface and the image-side surface being both spherical.

The fifth lens element E5 with negative refractive power has an object-side surface being convex in a paraxial region thereof and an image-side surface being concave in a paraxial region thereof. The fifth lens element E5 is made of a plastic material, and has the object-side surface and the image-side surface being both aspheric. Furthermore, the object-side surface of the fifth lens element E5 includes one inflection point.

The sixth lens element E6 with negative refractive power has an object-side surface being convex in a paraxial region thereof and an image-side surface being concave in a paraxial region thereof. The sixth lens element E6 is made of a plastic material, and has the object-side surface and the image-side surface being both aspheric. Furthermore, the object-side surface of the sixth lens element E6 includes two inflection points and one critical point, and the image-side surface of the sixth lens element E6 includes two inflection points and one critical point.

The seventh lens element E7 with positive refractive power has an object-side surface being concave in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes three inflection points, and the image-side surface of the seventh lens element E7 includes three inflection points.

The eighth lens element E8 with negative refractive power has an object-side surface being convex in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes three inflection points and three critical points, and the image-side surface of the eighth lens element E8 includes one inflection point and one critical point.

The filter E9 is made of a glass material, which is located between the eighth lens element E8 and the image surface IMG in order, and will not affect the focal length of the image capturing optical lens assembly.

The detailed optical data of the 5th embodiment are shown in Table 5A and the aspheric surface data are shown in Table 5B below.

TABLE 5A
5th Embodiment
f = 6.64 mm, Fno = 1.63, HFOV = 45.6 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | −68.8078 | ASP | 0.627 | Plastic | 1.511 | 56.8 | −48.35 |
| 2 | | 38.6517 | ASP | 3.176 | | | | |
| 3 | Lens 2 | −4.0051 | ASP | 1.288 | Plastic | 1.551 | 44.8 | −93.68 |
| 4 | | −4.8381 | ASP | 0.594 | | | | |
| 5 | Ape. Stop | Plano | | −0.544 | | | | |
| 6 | Lens 3 | 5.0218 | ASP | 1.485 | Plastic | 1.544 | 56.0 | 7.77 |
| 7 | | −23.8888 | ASP | 0.050 | | | | |
| 8 | Lens 4 | 8.4325 | SPH | 1.175 | Plastic | 1.544 | 56.0 | 16.42 |
| 9 | | 142.8571 | SPH | 0.043 | | | | |
| 10 | Lens 5 | 35.8433 | ASP | 0.686 | Plastic | 1.680 | 18.2 | −11.37 |
| 11 | | 6.3095 | ASP | 1.442 | | | | |
| 12 | Lens 6 | 322.5806 | ASP | 0.949 | Plastic | 1.511 | 56.8 | −184.90 |
| 13 | | 72.9915 | ASP | 0.654 | | | | |
| 14 | Lens 7 | −1486.0541 | ASP | 1.045 | Plastic | 1.562 | 44.6 | 6.26 |
| 15 | | −3.5121 | ASP | 0.837 | | | | |
| 16 | Lens 8 | 488.6483 | ASP | 0.743 | Plastic | 1.587 | 28.3 | −5.48 |
| 17 | | 3.1956 | ASP | 0.650 | | | | |

| | | | | | | | |
|---|---|---|---|---|---|---|---|
| 18 | Filter | Plano | 0.180 | Glass | 1.517 | 64.2 | — |
| 19 | | Plano | 0.652 | | | | |
| 20 | Image | Plano | — | | | | |

Reference wavelength is 587.6 nm (d-line).

TABLE 5B
Aspheric Coefficients

| Surface # | 1 | 2 | 3 | 4 | 6 | 7 |
|---|---|---|---|---|---|---|
| k= | −9.00000E+01 | −7.25460E+01 | −5.80434E+00 | −7.39441E+00 | −1.15560E+00 | 4.17138E+01 |
| A4= | 5.676941E−03 | 6.991340E−03 | −4.742072E−03 | −4.307962E−03 | −2.240526E−03 | −5.193743E−03 |
| A6= | −4.042628E−04 | −4.101576E−04 | 4.296259E−04 | 7.456065E−04 | 4.081203E−04 | 8.966743E−04 |
| A8= | 3.161296E−05 | 3.170383E−05 | −3.132051E−05 | −8.730484E−05 | −4.980726E−05 | −1.032629E−04 |
| A10= | −2.408193E−06 | −2.298613E−06 | 2.869778E−06 | 9.341737E−06 | 4.978733E−06 | 8.917227E−06 |
| A12= | 1.260473E−07 | 6.558154E−08 | −1.819212E−07 | −6.014086E−07 | −2.609906E−07 | −3.982192E−07 |
| A14= | −4.397699E−09 | −2.207675E−10 | 4.678302E−09 | 1.601825E−08 | | |
| A16= | 9.688960E−11 | | | | | |
| A18= | −9.856213E−13 | | | | | |
| Surface # | 10 | 11 | 12 | 13 | 14 | 15 |
| k= | 8.73816E+01 | 1.43018E+00 | −9.00000E+01 | −9.00000E+01 | 9.00000E+01 | −9.85649E+00 |
| A4= | −3.827127E−03 | −1.995857E−03 | −6.631285E−03 | −8.626555E−03 | 9.873009E−04 | −7.230343E−03 |
| A6= | 1.524369E−03 | 1.188726E−03 | −6.813478E−05 | −8.967082E−04 | −1.711198E−03 | 2.970082E−03 |
| A8= | −2.870220E−04 | −2.146859E−04 | 3.076804E−04 | 4.337355E−04 | 5.002221E−04 | −7.089780E−04 |
| A10= | 3.450926E−05 | 2.143388E−05 | −1.462028E−04 | −1.317775E−04 | −1.266872E−04 | 1.298611E−04 |
| A12= | −2.678884E−06 | −2.791374E−07 | 3.908118E−05 | 2.403582E−05 | 2.167749E−05 | −1.679039E−05 |
| A14= | 9.047667E−08 | −1.525739E−07 | −6.439131E−06 | −2.546813E−06 | −2.556934E−06 | 1.417566E−06 |
| A16= | | 9.488555E−09 | 6.443787E−07 | 1.455891E−07 | 1.972178E−07 | −7.597330E−08 |
| A18= | | | −3.482813E−08 | −3.349695E−09 | −9.084038E−09 | 2.507973E−09 |
| A20= | | | 7.651531E−10 | | 1.927245E−10 | −4.700391E−11 |
| A22= | | | | | | 3.878215E−13 |

| Surface # | 16 | 17 |
|---|---|---|
| k= | 9.00000E+01 | −7.45581E+00 |
| A4= | −1.304952E−02 | −9.760038E−03 |
| A6= | 1.719283E−03 | 1.407687E−03 |
| A8= | −1.936747E−04 | −1.735097E−04 |
| A10= | 2.225375E−05 | 1.617041E−05 |
| A12= | −1.919542E−06 | −1.079046E−06 |
| A14= | 1.090383E−07 | 4.989360E−08 |
| A16= | −3.967110E−09 | −1.545497E−09 |
| A18= | 8.948088E−11 | 3.040269E−11 |
| A20= | −1.144084E−12 | −3.415445E−13 |
| A22= | 6.354676E−15 | 1.660927E−15 |

In the 5th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 5th embodiment, so an explanation in this regard will not be provided again.

Moreover, these parameters can be calculated from Table 5A and Table 5B as the following values and satisfy the following conditions in Table 5C:

TABLE 5C
5th Embodiment

| | | | |
|---|---|---|---|
| f [mm] | 6.64 | (R3 + R7)/(R3 − R7) | −0.36 |
| Fno | 1.63 | (\|R3\| + \|R4\| + R16)/f | 1.81 |
| HFOV [deg.] | 45.6 | CTmax/ATmax | 0.47 |
| FOV [deg.] | 91.2 | CT3/CT5 | 2.16 |
| f/EPD | 1.63 | (T67 + T78)/(CT1 + CT8) | 1.09 |
| tan(HFOV) | 1.02 | BL/T12 | 0.47 |
| EPD/ImgH | 0.59 | T45/T56 | 0.03 |
| f/ImgH | 0.97 | (T23 + T34 + T45)/T12 | 0.05 |
| SL/TL | 0.64 | V3/V4 | 1.00 |
| BL/SD | 0.17 | V7/V3 | 0.80 |
| f/f2 | −0.07 | tan(CRA) | 0.64 |
| f8/f1 | 0.11 | ET8/ET1 | 1.27 |
| f3/f4 | 0.47 | SAG2R1/CT2 | −0.87 |
| R3/f | −0.60 | SAG3R2/CT3 | −0.19 |
| f/R13 | −0.004 | SAG7R1/CT7 | −0.89 |
| R4/R5 | −0.96 | SAG8R1/CT8 | −0.87 |
| R16/R9 | 0.09 | Y8R2/Y7R1 | 1.80 |

### 6th Embodiment

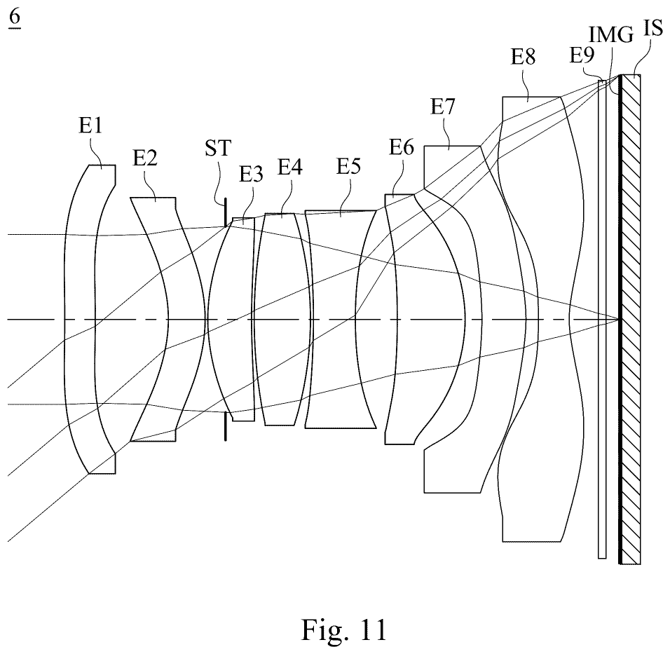

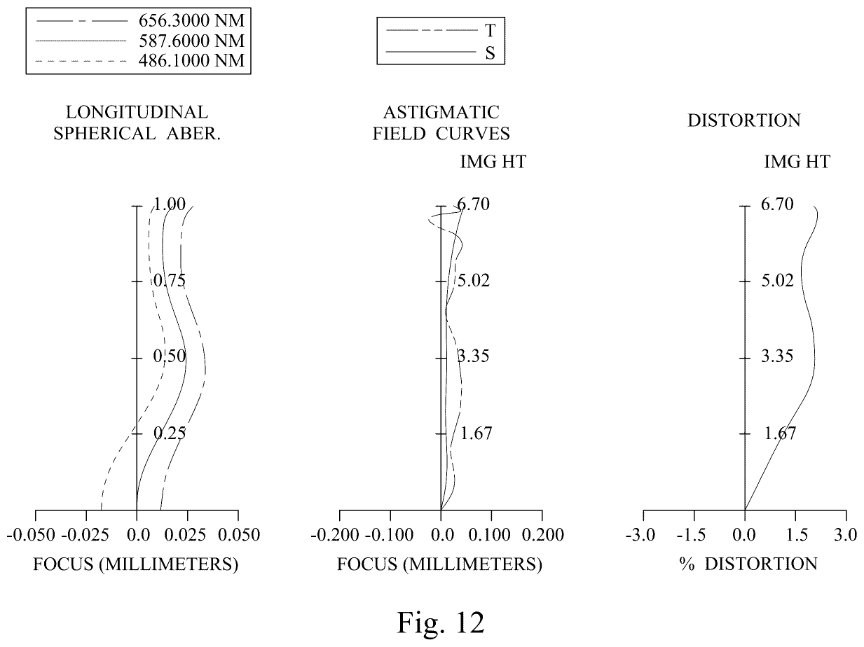

FIG. 11 is a schematic view of an imaging apparatus 6 according to the 6th embodiment of the present disclosure. FIG. 12 shows spherical aberration curves, astigmatic field curves and a distortion curve of the imaging apparatus 6 according to the 6th embodiment. In FIG. 11, the imaging apparatus 6 includes an image capturing optical lens assembly (its reference numeral is omitted) and an image sensor IS. The image capturing optical lens assembly includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the image capturing optical lens assembly. The image capturing optical lens assembly includes eight lens elements (E1, E2, E3, E4, E5, E6, E7, E8) without additional one or more lens elements inserted between the first lens element E1 and the eighth lens element E8, and there is an air gap along an optical axis between each two adjacent lens elements of the eight lens elements.

The first lens element E1 with positive refractive power has an object-side surface being concave in a paraxial region thereof and an image-side surface being convex in a paraxial region thereof. The first lens element E1 is made of a plastic material, and has the object-side surface and the image-side surface being both aspheric. Furthermore, the object-side surface of the first lens element E1 includes one inflection point and one critical point, and the image-side surface of the first lens element E1 includes one inflection point and one critical point.

The second lens element E2 with negative refractive power has an object-side surface being concave in a paraxial region thereof and an image-side surface being convex in a paraxial region thereof. The second lens element E2 is made of a plastic material, and has the object-side surface and the image-side surface being both aspheric. Furthermore, the object-side surface of the second lens element E2 includes one inflection point, and the image-side surface of the second lens element E2 includes one inflection point.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the image-side surface of the third lens element E3 includes one inflection point.

The fourth lens element E4 with positive refractive power has an object-side surface being convex in a paraxial region thereof and an image-side surface being convex in a paraxial region thereof. The fourth lens element E4 is made of a glass material, and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of a plastic material, and has the object-side surface and the image-side surface being both aspheric.

The sixth lens element E6 with positive refractive power has an object-side surface being concave in a paraxial region thereof and an image-side surface being convex in a paraxial region thereof. The sixth lens element E6 is made of a plastic material, and has the object-side surface and the image-side surface being both aspheric. Furthermore, the object-side surface of the sixth lens element E6 includes two inflection points, and the image-side surface of the sixth lens element E6 includes one inflection point.

The seventh lens element E7 with positive refractive power has an object-side surface being concave in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes one inflection point, and the image-side surface of the seventh lens element E7 includes two inflection points.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes one inflection point and one critical point, and the image-side surface of the eighth lens element E8 includes three inflection points and one critical point.

The filter E9 is made of a glass material, which is located between the eighth lens element E8 and the image surface IMG in order, and will not affect the focal length of the image capturing optical lens assembly.

The detailed optical data of the 6th embodiment are shown in Table 6A and the aspheric surface data are shown in Table 6B below.

TABLE 6A
6th Embodiment
f = 7.82 mm, Fno = 1.68, HFOV = 40.0 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | −40.1742 | ASP | 0.837 | Plastic | 1.551 | 44.8 | 217.70 |
| 2 | | −30.3141 | ASP | 2.005 | | | | |
| 3 | Lens 2 | −3.7367 | ASP | 1.006 | Plastic | 1.511 | 56.8 | −190.10 |
| 4 | | −4.2400 | ASP | 0.561 | | | | |
| 5 | Ape. Stop | Plano | | −0.488 | | | | |
| 6 | Lens 3 | 4.8068 | ASP | 1.198 | Plastic | 1.544 | 56.0 | 12.09 |
| 7 | | 16.2768 | ASP | 0.075 | | | | |
| 8 | Lens 4 | 13.8256 | SPH | 1.544 | Glass | 1.569 | 63.0 | 10.21 |
| 9 | | −9.6159 | SPH | 0.080 | | | | |
| 10 | Lens 5 | −19.8010 | ASP | 1.150 | Plastic | 1.639 | 23.5 | −11.33 |
| 11 | | 11.6668 | ASP | 1.148 | | | | |
| 12 | Lens 6 | −21.6075 | ASP | 1.859 | Plastic | 1.511 | 56.8 | 9.40 |
| 13 | | −4.0416 | ASP | 0.462 | | | | |
| 14 | Lens 7 | −7.3449 | ASP | 1.207 | Plastic | 1.529 | 45.4 | 19.19 |
| 15 | | −4.5046 | ASP | 0.341 | | | | |
| 16 | Lens 8 | −14.1163 | ASP | 0.844 | Plastic | 1.551 | 44.8 | −4.71 |
| 17 | | 3.2421 | ASP | 0.800 | | | | |

| | | | | | | | |
|---|---|---|---|---|---|---|---|
| 18 | Filter | Plano | 0.210 | Glass | 1.517 | 64.2 | — |
| 19 | | Plano | 0.390 | | | | |
| 20 | Image | Plano | — | | | | |

Reference wavelength is 587.6 nm (d-line).

TABLE 6B
Aspheric Coefficients

| Surface # | 1 | 2 | 3 | 4 | 6 | 7 |
|---|---|---|---|---|---|---|
| k= | 1.31916E+01 | 4.08979E+01 | −6.69057E+00 | −5.59628E+00 | −1.50655E+00 | −6.22065E+01 |
| A4= | 3.982954E−03 | 5.769991E−03 | −3.376090E−03 | −3.812641E−03 | −5.125849E−03 | −3.896201E−03 |
| A6= | −1.957719E−04 | −2.406999E−04 | −4.258746E−05 | 5.167464E−04 | 1.190954E−03 | 5.809071E−04 |
| A8= | 2.824044E−05 | 2.511662E−05 | 5.754574E−05 | −4.867071E−05 | −1.426299E−04 | −5.974632E−05 |
| A10= | −4.013953E−06 | −1.991453E−06 | −5.426010E−06 | 7.199514E−06 | 1.102628E−05 | 4.225712E−06 |
| A12= | 3.983045E−07 | 9.904446E−08 | 2.312607E−07 | −6.142220E−07 | −3.939878E−07 | −1.624022E−07 |
| A14= | −2.439473E−08 | −2.205791E−09 | −3.692736E−09 | 2.194796E−08 | | |
| A16= | 8.281331E−10 | | | | | |
| A18= | −1.190396E−11 | | | | | |
| Surface # | 10 | 11 | 12 | 13 | 14 | 15 |
| k= | −7.79605E+01 | 6.86239E+00 | −3.18073E+01 | 1.26291E−01 | −2.58622E+01 | −2.38584E+01 |
| A4= | −1.990662E−04 | 3.034783E−03 | −1.316639E−03 | 1.152322E−02 | 1.117820E−02 | 9.406023E−04 |
| A6= | 1.782963E−04 | −4.827208E−04 | −5.745056E−04 | −5.397936E−03 | −6.536436E−03 | 1.824426E−04 |
| A8= | −8.765557E−05 | 1.964481E−04 | 3.117974E−04 | 1.939651E−03 | 2.122096E−03 | −1.046425E−04 |
| A10= | 1.632151E−05 | −5.589968E−05 | −1.106642E−04 | −4.559797E−04 | −4.581563E−04 | 1.074286E−05 |
| A12= | −1.838933E−06 | 8.853771E−06 | 2.372080E−05 | 6.691197E−05 | 6.013776E−05 | −4.122840E−07 |
| A14= | 8.050187E−08 | −7.282461E−07 | −3.000066E−06 | −5.874911E−06 | −4.723659E−06 | −3.246560E−09 |
| A16= | | 2.376347E−08 | 2.113957E−07 | 2.825814E−07 | 2.008629E−07 | 8.899117E−10 |
| A18= | | | −6.367410E−09 | −5.657371E−09 | −3.477310E−09 | −3.092201E−11 |
| A20= | | | | | | 3.638302E−13 |

| Surface # | 16 | 17 |
|---|---|---|
| k= | 1.80811E+00 | −9.57818E+00 |
| A4= | −1.505303E−02 | −8.788509E−03 |
| A6= | 2.578173E−03 | 1.455405E−03 |
| A8= | −5.721836E−04 | −2.334192E−04 |
| A10= | 9.826899E−05 | 2.654499E−05 |
| A12= | −9.864578E−06 | −1.990574E−06 |
| A14= | 5.993526E−07 | 9.778482E−08 |
| A16= | −2.266636E−08 | −3.113069E−09 |
| A18= | 5.246955E−10 | 6.184616E−11 |
| A20= | −6.830875E−12 | −6.965735E−13 |
| A22= | 3.841566E−14 | 3.394468E−15 |

In the 6th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 6th embodiment, so an explanation in this regard will not be provided again.

Moreover, these parameters can be calculated from Table 6A and Table 6B as the following values and satisfy the following conditions in Table 6C:

TABLE 6C
6th Embodiment

| | | | |
|---|---|---|---|
| f [mm] | 7.82 | (R3 + R7)/(R3 − R7) | −0.57 |
| Fno | 1.68 | (\|R3\| + \|R4\| + R16)/f | 1.44 |
| HFOV [deg.] | 40.0 | CTmax/ATmax | 0.93 |
| FOV [deg.] | 80.0 | CT3/CT5 | 1.04 |
| f/EPD | 1.68 | (T67 + T78)/(CT1 + CT8) | 0.48 |
| tan(HFOV) | 0.84 | BL/T12 | 0.70 |
| EPD/ImgH | 0.69 | T45/T56 | 0.07 |
| f/ImgH | 1.17 | (T23 + T34 + T45)/T12 | 0.11 |
| SL/TL | 0.71 | V3/V4 | 0.89 |
| BL/SD | 0.15 | V7/V3 | 0.81 |
| f/f2 | −0.04 | tan(CRA) | 0.63 |
| f8/f1 | −0.02 | ET8/ET1 | 2.12 |
| f3/f4 | 1.18 | SAG2R1/CT2 | −1.13 |
| R3/f | −0.48 | SAG3R2/CT3 | 0.07 |
| f/R13 | −1.06 | SAG7R1/CT7 | −1.31 |
| R4/R5 | −0.88 | SAG8R1/CT8 | −1.16 |
| R16/R9 | −0.16 | Y8R2/Y7R1 | 1.70 |

### 7th Embodiment

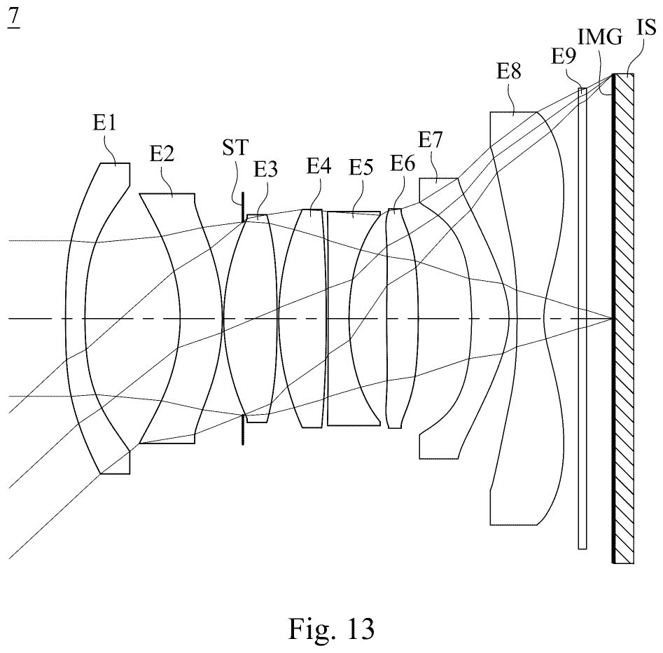

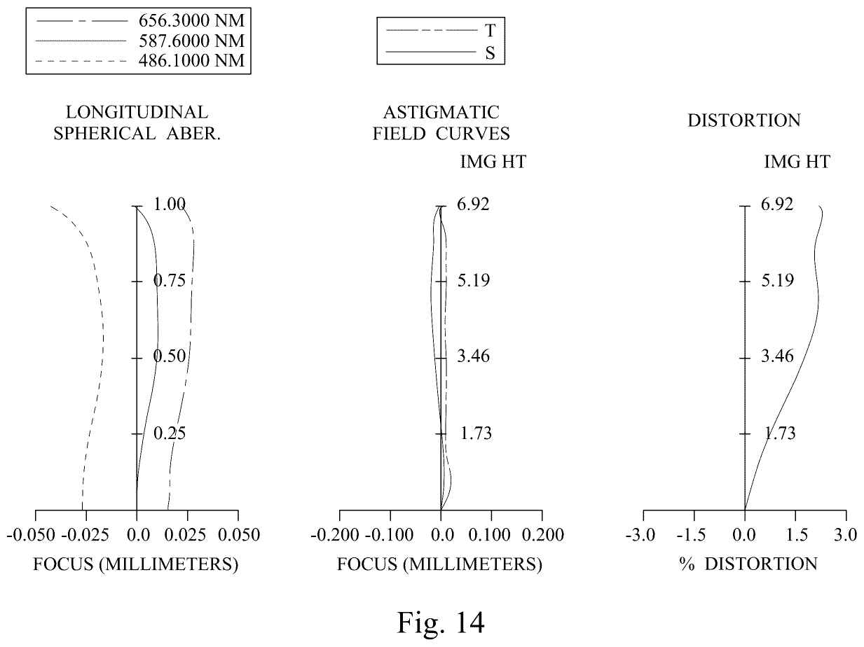

FIG. 13 is a schematic view of an imaging apparatus 7 according to the 7th embodiment of the present disclosure. FIG. 14 shows spherical aberration curves, astigmatic field curves and a distortion curve of the imaging apparatus 7 according to the 7th embodiment. In FIG. 13, the imaging apparatus 7 includes an image capturing optical lens assembly (its reference numeral is omitted) and an image sensor IS. The image capturing optical lens assembly includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the image capturing optical lens assembly. The image capturing optical lens assembly includes eight lens elements (E1, E2, E3, E4, E5, E6, E7, E8) without additional one or more lens elements inserted between the first lens element E1 and the eighth lens element E8, and there is an air gap along an optical axis between each two adjacent lens elements of the eight lens elements.

The first lens element E1 with negative refractive power has an object-side surface being convex in a paraxial region thereof and an image-side surface being concave in a paraxial region thereof. The first lens element E1 is made of a plastic material, and has the object-side surface and the image-side surface being both aspheric. Furthermore, the image-side surface of the first lens element E1 includes one inflection point.

The second lens element E2 with negative refractive power has an object-side surface being concave in a paraxial region thereof and an image-side surface being convex in a paraxial region thereof. The second lens element E2 is made of a plastic material, and has the object-side surface and the image-side surface being both aspheric. Furthermore, the object-side surface of the second lens element E2 includes one inflection point, and the image-side surface of the second lens element E2 includes one inflection point.

The third lens element E3 with positive refractive power has an object-side surface being convex in a paraxial region thereof and an image-side surface being convex in a paraxial region thereof. The third lens element E3 is made of a plastic material, and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of a plastic material, and has the object-side surface and the image-side surface being both spherical.

The fifth lens element E5 with negative refractive power has an object-side surface being convex in a paraxial region thereof and an image-side surface being concave in a paraxial region thereof. The fifth lens element E5 is made of a plastic material, and has the object-side surface and the image-side surface being both aspheric. Furthermore, the object-side surface of the fifth lens element E5 includes three reflection points and one critical point.

The sixth lens element E6 with positive refractive power has an object-side surface being convex in a paraxial region thereof and an image-side surface being convex in a paraxial region thereof. The sixth lens element E6 is made of a plastic material, and has the object-side surface and the image-side surface being both aspheric. Furthermore, the object-side surface of the sixth lens element E6 includes two inflection points and two critical points, and the image-side surface of the sixth lens element E6 includes one inflection point and one critical point.

The seventh lens element E7 with positive refractive power has an object-side surface being concave in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes one inflection point, and the image-side surface of the seventh lens element E7 includes one inflection point.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes two inflection points, and the image-side surface of the eighth lens element E8 includes one inflection point and one critical point.

The filter E9 is made of a glass material, which is located between the eighth lens element E8 and the image surface IMG in order, and will not affect the focal length of the image capturing optical lens assembly.

The detailed optical data of the 7th embodiment are shown in Table 7A and the aspheric surface data are shown in Table 7B below.

TABLE 7A
7th Embodiment
f = 7.27 mm, Fno = 1.65, HFOV = 42.9 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 45.0601 | ASP | 0.551 | Plastic | 1.545 | 56.1 | −34.59 |
| 2 | | 13.2328 | ASP | 2.699 | | | | |
| 3 | Lens 2 | −5.0000 | ASP | 1.197 | Plastic | 1.551 | 44.8 | −173.21 |
| 4 | | −5.7252 | ASP | 0.585 | | | | |
| 5 | Ape. Stop | Plano | | −0.546 | | | | |
| 6 | Lens 3 | 5.5928 | ASP | 1.514 | Plastic | 1.544 | 56.0 | 8.94 |
| 7 | | −33.7262 | ASP | 0.047 | | | | |
| 8 | Lens 4 | 7.4935 | SPH | 1.351 | Plastic | 1.544 | 56.0 | 11.57 |
| 9 | | −36.9086 | SPH | 0.050 | | | | |
| 10 | Lens 5 | 123.5820 | ASP | 0.593 | Plastic | 1.639 | 23.5 | −9.79 |
| 11 | | 5.9419 | ASP | 1.068 | | | | |
| 12 | Lens 6 | 35.9125 | ASP | 0.896 | Plastic | 1.551 | 44.8 | 23.92 |
| 13 | | −20.6180 | ASP | 1.514 | | | | |
| 14 | Lens 7 | −10.0522 | ASP | 1.061 | Plastic | 1.584 | 28.2 | 5.12 |
| 15 | | −2.3947 | ASP | 0.228 | | | | |
| 16 | Lens 8 | −29.8227 | ASP | 0.760 | Plastic | 1.584 | 28.2 | −3.81 |
| 17 | | 2.4266 | ASP | 0.980 | | | | |

| | | | | | | | |
|---|---|---|---|---|---|---|---|
| 18 | Filter | Plano | 0.230 | Glass | 1.517 | 64.2 | — |
| 19 | | Plano | 0.768 | | | | |
| 20 | Image | Plano | — | | | | |

Reference wavelength is 587.6 nm (d-line).

TABLE 7B
Aspheric Coefficients

| Surface # | 1 | 2 | 3 | 4 | 6 | 7 |
|---|---|---|---|---|---|---|
| k= | 2.47316E+01 | 3.14455E−01 | −6.95432E+00 | −6.05576E+00 | −1.21279E+00 | 5.48455E+01 |
| A4= | 6.135518E−03 | 7.698450E−03 | −4.021975E−03 | −3.481643E−03 | −2.102936E−03 | −2.925608E−03 |
| A6= | −4.930032E−04 | −4.241941E−04 | 1.587218E−05 | 2.426435E−04 | 3.067225E−04 | 1.049892E−04 |
| A8= | 3.890880E−05 | 1.827015E−05 | 2.389518E−05 | 5.099913E−06 | −2.242741E−05 | 1.097339E−05 |
| A10= | −3.560039E−06 | −6.274051E−07 | −1.284316E−06 | −6.836976E−07 | 8.999653E−07 | −1.636978E−06 |
| A12= | 2.724928E−07 | −3.680233E−11 | 2.216175E−08 | 4.032898E−08 | −1.993749E−08 | 5.921118E−08 |
| A14= | −1.398262E−08 | | | | | |
| A16= | 4.128973E−10 | | | | | |
| A18= | −5.212174E−12 | | | | | |
| Surface # | 10 | 11 | 12 | 13 | 14 | 15 |
| k= | 6.99891E+01 | 9.04141E−01 | −7.80610E+01 | 2.34717E+01 | 5.97885E+00 | −7.38763E+00 |
| A4= | −4.000572E−03 | −3.479316E−03 | −2.922459E−03 | −3.086565E−03 | −4.110353E−03 | −1.070695E−02 |
| A6= | 1.105134E−03 | 1.169141E−03 | 1.449972E−04 | 1.364211E−04 | 8.440583E−04 | 3.883538E−03 |
| A8= | −1.409133E−04 | −1.691365E−04 | −1.981143E−04 | −1.852117E−04 | −3.905277E−04 | −9.669568E−04 |
| A10= | 9.820664E−06 | 2.278249E−05 | 9.521588E−05 | 6.008029E−05 | 6.357351E−05 | 1.386216E−04 |
| A12= | −4.694097E−07 | −2.778803E−06 | −2.529665E−05 | −1.118280E−05 | −5.135737E−06 | −8.464579E−06 |
| A14= | 1.240666E−08 | 2.354060E−07 | 4.321707E−06 | 1.327084E−06 | 2.219232E−07 | −3.115022E−07 |
| A16= | | −9.171550E−09 | −4.562089E−07 | −9.106258E−08 | −1.453036E−08 | 8.520542E−08 |
| A18= | | | 2.754881E−08 | 2.867137E−09 | 8.351946E−10 | −5.616187E−09 |
| A20= | | | −7.262171E−10 | | | 1.681757E−10 |
| A22= | | | | | | −1.969366E−12 |

| Surface # | 16 | 17 |
|---|---|---|
| k= | −8.94578E+01 | −8.64785E+00 |
| A4= | −7.151964E−03 | −7.171343E−03 |
| A6= | 6.548552E−04 | 7.769056E−04 |
| A8= | 2.786657E−06 | −5.519017E−05 |
| A10= | −3.967679E−06 | 1.570272E−06 |
| A12= | 3.261716E−07 | 9.941979E−08 |
| A14= | −2.180229E−08 | −1.287391E−08 |
| A16= | 1.454123E−09 | 6.346070E−10 |
| A18= | −6.720683E−11 | −1.705296E−11 |
| A20= | 1.682595E−12 | 2.465916E−13 |
| A22= | −1.727746E−14 | −1.512456E−15 |

In the 7th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 7th embodiment, so an explanation in this regard will not be provided again.

Moreover, these parameters can be calculated from Table 7A and Table 7B as the following values and satisfy the following conditions in Table 7C:

TABLE 7C
7th Embodiment

| | | | |
|---|---|---|---|
| f [mm] | 7.27 | (R3 + R7)/(R3 − R7) | −0.20 |
| Fno | 1.65 | (\|R3\| + \|R4\| + R16)/f | 1.81 |
| HFOV [deg.] | 42.9 | CTmax/ATmax | 0.56 |
| FOV [deg.] | 85.8 | CT3/CT5 | 2.55 |
| f/EPD | 1.65 | (T67 + T78)/(CT1 + CT8) | 1.33 |
| tan(HFOV) | 0.93 | BL/T12 | 0.73 |
| EPD/ImgH | 0.64 | T45/T56 | 0.05 |
| f/ImgH | 1.05 | (T23 + T34 + T45)/T12 | 0.05 |
| SL/TL | 0.68 | V3/V4 | 1.00 |
| BL/SD | 0.23 | V7/V3 | 0.50 |
| f/f2 | −0.04 | tan(CRA) | 0.72 |
| f8/f1 | 0.11 | ET8/ET1 | 1.59 |
| f3/f4 | 0.77 | SAG2R1/CT2 | −0.97 |
| R3/f | −0.69 | SAG3R2/CT3 | −0.19 |
| f/R13 | −0.72 | SAG7R1/CT7 | −1.39 |
| R4/R5 | −1.02 | SAG8R1/CT8 | −1.00 |
| R16/R9 | 0.02 | Y8R2/Y7R1 | 1.78 |

### 8th Embodiment

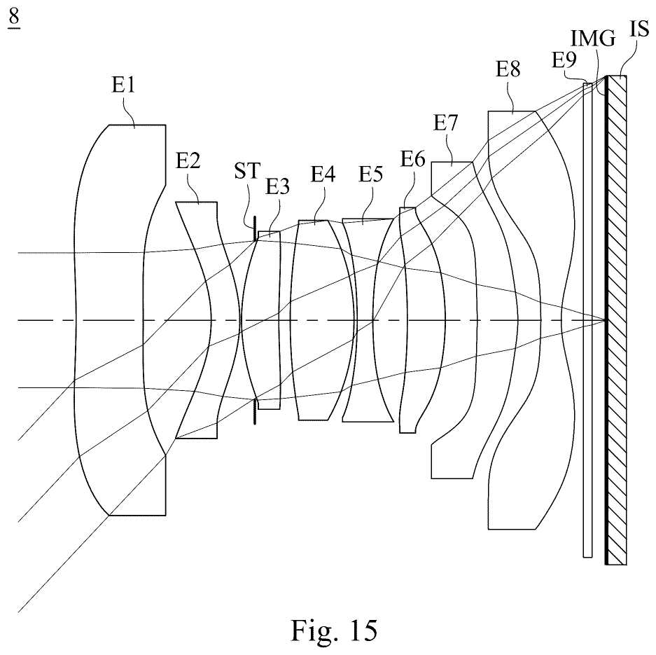

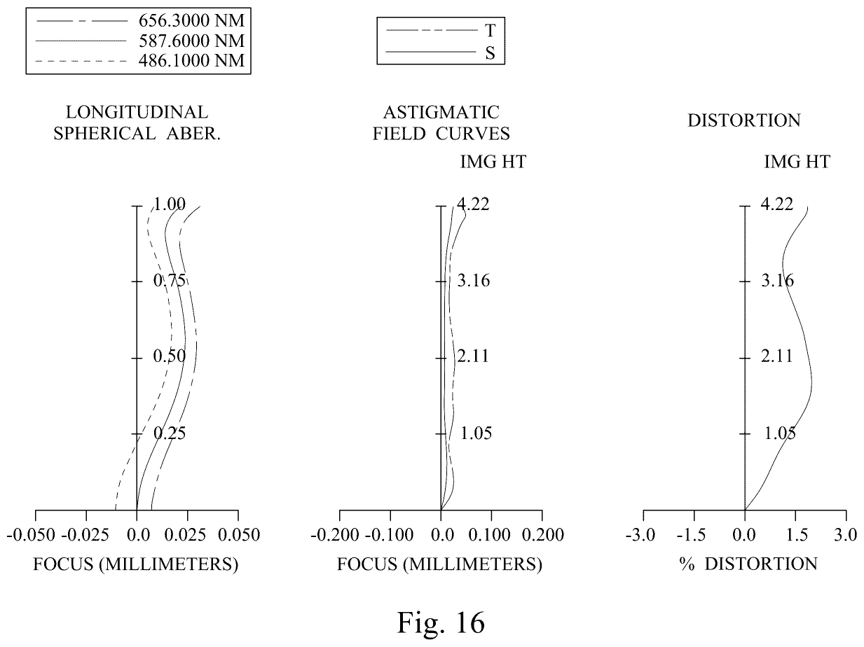

FIG. 15 is a schematic view of an imaging apparatus 8 according to the 8th embodiment of the present disclosure. FIG. 16 shows spherical aberration curves, astigmatic field curves and a distortion curve of the imaging apparatus 8 according to the 8th embodiment. In FIG. 15, the imaging apparatus 8 includes an image capturing optical lens assembly (its reference numeral is omitted) and an image sensor IS. The image capturing optical lens assembly includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the image capturing optical lens assembly. The image capturing optical lens assembly includes eight lens elements (E1, E2, E3, E4, E5, E6, E7, E8) without additional one or more lens elements inserted between the first lens element E1 and the eighth lens element E8, and there is an air gap along an optical axis between each two adjacent lens elements of the eight lens elements.

The first lens element E1 with negative refractive power has an object-side surface being concave in a paraxial region thereof and an image-side surface being convex in a paraxial region thereof. The first lens element E1 is made of a plastic material, and has the object-side surface and the image-side surface being both aspheric. Furthermore, the object-side surface of the first lens element E1 includes one inflection point and one critical point, and the image-side surface of the first lens element E1 includes two inflection points and one critical point.

The second lens element E2 with positive refractive power has an object-side surface being concave in a paraxial region thereof and an image-side surface being convex in a paraxial region thereof. The second lens element E2 is made of a plastic material, and has the object-side surface and the image-side surface being both aspheric. Furthermore, the object-side surface of the second lens element E2 includes one inflection point, and the image-side surface of the second lens element E2 includes one inflection point and one critical point.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the object-side surface of the third lens element E3 includes one inflection point, and the image-side surface of the third lens element E3 includes one inflection point and one critical point.

The fourth lens element E4 with positive refractive power has an object-side surface being convex in a paraxial region thereof and an image-side surface being convex in a paraxial region thereof. The fourth lens element E4 is made of a glass material, and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of a plastic material, and has the object-side surface and the image-side surface being both aspheric.

The sixth lens element E6 with positive refractive power has an object-side surface being concave in a paraxial region thereof and an image-side surface being convex in a paraxial region thereof. The sixth lens element E6 is made of a plastic material, and has the object-side surface and the image-side surface being both aspheric. Furthermore, the object-side surface of the sixth lens element E6 includes one inflection point and one critical point, and the image-side surface of the sixth lens element E6 includes one inflection point and one critical point.

The seventh lens element E7 with positive refractive power has an object-side surface being concave in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes three inflection points, and the image-side surface of the seventh lens element E7 includes three inflection points.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes two inflection points, and the image-side surface of the eighth lens element E8 includes one inflection point and one critical point.

The filter E9 is made of a glass material, which is located between the eighth lens element E8 and the image surface IMG in order, and will not affect the focal length of the image capturing optical lens assembly.

The detailed optical data of the 8th embodiment are shown in Table 8A and the aspheric surface data are shown in Table 8B below.

TABLE 8A
8th Embodiment
f = 3.87 mm, Fno = 1.66, HFOV = 46.9 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | −13.4165 | ASP | 1.158 | Plastic | 1.545 | 56.1 | −37.27 |
| 2 | | −40.7230 | ASP | 1.176 | | | | |
| 3 | Lens 2 | −2.2226 | ASP | 0.494 | Plastic | 1.544 | 56.0 | 206.21 |
| 4 | | −2.3501 | ASP | 0.260 | | | | |
| 5 | Ape. Stop | Plano | | −0.230 | | | | |
| 6 | Lens 3 | 3.0966 | ASP | 0.644 | Plastic | 1.544 | 55.9 | 8.29 |
| 7 | | 9.1726 | ASP | 0.196 | | | | |
| 8 | Lens 4 | 9.4251 | SPH | 1.105 | Glass | 1.692 | 54.5 | 3.82 |
| 9 | | −3.4996 | SPH | 0.053 | | | | |
| 10 | Lens 5 | −8.0295 | ASP | 0.270 | Plastic | 1.639 | 23.5 | −5.59 |
| 11 | | 6.5027 | ASP | 0.597 | | | | |
| 12 | Lens 6 | −10.4855 | ASP | 0.656 | Plastic | 1.544 | 56.0 | 11.83 |
| 13 | | −4.0768 | ASP | 0.551 | | | | |
| 14 | Lens 7 | −7.6346 | ASP | 0.702 | Plastic | 1.529 | 45.4 | 5.87 |
| 15 | | −2.2776 | ASP | 0.397 | | | | |
| 16 | Lens 8 | −7.2521 | ASP | 0.352 | Plastic | 1.551 | 44.8 | −2.88 |
| 17 | | 2.0675 | ASP | 0.384 | | | | |

| | | | | | | | |
|---|---|---|---|---|---|---|---|
| 18 | Filter | Plano | 0.150 | Glass | 1.517 | 64.2 | — |
| 19 | | Plano | 0.248 | | | | |
| 20 | Image | Plano | — | | | | |

Reference wavelength is 587.6 nm (d-line).

TABLE 8B
Aspheric Coefficients

| Surface # | 1 | 2 | 3 | 4 | 6 | 7 |
|---|---|---|---|---|---|---|
| k= | 1.22879E+01 | 8.72253E+01 | −7.33084E+00 | −7.09182E+00 | −1.58976E+00 | −8.16240E+01 |
| A4= | 1.357253E−02 | 2.292687E−02 | −2.837806E−02 | −2.926594E−02 | −2.787326E−02 | −3.263347E−02 |
| A6= | −1.347104E−03 | −2.637338E−03 | 7.319659E−03 | 2.214998E−02 | 2.521299E−02 | 1.772769E−02 |
| A8= | 1.672565E−04 | 4.561343E−04 | 1.326620E−03 | −9.766341E−03 | −1.340201E−02 | −6.839290E−03 |
| A10= | −1.168517E−05 | −1.654448E−05 | −9.372649E−04 | 4.052206E−03 | 4.616681E−03 | 2.339576E−03 |
| A12= | −4.626663E−08 | −5.616711E−06 | 1.703195E−04 | −1.033674E−03 | −8.208439E−04 | −4.945942E−04 |
| A14= | 1.021116E−07 | 2.245140E−07 | −1.072498E−05 | 1.140137E−04 | | |
| A16= | −8.886037E−09 | | | | | |
| A18= | 2.826914E−10 | | | | | |
| Surface # | 10 | 11 | 12 | 13 | 14 | 15 |
| k= | 1.59055E+01 | 5.84654E+00 | −6.05345E+01 | 1.13436E+00 | −5.07845E+01 | −1.56856E+01 |
| A4= | −1.744000E−02 | −3.999630E−03 | 4.229222E−03 | 3.730215E−02 | 8.393385E−02 | 7.359607E−02 |
| A6= | 1.622484E−02 | 1.119072E−02 | −2.175269E−02 | −6.669599E−02 | −1.017192E−01 | −6.958978E−02 |
| A8= | −6.695759E−03 | −2.639733E−03 | 2.082042E−02 | 6.084394E−02 | 6.275676E−02 | 2.595624E−02 |
| A10= | 1.860980E−03 | −1.669355E−04 | −1.257842E−02 | −3.914944E−02 | −2.848914E−02 | −5.099599E−03 |
| A12= | −4.773143E−04 | 2.605333E−04 | 4.380089E−03 | 1.684149E−02 | 8.833975E−03 | 4.177790E−04 |
| A14= | 6.071808E−05 | −9.484920E−05 | −7.248192E−04 | −4.611517E−03 | −1.794433E−03 | 3.099371E−05 |
| A16= | | 1.330291E−05 | 4.311310E−05 | 7.307849E−04 | 2.099628E−04 | −1.002669E−05 |
| A18= | | | | −4.985516E−05 | −1.027884E−05 | 8.241082E−07 |
| A20= | | | | | | −2.366484E−08 |

| Surface # | 16 | 17 |
|---|---|---|
| k= | 2.31377E+00 | −4.42658E+00 |
| A4= | 5.247898E−02 | −5.055363E−02 |
| A6= | −1.196756E−01 | 5.573035E−03 |
| A8= | 6.406124E−02 | 1.351991E−03 |
| A10= | −1.769775E−02 | −5.503147E−04 |
| A12= | 2.981082E−03 | 8.424823E−05 |
| A14= | −3.188961E−04 | −7.144974E−06 |
| A16= | 2.123299E−05 | 3.499317E−07 |
| A18= | −8.046847E−07 | −9.079012E−09 |
| A20= | 1.328034E−08 | 9.175775E−11 |

In the 8th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 8th embodiment, so an explanation in this regard will not be provided again.

Moreover, these parameters can be calculated from Table 8A and Table 8B as the following values and satisfy the following conditions in Table 8C:

TABLE 8C
8th Embodiment

| | | | |
|---|---|---|---|
| f [mm] | 3.87 | (R3 + R7)/(R3 − R7) | −0.62 |
| Fno | 1.66 | (\|R3\| + \|R4\| + R16)/f | 1.72 |
| HFOV [deg.] | 46.9 | CTmax/ATmax | 0.98 |
| FOV [deg.] | 93.8 | CT3/CT5 | 2.39 |
| f/EPD | 1.66 | (T67 + T78)/(CT1 + CT8) | 0.63 |
| tan(HFOV) | 1.07 | BL/T12 | 0.67 |
| EPD/ImgH | 0.55 | T45/T56 | 0.09 |
| f/ImgH | 0.92 | (T23 + T34 + T45)/T12 | 0.24 |
| SL/TL | 0.66 | V3/V4 | 1.03 |
| BL/SD | 0.15 | V7/V3 | 0.81 |
| f/f2 | 0.02 | tan(CRA) | 0.72 |
| f8/f1 | 0.08 | ET8/ET1 | 0.84 |
| f3/f4 | 2.17 | SAG2R1/CT2 | −1.26 |
| R3/f | −0.57 | SAG3R2/CT3 | 0.03 |
| f/R13 | −0.51 | SAG7R1/CT7 | −1.13 |
| R4/R5 | −0.76 | SAG8R1/CT8 | −2.58 |
| R16/R9 | −0.26 | Y8R2/Y7R1 | 1.68 |

### 9th Embodiment

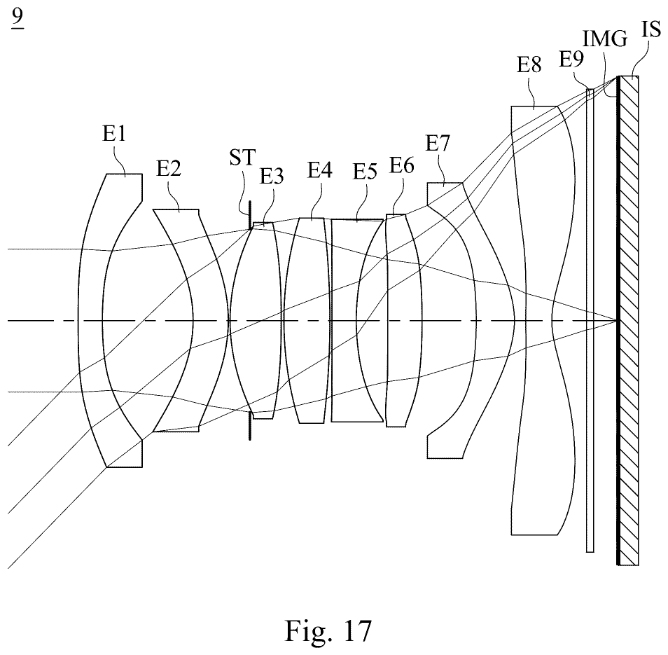

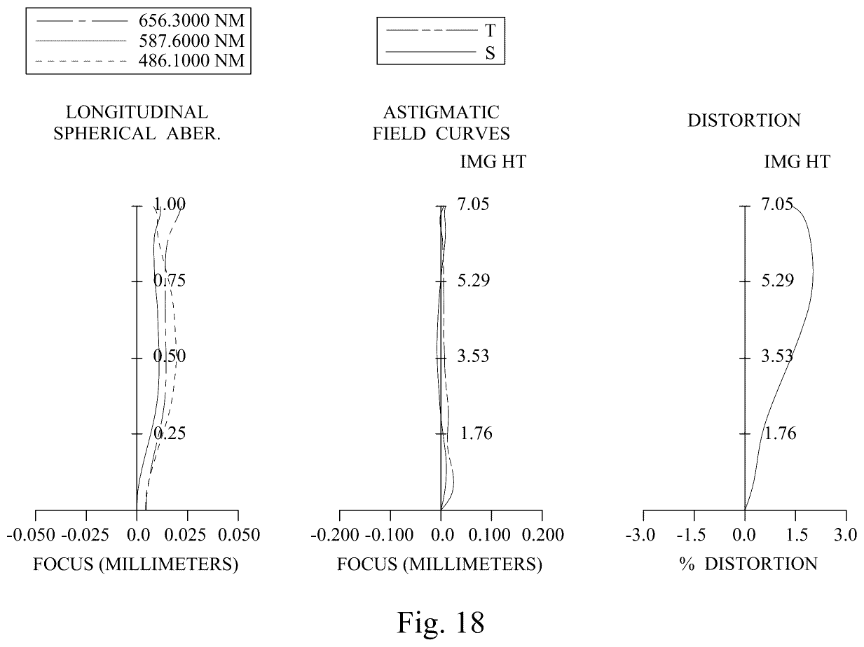

FIG. 17 is a schematic view of an imaging apparatus 9 according to the 9th embodiment of the present disclosure. FIG. 18 shows spherical aberration curves, astigmatic field curves and a distortion curve of the imaging apparatus 9 according to the 9th embodiment. In FIG. 17, the imaging apparatus 9 includes an image capturing optical lens assembly (its reference numeral is omitted) and an image sensor IS. The image capturing optical lens assembly includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the image capturing optical lens assembly. The image capturing optical lens assembly includes eight lens elements (E1, E2, E3, E4, E5, E6, E7, E8) without additional one or more lens elements inserted between the first lens element E1 and the eighth lens element E8, and there is an air gap along an optical axis between each two adjacent lens elements of the eight lens elements.

The first lens element E1 with negative refractive power has an object-side surface being convex in a paraxial region thereof and an image-side surface being concave in a paraxial region thereof. The first lens element E1 is made of a plastic material, and has the object-side surface and the image-side surface being both aspheric. Furthermore, the object-side surface of the first lens element E1 includes one inflection point, and the image-side surface of the first lens element E1 includes one inflection point.

The second lens element E2 with negative refractive power has an object-side surface being concave in a paraxial region thereof and an image-side surface being convex in a paraxial region thereof. The second lens element E2 is made of a plastic material, and has the object-side surface and the image-side surface being both aspheric. Furthermore, the object-side surface of the second lens element E2 includes one inflection point, and the image-side surface of the second lens element E2 includes one inflection point.

The third lens element E3 with positive refractive power has an object-side surface being convex in a paraxial region thereof and an image-side surface being convex in a paraxial region thereof. The third lens element E3 is made of a plastic material, and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of a glass material, and has the object-side surface and the image-side surface being both spherical.

The fifth lens element E5 with negative refractive power has an object-side surface being convex in a paraxial region thereof and an image-side surface being concave in a paraxial region thereof. The fifth lens element E5 is made of a plastic material, and has the object-side surface and the image-side surface being both aspheric. Furthermore, the object-side surface of the fifth lens element E5 includes three inflection points and three critical points.

The sixth lens element E6 with positive refractive power has an object-side surface being convex in a paraxial region thereof and an image-side surface being convex in a paraxial region thereof. The sixth lens element E6 is made of a plastic material, and has the object-side surface and the image-side surface being both aspheric. Furthermore, the object-side surface of the sixth lens element E6 includes two inflection points and two critical points, and the image-side surface of the sixth lens element E6 includes one inflection point and one critical point.

The seventh lens element E7 with positive refractive power has an object-side surface being concave in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes one inflection point, and the image-side surface of the seventh lens element E7 includes one inflection point.

The eighth lens element E8 with negative refractive power has an object-side surface being convex in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes five inflection points and one critical point, and the image-side surface of the eighth lens element E8 includes one inflection point and one critical point.

The filter E9 is made of a glass material, which is located between the eighth lens element E8 and the image surface IMG in order, and will not affect the focal length of the image capturing optical lens assembly.

The detailed optical data of the 9th embodiment are shown in Table 9A and the aspheric surface data are shown in Table 9B below.

TABLE 9A
9th Embodiment
f = 6.76 mm, Fno = 1.64, HFOV = 45.8 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 58.5475 | ASP | 0.700 | Plastic | 1.545 | 56.1 | −25.92 |
| 2 | | 11.3317 | ASP | 2.617 | | | | |
| 3 | Lens 2 | −3.7451 | ASP | 1.015 | Plastic | 1.544 | 56.0 | −122.22 |
| 4 | | −4.3476 | ASP | 0.625 | | | | |
| 5 | Ape. Stop | Plano | | −0.575 | | | | |
| 6 | Lens 3 | 5.2164 | ASP | 1.475 | Plastic | 1.544 | 56.0 | 8.48 |
| 7 | | −35.8792 | ASP | 0.079 | | | | |
| 8 | Lens 4 | 10.0000 | (SPH) | 1.326 | Glass | 1.620 | 60.4 | 11.61 |
| 9 | | −24.4106 | (SPH) | 0.060 | | | | |
| 10 | Lens 5 | 119.3312 | ASP | 0.700 | Plastic | 1.660 | 20.4 | −10.36 |
| 11 | | 6.4506 | ASP | 0.907 | | | | |
| 12 | Lens 6 | 108.6916 | ASP | 0.992 | Plastic | 1.544 | 56.0 | 31.01 |
| 13 | | −19.9032 | ASP | 1.563 | | | | |
| 14 | Lens 7 | −11.4272 | ASP | 1.103 | Plastic | 1.566 | 37.4 | 5.12 |
| 15 | | −2.3932 | ASP | 0.327 | | | | |
| 16 | Lens 8 | 62.2713 | ASP | 0.750 | Plastic | 1.615 | 25.4 | −4.11 |
| 17 | | 2.4188 | ASP | 1.000 | | | | |

| | | | | | | | |
|---|---|---|---|---|---|---|---|
| 18 | Filter | Plano | 0.210 | Glass | 1.517 | 64.2 | — |
| 19 | | Plano | 0.709 | | | | |
| 20 | Image | Plano | — | | | | |

Reference wavelength is 587.6 nm (d-line).

TABLE 9B
Aspheric Coefficients

| Surface # | 1 | 2 | 3 | 4 | 6 | 7 |
|---|---|---|---|---|---|---|
| k= | −9.00000E+01 | 6.93368E−01 | −5.64342E+00 | −5.67640E+00 | −1.09374E+00 | 5.97352E+01 |
| A4= | 6.004573E−03 | 7.778361E−03 | −6.185792E−03 | −4.506309E−03 | −2.597945E−03 | −5.151586E−03 |
| A6= | −5.096583E−04 | −4.765385E−04 | 4.813390E−04 | 5.455679E−04 | 5.443900E−04 | 8.258603E−04 |
| A8= | 4.557263E−05 | 3.636846E−05 | −1.855493E−05 | −3.347372E−05 | −6.477894E−05 | −8.971421E−05 |
| A10= | −4.090489E−06 | −2.268115E−06 | 7.519564E−07 | 2.016402E−06 | 5.376910E−06 | 6.821554E−06 |
| A12= | 2.839808E−07 | 4.052147E−08 | −1.991703E−08 | −4.912704E−08 | −2.323996E−07 | −2.824479E−07 |
| A14= | −1.369058E−08 | | | | | |
| A16= | 4.023230E−10 | | | | | |
| A18= | −5.301318E−12 | | | | | |
| Surface # | 10 | 11 | 12 | 13 | 14 | 15 |
| k= | −9.00000E+01 | 1.05828E+00 | 6.11829E+01 | 1.28855E+01 | 6.18348E+00 | −6.89133E+00 |
| A4= | −5.138228E−03 | −4.093602E−03 | −3.243767E−03 | −2.930440E−03 | −3.080255E−03 | −8.656323E−03 |
| A6= | 1.851368E−03 | 1.692102E−03 | 3.934936E−04 | 2.840957E−05 | 3.374902E−04 | 2.735180E−03 |
| A8= | −3.361787E−04 | −2.902713E−04 | −1.994979E−04 | −6.143690E−05 | −3.890658E−04 | −7.968363E−04 |
| A10= | 3.867789E−05 | 3.116573E−05 | 7.803433E−05 | 1.718090E−05 | 1.019983E−04 | 1.428149E−04 |
| A12= | −2.884186E−06 | −1.527430E−06 | −1.999598E−05 | −3.342319E−06 | −1.505891E−05 | −1.389892E−05 |
| A14= | 9.615016E−08 | −2.531152E−08 | 3.359856E−06 | 4.372798E−07 | 1.376915E−06 | 6.238413E−07 |
| A16= | | 4.076987E−09 | −3.504217E−07 | −3.285694E−08 | −7.913645E−08 | 2.791660E−09 |
| A18= | | | 2.172226E−08 | 1.241653E−09 | 2.202703E−09 | −1.553211E−09 |
| A20= | | | −6.171032E−10 | | | 6.201526E−11 |
| A22= | | | | | | −8.212800E−13 |

| Surface # | 16 | 17 |
|---|---|---|
| k= | 1.29606E+01 | −7.68784E+00 |
| A4= | −5.258414E−03 | −6.601698E−03 |
| A6= | −2.874719E−04 | 7.109870E−04 |
| A8= | 1.901466E−04 | −6.021116E−05 |
| A10= | −2.689331E−05 | 4.010531E−06 |
| A12= | 2.111520E−06 | −2.053754E−07 |
| A14= | −1.051738E−07 | 7.665254E−09 |
| A16= | 3.405016E−09 | −1.969268E−10 |
| A18= | −6.959133E−11 | 3.238166E−12 |
| A20= | 8.170656E−13 | −3.012399E−14 |
| A22= | −4.209471E−15 | 1.177357E−16 |

In the 9th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 9th embodiment, so an explanation in this regard will not be provided again.

Moreover, these parameters can be calculated from Table 9A and Table 9B as the following values and satisfy the following conditions in Table 9C:

TABLE 9C
9th Embodiment

| | | | |
|---|---|---|---|
| f [mm] | 6.76 | (R3 + R7)/(R3 − R7) | −0.46 |
| Fno | 1.64 | (\|R3\| + \|R4\| + R16)/f | 1.56 |
| HFOV [deg.] | 45.8 | CTmax/ATmax | 0.56 |
| FOV [deg.] | 91.6 | CT3/CT5 | 2.11 |
| f/EPD | 1.64 | (T67 + T78)/(CT1 + CT8) | 1.30 |
| tan(HFOV) | 1.03 | BL/T12 | 0.73 |
| EPD/ImgH | 0.58 | T45/T56 | 0.07 |
| f/ImgH | 0.96 | (T23 + T34 + T45)/T12 | 0.07 |
| SL/TL | 0.68 | V3/V4 | 0.93 |
| BL/SD | 0.22 | V7/V3 | 0.67 |
| f/f2 | −0.06 | tan(CRA) | 0.69 |
| f8/f1 | 0.16 | ET8/ET1 | 1.26 |
| f3/f4 | 0.73 | SAG2R1/CT2 | −1.23 |
| R3/f | −0.55 | SAG3R2/CT3 | −0.17 |
| f/R13 | −0.59 | SAG7R1/CT7 | −1.28 |
| R4/R5 | −0.83 | SAG8R1/CT8 | −0.55 |
| R16/R9 | 0.02 | Y8R2/Y7R1 | 1.86 |

### 10th Embodiment

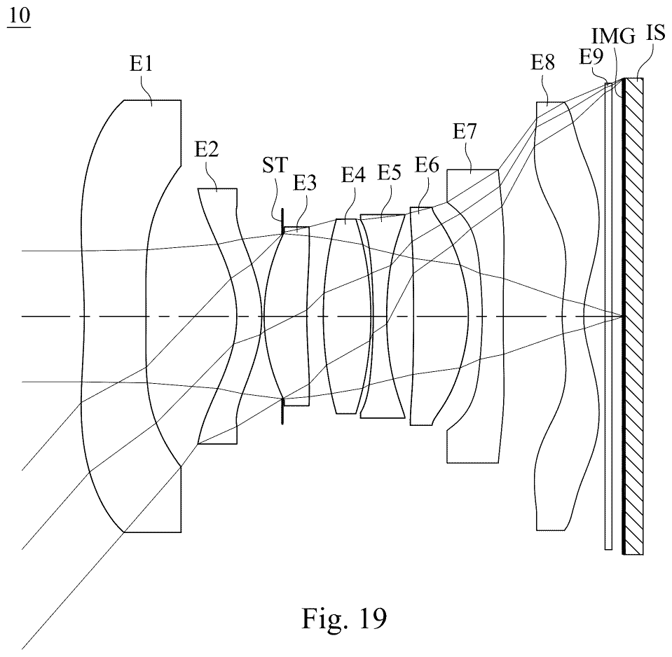

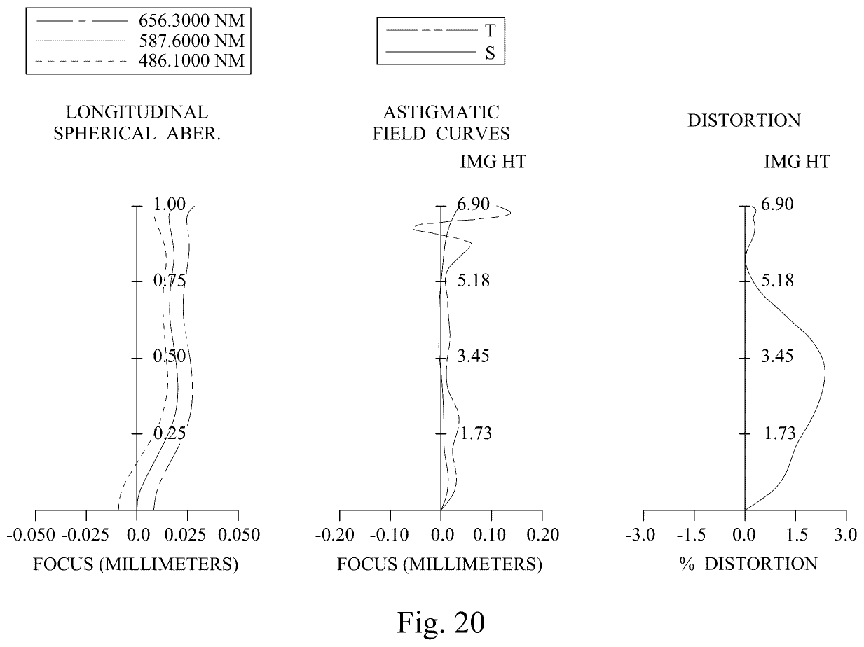

FIG. 19 is a schematic view of an imaging apparatus 10 according to the 10th embodiment of the present disclosure. FIG. 20 shows spherical aberration curves, astigmatic field curves and a distortion curve of the imaging apparatus 10 according to the 10th embodiment. In FIG. 19, the imaging apparatus 10 includes an image capturing optical lens assembly (its reference numeral is omitted) and an image sensor IS. The image capturing optical lens assembly includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the image capturing optical lens assembly. The image capturing optical lens assembly includes eight lens elements (E1, E2, E3, E4, E5, E6, E7, E8) without additional one or more lens elements inserted between the first lens element E1 and the eighth lens element E8, and there is an air gap along an optical axis between each two adjacent lens elements of the eight lens elements.

The first lens element E1 with negative refractive power has an object-side surface being concave in a paraxial region thereof and an image-side surface being convex in a paraxial region thereof. The first lens element E1 is made of a plastic material, and has the object-side surface and the image-side surface being both aspheric. Furthermore, the object-side surface of the first lens element E1 includes one inflection point and one critical point, and the image-side surface of the first lens element E1 includes one inflection point and one critical point.

The second lens element E2 with positive refractive power has an object-side surface being concave in a paraxial region thereof and an image-side surface being convex in a paraxial region thereof. The second lens element E2 is made of a glass material, and has the object-side surface and the image-side surface being both aspheric. Furthermore, the object-side surface of the second lens element E2 includes one inflection point, and the image-side surface of the second lens element E2 includes one inflection point and one critical point.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the image-side surface of the third lens element E3 includes one inflection point and one critical point.

The fourth lens element E4 with positive refractive power has an object-side surface being convex in a paraxial region thereof and an image-side surface being convex in a paraxial region thereof. The fourth lens element E4 is made of a glass material, and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of a plastic material, and has the object-side surface and the image-side surface being both aspheric. Furthermore, the image-side surface of the fifth lens element E5 includes one inflection point.

The sixth lens element E6 with positive refractive power has an object-side surface being concave in a paraxial region thereof and an image-side surface being convex in a paraxial region thereof. The sixth lens element E6 is made of a plastic material, and has the object-side surface and the image-side surface being both aspheric. Furthermore, the object-side surface of the sixth lens element E6 includes two inflection points, and the image-side surface of the sixth lens element E6 includes one inflection point.

The seventh lens element E7 with negative refractive power has an object-side surface being concave in a paraxial region thereof and an image-side surface being concave in a paraxial region thereof. The seventh lens element E7 is made of a plastic material, and has the object-side surface and the image-side surface being both aspheric. Furthermore, the object-side surface of the seventh lens element E7 includes one inflection point, and the image-side surface of the seventh lens element E7 includes three inflection points and one critical point.

The eighth lens element E8 with negative refractive power has an object-side surface being convex in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes three inflection points and three critical points, and the image-side surface of the eighth lens element E8 includes three inflection points and one critical point.

The filter E9 is made of a glass material, which is located between the eighth lens element E8 and the image surface IMG in order, and will not affect the focal length of the image capturing optical lens assembly.

The detailed optical data of the 10th embodiment are shown in Table 10A and the aspheric surface data are shown in Table 10B below.

TABLE 10A
10th Embodiment
f = 6.00 mm, Fno = 1.58, HFOV = 48.9 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | −16.1087 | ASP | 1.788 | Plastic | 1.566 | 37.4 | −36.74 |
| 2 | | −74.3554 | ASP | 2.631 | | | | |
| 3 | Lens 2 | −3.2976 | ASP | 0.722 | Glass | 1.603 | 60.6 | 401.73 |
| 4 | | −3.5213 | ASP | 0.601 | | | | |
| 5 | Ape. Stop | Plano | | −0.532 | | | | |
| 6 | Lens 3 | 4.8719 | ASP | 1.238 | Plastic | 1.544 | 56.0 | 13.60 |
| 7 | | 12.9843 | ASP | 0.478 | | | | |
| 8 | Lens 4 | 10.6888 | SPH | 1.380 | Glass | 1.720 | 50.4 | 7.14 |
| 9 | | −9.3791 | SPH | 0.067 | | | | |
| 10 | Lens 5 | −17.9283 | ASP | 0.390 | Plastic | 1.615 | 25.3 | −10.83 |
| 11 | | 10.7011 | ASP | 0.779 | | | | |
| 12 | Lens 6 | −82.4735 | ASP | 1.587 | Plastic | 1.544 | 55.9 | 8.24 |
| 13 | | −4.2769 | ASP | 0.402 | | | | |
| 14 | Lens 7 | −10.2231 | ASP | 0.611 | Plastic | 1.650 | 21.8 | −14.05 |
| 15 | | 87.3053 | ASP | 1.705 | | | | |
| 16 | Lens 8 | 4.5649 | ASP | 0.624 | Plastic | 1.614 | 26.0 | −15.87 |
| 17 | | 2.9465 | ASP | 0.620 | | | | |

| | | | | | | | |
|---|---|---|---|---|---|---|---|
| 18 | Filter | Plano | 0.200 | Glass | 1.517 | 64.2 | — |
| 19 | | Plano | 0.339 | | | | |
| 20 | Image | Plano | — | | | | |

Reference wavelength is 587.6 nm (d-line).

TABLE 10B
Aspheric Coefficients

| Surface # | 1 | 2 | 3 | 4 | 6 | 7 |
|---|---|---|---|---|---|---|
| k= | −1.26116E+00 | −2.91868E+01 | −6.50996E+00 | −7.07518E+00 | −1.02074E+00 | −7.63606E+01 |
| A4= | 3.348314E−03 | 5.103984E−03 | −8.821474E−03 | −9.341125E−03 | −4.135110E−03 | −4.603198E−03 |
| A6= | −1.503822E−04 | −2.757423E−04 | 1.422187E−03 | 2.344273E−03 | 1.141544E−03 | 7.449051E−04 |
| A8= | 7.659418E−06 | 3.593524E−05 | −9.304006E−05 | −3.151371E−04 | −1.031391E−04 | −5.573049E−05 |
| A10= | −3.146270E−07 | −3.906845E−06 | 3.183595E−06 | 3.418703E−05 | −8.777464E−06 | −8.659361E−06 |
| A12= | 8.851291E−09 | 2.855501E−07 | −4.540702E−08 | −2.244605E−06 | 2.975820E−06 | 2.273239E−06 |
| A14= | −1.481214E−10 | −1.239622E−08 | | 6.708355E−08 | −2.150650E−07 | −1.704274E−07 |
| A16= | 1.175342E−12 | 2.253644E−10 | | | | |
| A18= | −1.357647E−15 | | | | | |
| Surface # | 10 | 11 | 12 | 13 | 14 | 15 |
| k= | 2.90897E+01 | 2.09691E+00 | −9.00000E+01 | −4.92167E−01 | −2.70414E+01 | 9.00000E+01 |
| A4= | −1.429587E−04 | 2.226379E−03 | −2. 163745E−03 | 5.484065E−03 | 3.452699E−03 | −9.237186E−04 |
| A6= | 1.107226E−03 | 1.066432E−03 | 1.504943E−03 | 1.682978E−03 | 3.341558E−04 | 1.232296E−03 |
| A8= | −4.992529E−04 | −4.221403E−04 | −7.162750E−04 | −1.644389E−03 | −6.845678E−04 | −5.184622E−04 |
| A10= | 9.141971E−05 | 6.413950E−05 | 2.136900E−04 | 5.906130E−04 | 1.501270E−04 | 9.219030E−05 |
| A12= | −8.886815E−06 | −3.916040E−06 | −4.180488E−05 | −1.320717E−04 | −1.665549E−05 | −9.046204E−06 |
| A14= | 3.817454E−07 | −1.894267E−07 | 5.326793E−06 | 1.941008E−05 | 1.051057E−06 | 5.306445E−07 |
| A16= | −4.188918E−09 | 4.560522E−08 | −4.689299E−07 | −1.815515E−06 | −4.124074E−08 | −1.865206E−08 |
| A18= | | −2.234697E−09 | 2.933838E−08 | 9.713799E−08 | 9.259354E−10 | 3.661839E−10 |
| A20= | | | −9.530017E−10 | −2.225159E−09 | | −3.135715E−12 |

| Surface # | 16 | 17 |
|---|---|---|
| k= | −4.35827E+01 | −5.72732E+00 |
| A4= | 2.525225E−03 | −6.477774E−03 |
| A6= | −8.048954E−03 | −9.006297E−04 |
| A8= | 2.298525E−03 | 3.248209E−04 |
| A10= | −3.734480E−04 | −4.635995E−05 |
| A12= | 3.984916E−05 | 4.061889E−06 |
| A14= | −2.892299E−06 | −2.450112E−07 |
| A16= | 1.447938E−07 | 1.067300E−08 |
| A18= | −5.000159E−09 | −3.380452E−10 |
| A20= | 1.170271E−10 | 7.587506E−12 |
| A22= | −1.773519E−12 | −1.138362E−13 |
| A24= | 1.571072E−14 | 1.018536E−15 |
| A26= | −6.180078E−17 | −4.093117E−18 |

In the 10th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 10th embodiment, so an explanation in this regard will not be provided again.

Moreover, these parameters can be calculated from Table 10A and Table 10B as the following values and satisfy the following conditions in Table 10C:

TABLE 10C
10th Embodiment

| | | | |
|---|---|---|---|
| f [mm] | 6.00 | (R3 + R7)/(R3 − R7) | −0.53 |
| Fno | 1.58 | (\|R3\| + \|R4\| + R16)/f | 1.63 |
| HFOV [deg.] | 48.9 | CTmax/ATmax | 0.68 |
| FOV [deg.] | 97.8 | CT3/CT5 | 3.17 |
| f/EPD | 1.58 | (T67 + T78)/(CT1 + CT8) | 0.87 |
| tan(HFOV) | 1.15 | BL/T12 | 0.44 |
| EPD/ImgH | 0.55 | T45/T56 | 0.09 |
| f/ImgH | 0.87 | (T23 + T34 + T45)/T12 | 0.23 |
| SL/TL | 0.63 | V3/V4 | 1.11 |
| BL/SD | 0.13 | V7/V3 | 0.39 |
| f/f2 | 0.01 | tan(CRA) | 0.61 |
| f8/f1 | 0.43 | ET8/ET1 | 0.49 |
| f3/f4 | 1.90 | SAG2R1/CT2 | −1.56 |
| R3/f | −0.55 | SAG3R2/CT3 | 0.05 |
| f/R13 | −0.59 | SAG7R1/CT7 | −1.67 |
| R4/R5 | −0.72 | SAG8R1/CT8 | −1.19 |
| R16/R9 | −0.16 | Y8R2/Y7R1 | 1.88 |

### 11th Embodiment

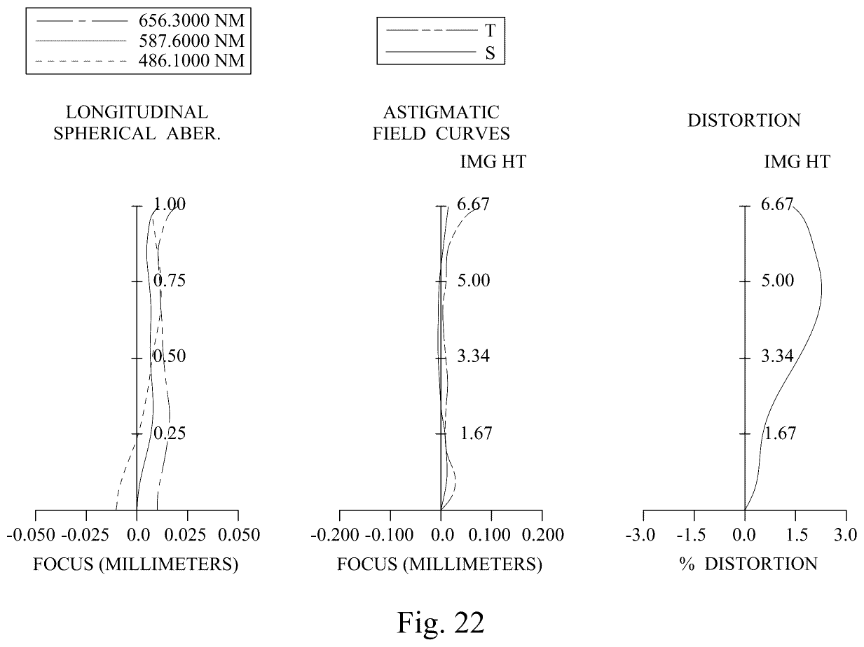

FIG. 21 is a schematic view of an imaging apparatus 11 according to the 11th embodiment of the present disclosure. FIG. 22 shows spherical aberration curves, astigmatic field curves and a distortion curve of the imaging apparatus 11 according to the 11th embodiment. In FIG. 21, the imaging apparatus 11 includes an image capturing optical lens assembly (its reference numeral is omitted) and an image sensor IS. The image capturing optical lens assembly includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the image capturing optical lens assembly. The image capturing optical lens assembly includes eight lens elements (E1, E2, E3, E4, E5, E6, E7, E8) without additional one or more lens elements inserted between the first lens element E1 and the eighth lens element E8, and there is an air gap along an optical axis between each two adjacent lens elements of the eight lens elements.

The first lens element E1 with negative refractive power has an object-side surface being convex in a paraxial region thereof and an image-side surface being concave in a paraxial region thereof. The first lens element E1 is made of a plastic material, and has the object-side surface and the image-side surface being both aspheric. Furthermore, the image-side surface of the first lens element E1 includes two inflection points.

The second lens element E2 with negative refractive power has an object-side surface being concave in a paraxial region thereof and an image-side surface being convex in a paraxial region thereof. The second lens element E2 is made of a plastic material, and has the object-side surface and the image-side surface being both aspheric. Furthermore, the object-side surface of the second lens element E2 includes one inflection point, and the image-side surface of the second lens element E2 includes one inflection point.

The third lens element E3 with positive refractive power has an object-side surface being convex in a paraxial region thereof and an image-side surface being convex in a paraxial region thereof. The third lens element E3 is made of a plastic material, and has the object-side surface and the image-side surface being both aspheric.

The fourth lens element E4 with negative refractive power has an object-side surface being concave in a paraxial region thereof and an image-side surface being convex in a paraxial region thereof. The fourth lens element E4 is made of a plastic material, and has the object-side surface and the image-side surface being both aspheric. Furthermore, the object-side surface of the fourth lens element E4 includes one inflection point and one critical point, and the image-side surface of the fourth lens element E4 includes one inflection point.

The fifth lens element E5 with negative refractive power has an object-side surface being convex in a paraxial region thereof and an image-side surface being concave in a paraxial region thereof. The fifth lens element E5 is made of a plastic material, and has the object-side surface and the image-side surface being both aspheric. Furthermore, the object-side surface of the fifth lens element E5 includes three inflection points and three critical points, and the image-side surface of the fifth lens element E5 includes one inflection point.

The sixth lens element E6 with positive refractive power has an object-side surface being convex in a paraxial region thereof and an image-side surface being convex in a paraxial region thereof. The sixth lens element E6 is made of a plastic material, and has the object-side surface and the image-side surface being both aspheric. Furthermore, the image-side surface of the sixth lens element E6 includes one inflection point and one critical point.

The seventh lens element E7 with positive refractive power has an object-side surface being convex in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes one inflection point and one critical point, and the image-side surface of the seventh lens element E7 includes one inflection point and one critical point.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes two inflection points, and the image-side surface of the eighth lens element E8 includes one inflection point and one critical point.

The filter E9 is made of a glass material, which is located between the eighth lens element E8 and the image surface IMG in order, and will not affect the focal length of the image capturing optical lens assembly.

The detailed optical data of the 11th embodiment are shown in Table 11A and the aspheric surface data are shown in Table 11B below.

TABLE 11A
11th Embodiment
f = 6.70 mm, Fno = 1.64, HFOV = 44.4 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 16.4821 | ASP | 0.565 | Plastic | 1.515 | 56.4 | −30.29 |
| 2 | | 7.9234 | ASP | 4.352 | | | | |
| 3 | Lens 2 | −3.4443 | ASP | 1.092 | Plastic | 1.551 | 44.8 | −122.94 |
| 4 | | −4.0375 | ASP | 0.760 | | | | |
| 5 | Ape. Stop | Plano | | −0.713 | | | | |
| 6 | Lens 3 | 4.6369 | ASP | 1.681 | Plastic | 1.544 | 56.0 | 6.41 |
| 7 | | −12.2419 | ASP | 0.070 | | | | |
| 8 | Lens 4 | −41.9933 | ASP | 0.800 | Plastic | 1.511 | 56.8 | −609.90 |
| 9 | | −48.8471 | ASP | 0.151 | | | | |
| 10 | Lens 5 | 87.3112 | ASP | 0.571 | Plastic | 1.660 | 20.4 | −12.82 |
| 11 | | 7.6928 | ASP | 0.697 | | | | |
| 12 | Lens 6 | 13.3388 | ASP | 1.317 | Plastic | 1.544 | 56.0 | 11.96 |
| 13 | | −12.2638 | ASP | 2.173 | | | | |
| 14 | Lens 7 | 138.8889 | ASP | 1.400 | Plastic | 1.614 | 25.6 | 3.60 |
| 15 | | −2.2333 | ASP | 0.071 | | | | |
| 16 | Lens 8 | −2.9945 | ASP | 0.913 | Plastic | 1.639 | 23.5 | −2.54 |
| 17 | | 3.9450 | ASP | 0.700 | | | | |

| | | | | | | | |
|---|---|---|---|---|---|---|---|
| 18 | Filter | Plano | 0.210 | Glass | 1.517 | 64.2 | — |
| 19 | | Plano | 0.669 | | | | |
| 20 | Image | Plano | — | | | | |

Reference wavelength is 587.6 nm (d-line).

TABLE 11B
Aspheric Coefficients

| Surface # | 1 | 2 | 3 | 4 | 6 | 7 |
|---|---|---|---|---|---|---|
| k= | 8.90892E−01 | 6.23405E−02 | −4.66215E+00 | −5.53953E+00 | −1.29261E+00 | 8.80790E+00 |
| A4= | 5.697960E−03 | 6.911540E−03 | −5.830829E−03 | −4.996676E−03 | −2.072590E−03 | −8.595963E−03 |
| A6= | −3.766557E−04 | −3.508375E−04 | 4.337025E−04 | 7.119099E−04 | 3.022493E−04 | 2.934434E−03 |
| A8= | 2.069325E−05 | 1.648714E−05 | −5.983537E−06 | −4.783587E−05 | −2.618418E−05 | −5.329181E−04 |
| A10= | −6.379217E−07 | −9.420499E−08 | −3.843775E−07 | 3.096041E−06 | 2.007409E−06 | 5.986506E−05 |
| A12= | −1.718871E−08 | −6.848916E−08 | 1.049190E−08 | −1.001930E−07 | −1.221602E−07 | −3.791398E−06 |
| A14= | 2.138200E−09 | 2.325074E−09 | | 4.476930E−10 | | 1.029598E−07 |
| A16= | −6.752180E−11 | | | | | |
| A18= | 7.828362E−13 | | | | | |
| Surface # | 8 | 9 | 10 | 11 | 12 | 13 |
| k= | −9.00000E+01 | 9.00000E+01 | −9.00000E+01 | 9.28308E−01 | 1.24739E+01 | −1.28472E+01 |
| A4= | −3.131311E−03 | −6.323899E−04 | −7.416541E−03 | −5.598016E−03 | −2.923815E−03 | −3.298893E−03 |
| A6= | 1.287178E−03 | −9.594818E−04 | 2.426272E−03 | 2.411423E−03 | 3.764055E−04 | 1.704080E−04 |
| A8= | −1.111399E−04 | 4.257752E−04 | −4.970929E−04 | −5.476529E−04 | −1.550263E−04 | −6.873939E−05 |
| A10= | −2.219703E−05 | −1.004231E−04 | 7.074619E−05 | 8.351232E−05 | 4.655831E−05 | 2.105682E−05 |
| A12= | 5.887370E−06 | 1.418198E−05 | −5.550004E−06 | −6.793860E−06 | −9.796792E−06 | −4.100679E−06 |
| A14= | −4.926759E−07 | −1.047317E−06 | 1.641190E−07 | 2. 154492E−07 | 1.375031E−06 | 4.950362E−07 |
| A16= | 1.543785E−08 | 3.091525E−08 | | −4.399690E−10 | −1.080634E−07 | −3.145126E−08 |
| A18= | | | | | 4.148729E−09 | 9.209541E−10 |
| A20= | | | | | −5.614505E−11 | |

| Surface # | 14 | 15 | 16 | 17 |
|---|---|---|---|---|
| k= | −9.00000E+01 | −9.61086E+00 | −1.54980E+01 | −1.62908E+01 |
| A4= | −6.533378E−03 | 4.687210E−03 | −1.445271E−03 | −7.108233E−03 |
| A6= | 1.291564E−03 | −4.085399E−03 | −5.229438E−03 | 1.301138E−03 |
| A8= | −1.329425E−03 | 6.927731E−04 | 2.152326E−03 | −1.773682E−04 |
| A10= | 5.220023E−04 | 8.427645E−05 | −4.060994E−04 | 1.664925E−05 |
| A12= | −1.274857E−04 | −5.313620E−05 | 4.599328E−05 | −1.095127E−06 |
| A14= | 2.014756E−05 | 1.019378E−05 | −3.389227E−06 | 5.019840E−08 |
| A16= | −2.055934E−06 | −1.132049E−06 | 1.649030E−07 | −1.566753E−09 |
| A18= | 1.318288E−07 | 8.124411E−08 | −5.126306E−09 | 3.161682E−11 |
| A20= | −4.861373E−09 | −3.841324E−09 | 9.229434E−11 | −3.696413E−13 |
| A22= | 7.881447E−11 | 1.159670E−10 | −7.315711E−13 | 1.883605E−15 |
| A24= | | −2.029066E−12 | | |
| A26= | | 1.565894E−14 | | |

In the 11th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 11th embodiment, so an explanation in this regard will not be provided again.

Moreover, these parameters can be calculated from Table 11A and Table 11B as the following values and satisfy the following conditions in Table 11C:

TABLE 11C
11th Embodiment

| | | | |
|---|---|---|---|
| f [mm] | 6.70 | (R3 + R7)/(R3 − R7) | −1.18 |
| Fno | 1.64 | (\|R3\| + \|R4\| + R16)/f | 1.71 |
| HFOV [deg.] | 44.4 | CTmax/ATmax | 0.39 |
| FOV [deg.] | 88.8 | CT3/CT5 | 2.94 |
| f/EPD | 1.64 | (T67 + T78)/(CT1 + CT8) | 1.52 |
| tan(HFOV) | 0.98 | BL/T12 | 0.36 |
| EPD/ImgH | 0.61 | T45/T56 | 0.22 |
| f/ImgH | 1.00 | (T23 + T34 + T45)/T12 | 0.06 |
| SL/TL | 0.61 | V3/V4 | 0.99 |
| BL/SD | 0.17 | V7/V3 | 0.46 |
| f/f2 | −0.05 | tan(CRA) | 0.80 |
| f8/f1 | 0.08 | ET8/ET1 | 2.08 |
| f3/f4 | −0.01 | SAG2R1/CT2 | −1.35 |
| R3/f | −0.51 | SAG3R2/CT3 | −0.27 |
| f/R13 | 0.05 | SAG7R1/CT7 | −0.89 |
| R4/R5 | −0.87 | SAG8R1/CT8 | −1.17 |
| R16/R9 | 0.05 | Y8R2/Y7R1 | 1.66 |

### 12th Embodiment

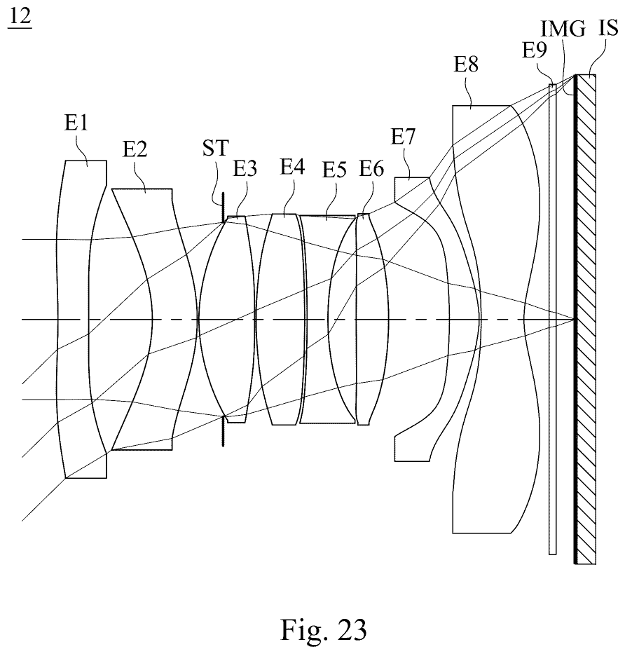

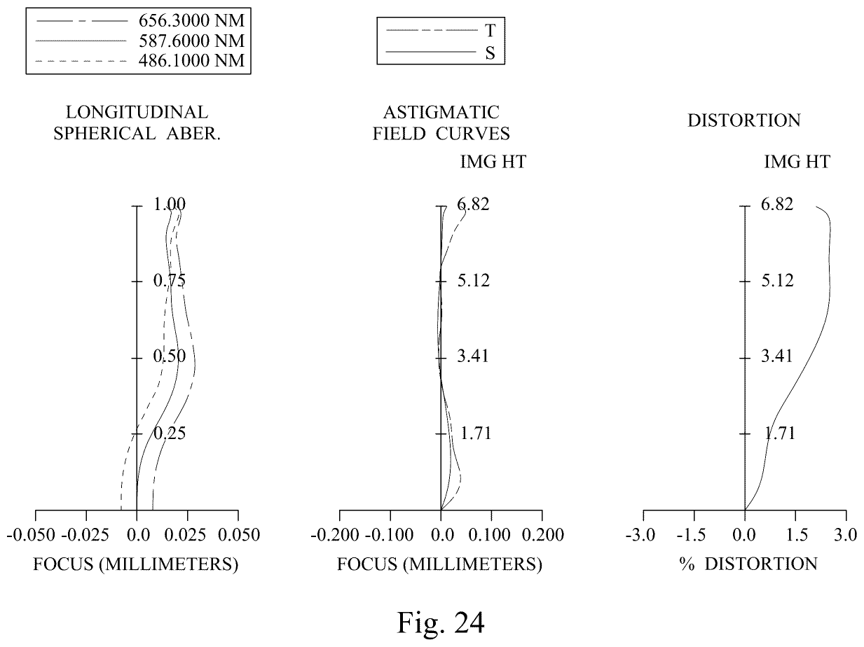

FIG. 23 is a schematic view of an imaging apparatus 12 according to the 12th embodiment of the present disclosure. FIG. 24 shows spherical aberration curves, astigmatic field curves and a distortion curve of the imaging apparatus 12 according to the 12th embodiment. In FIG. 23, the imaging apparatus 12 includes an image capturing optical lens assembly (its reference numeral is omitted) and an image sensor IS. The image capturing optical lens assembly includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the image capturing optical lens assembly. The image capturing optical lens assembly includes eight lens elements (E1, E2, E3, E4, E5, E6, E7, E8) without additional one or more lens elements inserted between the first lens element E1 and the eighth lens element E8, and there is an air gap along an optical axis between each two adjacent lens elements of the eight lens elements.

The first lens element E1 with negative refractive power has an object-side surface being concave in a paraxial region thereof and an image-side surface being convex in a paraxial region thereof. The first lens element E1 is made of a plastic material, and has the object-side surface and the image-side surface being both aspheric. Furthermore, the object-side surface of the first lens element E1 includes two inflection points and one critical point, and the image-side surface of the first lens element E1 includes one inflection point and one critical point.

The second lens element E2 with negative refractive power has an object-side surface being concave in a paraxial region thereof and an image-side surface being convex in a paraxial region thereof. The second lens element E2 is made of a plastic material, and has the object-side surface and the image-side surface being both aspheric. Furthermore, the object-side surface of the second lens element E2 includes one inflection point, and the image-side surface of the second lens element E2 includes one inflection point.

The third lens element E3 with positive refractive power has an object-side surface being convex in a paraxial region thereof and an image-side surface being convex in a paraxial region thereof. The third lens element E3 is made of a plastic material, and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of a plastic material, and has the object-side surface and the image-side surface being both aspheric. Furthermore, the object-side surface of the fourth lens element E4 includes one inflection point, and the image-side surface of the fourth lens element E4 includes one inflection point.

The fifth lens element E5 with negative refractive power has an object-side surface being concave in a paraxial region thereof and an image-side surface being concave in a paraxial region thereof. The fifth lens element E5 is made of a plastic material, and has the object-side surface and the image-side surface being both aspheric. Furthermore, the object-side surface of the fifth lens element E5 includes one inflection point.

The sixth lens element E6 with positive refractive power has an object-side surface being convex in a paraxial region thereof and an image-side surface being convex in a paraxial region thereof. The sixth lens element E6 is made of a plastic material, and has the object-side surface and the image-side surface being both aspheric. Furthermore, the object-side surface of the sixth lens element E6 includes two inflection points and two critical points, and the image-side surface of the sixth lens element E6 includes one inflection point and one critical point.

The seventh lens element E7 with positive refractive power has an object-side surface being concave in a paraxial region thereof and an image-side surface being convex in a paraxial region thereof. The seventh lens element E7 is made of a plastic material, and has the object-side surface and the image-side surface being both aspheric. Furthermore, the object-side surface of the seventh lens element E7 includes one inflection point, and the image-side surface of the seventh lens element E7 includes one inflection point.

The eighth lens element E8 with negative refractive power has an object-side surface being concave in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes two inflection points, and the image-side surface of the eighth lens element E8 includes one inflection point and one critical point.

The filter E9 is made of a glass material, which is located between the eighth lens element E8 and the image surface IMG in order, and will not affect the focal length of the image capturing optical lens assembly.

The detailed optical data of the 12th embodiment are shown in Table 12A and the aspheric surface data are shown in Table 12B below.

TABLE 12A
12th Embodiment
f = 6.80 mm, Fno = 1.52, HFOV = 44.4 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | −19.8617 | ASP | 0.861 | Plastic | 1.529 | 45.4 | −57.91 |
| 2 | | −57.2856 | ASP | 1.777 | | | | |
| 3 | Lens 2 | −4.1154 | ASP | 1.254 | Plastic | 1.551 | 44.8 | −70.35 |
| 4 | | −5.1028 | ASP | 0.725 | | | | |
| 5 | Ape. Stop | Plano | | −0.678 | | | | |
| 6 | Lens 3 | 4.6838 | ASP | 1.559 | Plastic | 1.544 | 56.0 | 7.81 |
| 7 | | −40.5789 | ASP | 0.039 | | | | |
| 8 | Lens 4 | 9.2599 | ASP | 1.357 | Plastic | 1.544 | 56.0 | 12.56 |
| 9 | | −24.7521 | ASP | 0.068 | | | | |
| 10 | Lens 5 | −31.9525 | ASP | 0.581 | Plastic | 1.639 | 23.5 | −8.74 |
| 11 | | 6.8150 | ASP | 0.792 | | | | |
| 12 | Lens 6 | 90.6548 | ASP | 0.905 | Plastic | 1.544 | 56.0 | 15.95 |
| 13 | | −9.5644 | ASP | 1.700 | | | | |
| 14 | Lens 7 | −11.7657 | ASP | 0.829 | Plastic | 1.614 | 25.6 | 5.33 |
| 15 | | −2.6277 | ASP | 0.056 | | | | |
| 16 | Lens 8 | −11.7059 | ASP | 1.198 | Plastic | 1.639 | 23.5 | −3.46 |
| 17 | | 2.8339 | ASP | 0.700 | | | | |

| | | | | | | | |
|---|---|---|---|---|---|---|---|
| 18 | Filter | Plano | 0.200 | Glass | 1.517 | 64.2 | — |
| 19 | | Plano | 0.541 | | | | |
| 20 | Image | Plano | — | | | | |

Reference wavelength is 587.6 nm (d-line).

TABLE 12B
Aspheric Coefficients

| Surface # | 1 | 2 | 3 | 4 | 6 | 7 |
|---|---|---|---|---|---|---|
| k= | −3.57134E+01 | −9.00000E+01 | −8.63509E+00 | −6.42585E+00 | −6.43665E−01 | 2.78822E+01 |
| A4= | 4.191774E−03 | 6.402289E−03 | −7.176923E−03 | −4.115178E−03 | −4.661081E−03 | −1.114303E−02 |
| A6= | −2.874904E−04 | −4.405902E−04 | 9.153764E−04 | 8.343492E−04 | 8.435995E−04 | 2.598217E−03 |
| A8= | 1.463842E−05 | 2.898000E−05 | −5.451237E−05 | −5.353769E−05 | −8.840988E−05 | −3.457551E−04 |
| A10= | −4.464073E−07 | −1.549342E−06 | 1.573348E−06 | 1.827774E−06 | 6.254550E−06 | 2.676980E−05 |
| A12= | −7.033947E−10 | 3.719476E−08 | −1.540743E−08 | −3.278401E−08 | −2.052422E−07 | −9.061095E−07 |
| A14= | 3.217582E−10 | | | | | |
| A16= | 6.018710E−12 | | | | | |
| A18= | −4.159477E−13 | | | | | |
| Surface # | 8 | 9 | 10 | 11 | 12 | 13 |
| k= | 1.38941E−01 | −5.34680E+00 | 5.86214E+01 | 1.93704E+00 | 9.00000E+01 | 3.86592E+00 |
| A4= | −6.699710E−03 | 8.801099E−03 | 5.392637E−03 | −8.447497E−04 | −1.362937E−03 | −2.967809E−04 |
| A6= | 2.316115E−03 | −5.076014E−03 | −3.841263E−03 | 1.645356E−05 | 5.385777E−04 | −4.406214E−04 |
| A8= | −3.617531E−04 | 1.220433E−03 | 1.009581E−03 | 5.324851E−05 | 4.234240E−04 | 2.146252E−04 |
| A10= | 3.150695E−05 | −1.351288E−04 | −1.118609E−04 | 7.103003E−06 | 1.863027E−04 | 6.834507E−05 |
| A12= | −1.264547E−06 | 5.393714E−06 | 3.661761E−06 | −3.941017E−06 | −5.553711E−05 | 1.077670E−05 |
| A14= | | | 7.168227E−08 | 5.081018E−07 | 1.117941E−05 | −6.677362E−07 |
| A16= | | | | −2.093161E−08 | −1.428973E−06 | −1.822227E−08 |
| A18= | | | | | 1.038326E−07 | 3.181582E−09 |
| A20= | | | | | −3.188217E−09 | |

| Surface # | 14 | 15 | 16 | 17 |
|---|---|---|---|---|
| k= | 3.91122E+00 | −1.08334E+01 | −6.64901E+01 | −1.08677E+01 |
| A4= | 5.157216E−03 | −6.266918E−03 | −3.989909E−03 | −7.708927E−03 |
| A6= | −1.170312E−03 | 5.784892E−03 | −2.316777E−03 | 1.144695E−03 |
| A8= | −2.127034E−04 | −3.077505E−03 | 7.354557E−04 | −1.498452E−04 |
| A10= | 9.759718E−05 | 9.388703E−04 | −9.825589E−05 | 1.456619E−05 |
| A12= | −1.877489E−05 | −1.775390E−04 | 7.754012E−06 | −9.982022E−07 |
| A14= | 1.515678E−06 | 2.104855E−05 | −3.938999E−07 | 4.696040E−08 |
| A16= | −4.687817E−08 | −1.560776E−06 | 1.308751E−08 | −1.476515E−09 |
| A18= | 4.451919E−10 | 7.038484E−08 | −2.758451E−10 | 2.956124E−11 |
| A20= | | −1.769222E−09 | 3.350121E−12 | −3.397604E−13 |
| A22= | | 1.905097E−11 | −1.784090E−14 | 1.699647E−15 |

In the 12th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 12th embodiment, so an explanation in this regard will not be provided again.

Moreover, these parameters can be calculated from Table 12A and Table 12B as the following values and satisfy the following conditions in Table 12C:

TABLE 12C
12th Embodiment

| | | | |
|---|---|---|---|
| f [mm] | 6.80 | (R3 + R7)/(R3 − R7) | −0.38 |
| Fno | 1.52 | (\|R3\| + \|R4\| + R16)/f | 1.77 |
| HFOV [deg.] | 44.4 | CTmax/ATmax | 0.88 |
| FOV [deg.] | 88.8 | CT3/CT5 | 2.68 |
| f/EPD | 1.52 | (T67 + T78)/(CT1 + CT8) | 0.85 |
| tan(HFOV) | 0.98 | BL/T12 | 0.81 |
| EPD/ImgH | 0.66 | T45/T56 | 0.09 |
| f/ImgH | 1.00 | (T23 + T34 + T45)/T12 | 0.09 |
| SL/TL | 0.68 | V3/V4 | 1.00 |
| BL/SD | 0.17 | V7/V3 | 0.46 |
| f/f2 | −0.10 | tan(CRA) | 0.73 |
| f8/f1 | 0.06 | ET8/ET1 | 1.42 |
| f3/f4 | 0.62 | SAG2R1/CT2 | −0.91 |
| R3/f | −0.60 | SAG3R2/CT3 | −0.17 |
| f/R13 | −0.58 | SAG7R1/CT7 | −1.84 |
| R4/R5 | −1.09 | SAG8R1/CT8 | −0.66 |
| R16/R9 | −0.09 | Y8R2/Y7R1 | 1.83 |

### 13th Embodiment

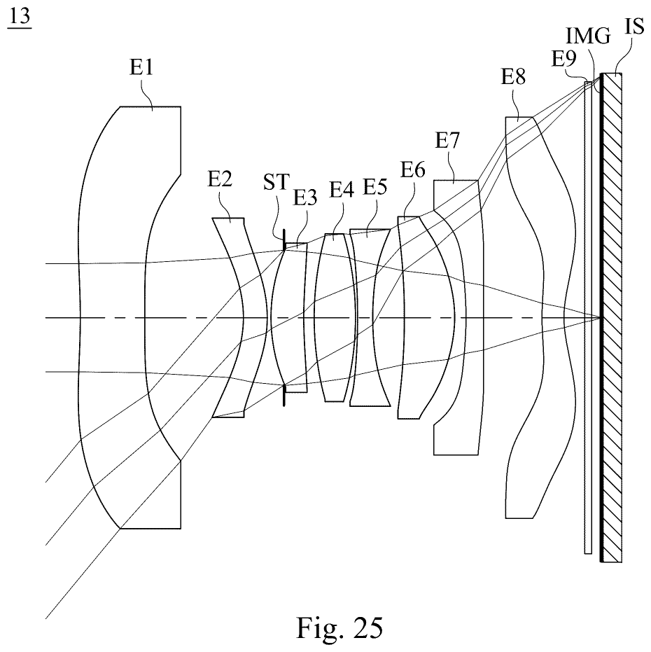

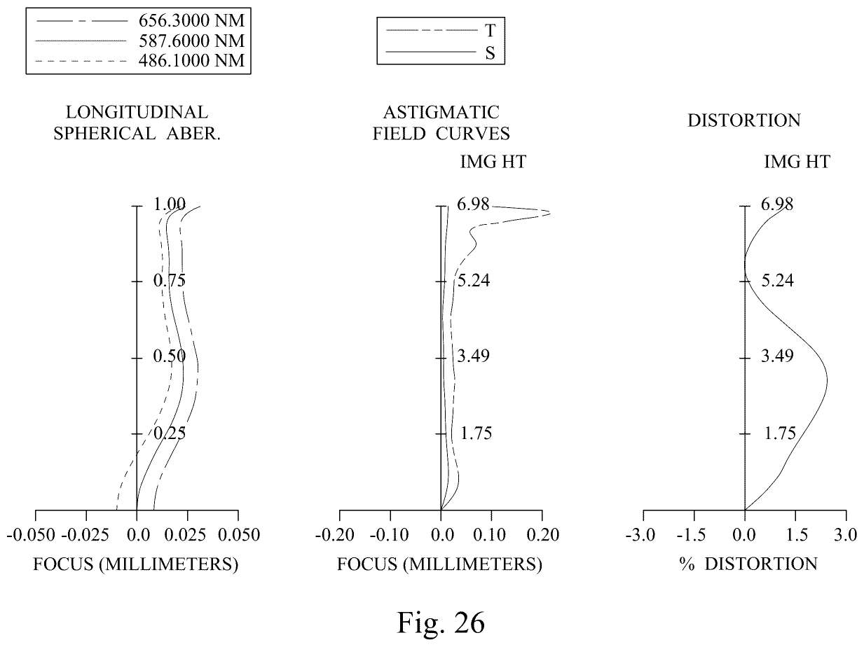

FIG. 25 is a schematic view of an imaging apparatus 13 according to the 13th embodiment of the present disclosure. FIG. 26 shows spherical aberration curves, astigmatic field curves and a distortion curve of the imaging apparatus 13 according to the 13th embodiment. In FIG. 25, the imaging apparatus 13 includes an image capturing optical lens assembly (its reference numeral is omitted) and an image sensor IS. The image capturing optical lens assembly includes, in order from an object side to an image side along an optical path, a first lens element E1, a second lens element E2, an aperture stop ST, a third lens element E3, a fourth lens element E4, a fifth lens element E5, a sixth lens element E6, a seventh lens element E7, an eighth lens element E8, a filter E9 and an image surface IMG, wherein the image sensor IS is disposed on the image surface IMG of the image capturing optical lens assembly. The image capturing optical lens assembly includes eight lens elements (E1, E2, E3, E4, E5, E6, E7, E8) without additional one or more lens elements inserted between the first lens element E1 and the eighth lens element E8, and there is an air gap along an optical axis between each two adjacent lens elements of the eight lens elements.

The first lens element E1 with negative refractive power has an object-side surface being concave in a paraxial region thereof and an image-side surface being concave in a paraxial region thereof. The first lens element E1 is made of a plastic material, and has the object-side surface and the image-side surface being both aspheric. Furthermore, the object-side surface of the first lens element E1 includes one inflection point and one critical point.

The second lens element E2 with positive refractive power has an object-side surface being concave in a paraxial region thereof and an image-side surface being convex in a paraxial region thereof. The second lens element E2 is made of a glass material, and has the object-side surface and the image-side surface being both aspheric. Furthermore, the object-side surface of the second lens element E2 includes one inflection point, and the image-side surface of the second lens element E2 includes one inflection point.

The third lens element E3 with positive refractive power has an object-side surface being convex in a paraxial region thereof and an image-side surface being concave in a paraxial region thereof. The third lens element E3 is made of a plastic material, and has the object-side surface and the image-side surface being both aspheric. Furthermore, the image-side surface of the third lens element E3 includes one inflection point.

The fourth lens element E4 with positive refractive power has an object-side surface being convex in a paraxial region thereof and an image-side surface being convex in a paraxial region thereof. The fourth lens element E4 is made of a glass material, and has the object-side surface and the image-side surface being both spherical.

The fifth lens element E5 with negative refractive power has an object-side surface being concave in a paraxial region thereof and an image-side surface being concave in a paraxial region thereof. The fifth lens element E5 is made of a plastic material, and has the object-side surface and the image-side surface being both aspheric. Furthermore, the image-side surface of the fifth lens element E5 includes one inflection point.

The sixth lens element E6 with positive refractive power has an object-side surface being concave in a paraxial region thereof and an image-side surface being convex in a paraxial region thereof. The sixth lens element E6 is made of a plastic material, and has the object-side surface and the image-side surface being both aspheric. Furthermore, the object-side surface of the sixth lens element E6 includes two inflection points, and the image-side surface of the sixth lens element E6 includes one inflection point.

The seventh lens element E7 with negative refractive power has an object-side surface being concave in a paraxial region thereof and an image-side surface being convex in a paraxial region thereof. The seventh lens element E7 is made of a plastic material, and has the object-side surface and the image-side surface being both aspheric. Furthermore, the image-side surface of the seventh lens element E7 includes three inflection points and two critical points.

The eighth lens element E8 with negative refractive power has an object-side surface being convex in a paraxial region thereof and an image-side surface being concave in a paraxial region thereof. The eighth lens element E8 is made of a plastic material, and has the object-side surface and the image-side surface being both aspheric. Furthermore, the object-side surface of the eighth lens element E8 includes three inflection points and one critical point, and the image-side surface of the eighth lens element E8 includes three inflection points and one critical point.

The filter E9 is made of a glass material, which is located between the eighth lens element E8 and the image surface IMG in order, and will not affect the focal length of the image capturing optical lens assembly.

The detailed optical data of the 13th embodiment are shown in Table 13A and the aspheric surface data are shown in Table 13B below.

TABLE 13A
13th Embodiment
f = 5.68 mm, Fno = 1.82, HFOV = 50.5 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | −19.7610 | ASP | 1.861 | Plastic | 1.529 | 45.4 | −36.88 |
| 2 | | 1651.0257 | ASP | 2.847 | | | | |
| 3 | Lens 2 | −3.3368 | ASP | 0.687 | Glass | 1.729 | 54.7 | 575.76 |
| 4 | | −3.5979 | ASP | 0.482 | | | | |
| 5 | Ape. Stop | Plano | | −0.374 | | | | |
| 6 | Lens 3 | 4.6353 | ASP | 0.946 | Plastic | 1.544 | 56.0 | 13.83 |
| 7 | | 11.2104 | ASP | 0.300 | | | | |
| 8 | Lens 4 | 9.0567 | SPH | 1.196 | Glass | 1.729 | 54.7 | 6.24 |
| 9 | | −8.6430 | SPH | 0.059 | | | | |
| 10 | Lens 5 | −18.8707 | ASP | 0.437 | Plastic | 1.615 | 25.3 | −9.84 |
| 11 | | 8.9949 | ASP | 0.912 | | | | |
| 12 | Lens 6 | −22.6401 | ASP | 1.452 | Plastic | 1.544 | 56.0 | 8.01 |
| 13 | | −3.7362 | ASP | 0.329 | | | | |
| 14 | Lens 7 | −8.8525 | ASP | 0.503 | Plastic | 1.614 | 25.6 | −15.25 |
| 15 | | −168.0958 | ASP | 1.688 | | | | |
| 16 | Lens 8 | 6.4438 | ASP | 0.636 | Plastic | 1.615 | 25.4 | −11.56 |
| 17 | | 3.2523 | ASP | 0.600 | | | | |

| | | | | | | | |
|---|---|---|---|---|---|---|---|
| 18 | Filter | Plano | 0.200 | Glass | 1.517 | 64.2 | — |
| 19 | | Plano | 0.286 | | | | |
| 20 | Image | Plano | — | | | | |

Reference wavelength is 587.6 nm (d-line).

TABLE 13B
Aspheric Coefficients

| Surface # | 1 | 2 | 3 | 4 | 6 | 7 |
|---|---|---|---|---|---|---|
| k= | −9.92258E−01 | 9.00000E+01 | −6.25512E+00 | −7.43219E+00 | −7.58964E−01 | −6.41552E+01 |
| A4= | 3.217582E−03 | 4.973387E−03 | −8.838116E−03 | −8.662942E−03 | −3.916067E−03 | −5.892250E−03 |
| A6= | −1.315058E−04 | −1.362683E−04 | 1.528815E−03 | 2.419913E−03 | 9.374124E−04 | 1.318490E−03 |
| A8= | 5.779909E−06 | 6.002062E−06 | −1.060900E−04 | −3.858041E−04 | 2.013409E−04 | 7.877814E−06 |
| A10= | −2.059202E−07 | −2.646208E−07 | 1.868906E−06 | 5.233179E−05 | −1.504590E−04 | −7.642648E−05 |
| A12= | 5.488798E−09 | 4.429811E−08 | 9.966125E−08 | −4.749948E−06 | 3.331668E−05 | 1.881241E−05 |
| A14= | −1.002646E−10 | −3.981457E−09 | | 1.989844E−07 | −2.790485E−06 | −1.736079E−06 |
| A16= | 1.074256E−12 | 9.987019E−11 | | | | |
| A18= | −4.246426E−15 | | | | | |
| Surface # | 10 | 11 | 12 | 13 | 14 | 15 |
| k= | 4.32649E+01 | 4.11011E+00 | −7.04882E+01 | −7.37187E−01 | −2.04510E+01 | 9.00000E+01 |
| A4= | −2.401402E−03 | 5.545303E−04 | −4.483708E−03 | 7.756633E−03 | 6.721571E−03 | 3.101787E−03 |
| A6= | 2.582004E−03 | 2.338081E−03 | 3.544899E−03 | −7.219415E−04 | −1.050178E−03 | −5.847183E−04 |
| A8= | −1.092793E−03 | −9.293861E−04 | −2.404984E−03 | −1.366468E−05 | −4.717414E−04 | 3.416585E−05 |
| A10= | 2.985236E−04 | 2.287430E−04 | 1.110935E−03 | −1.229988E−04 | 1.497598E−04 | −2.342973E−05 |
| A12= | −5.452801E−05 | −3.842903E−05 | −3.432947E−04 | 6.169799E−05 | −2.567333E−05 | 6.798331E−06 |
| A14= | 5.691731E−06 | 4.112095E−06 | 6.874514E−05 | −1.340438E−05 | 2.866490E−06 | −8.385297E−07 |
| A16= | −2.667330E−07 | −2.486542E−07 | −8.552154E−06 | 1.552222E−06 | −1.895947E−07 | 5.292248E−08 |
| A18= | | 5.535688E−09 | 6.052219E−07 | −9.279923E−08 | 5.469300E−09 | −1.699192E−09 |
| A20= | | | −1.873441E−08 | 2.273281E−09 | | 2.211882E−11 |

| Surface # | 16 | 17 |
|---|---|---|
| k= | −9.00000E+01 | −6.95746E+00 |
| A4= | −6.268618E−03 | −9.477151E−03 |
| A6= | −5.618670E−03 | −2.068735E−04 |
| A8= | 1.900625E−03 | 2.370896E−04 |
| A10= | −3.308811E−04 | −4.055899E−05 |
| A12= | 3.694968E−05 | 3.816772E−06 |
| A14= | −2.752971E−06 | −2.297245E−07 |
| A16= | 1.378999E−07 | 9.287633E−09 |
| A18= | −4.588227E−09 | −2.523537E−10 |
| A20= | 9.732141E−11 | 4.418797E−12 |
| A22= | −1.192180E−12 | −4.489135E−14 |
| A24= | 6.423206E−15 | 1.999313E−16 |

In the 13th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 13th embodiment, so an explanation in this regard will not be provided again.

Moreover, these parameters can be calculated from Table 13A and Table 13B as the following values and satisfy the following conditions in Table 13C:

TABLE 13C
13th Embodiment

| | | | |
|---|---|---|---|
| f [mm] | 5.68 | (R3 + R7)/(R3 − R7) | −0.46 |
| Fno | 1.82 | (\|R3\| + \|R4\| + R16)/f | 1.79 |
| HFOV [deg.] | 50.5 | CTmax/ATmax | 0.65 |
| FOV [deg.] | 101.0 | CT3/CT5 | 2.16 |
| f/EPD | 1.82 | (T67 + T78)/(CT1 + CT8) | 0.81 |
| tan(HFOV) | 1.21 | BL/T12 | 0.38 |
| EPD/ImgH | 0.45 | T45/T56 | 0.06 |
| f/ImgH | 0.81 | (T23 + T34 + T45)/T12 | 0.16 |
| SL/TL | 0.61 | V3/V4 | 1.02 |
| BL/SD | 0.13 | V7/V3 | 0.46 |
| f/f2 | 0.01 | tan(CRA) | 0.79 |
| f8/f1 | 0.31 | ET8/ET1 | 0.44 |
| f3/f4 | 2.21 | SAG2R1/CT2 | −1.31 |
| R3/f | −0.59 | SAG3R2/CT3 | 0.10 |
| f/R13 | −0.64 | SAG7R1/CT7 | −1.85 |
| R4/R5 | −0.78 | SAG8R1/CT8 | −1.64 |
| R16/R9 | −0.17 | Y8R2/Y7R1 | 1.87 |

### 14th Embodiment

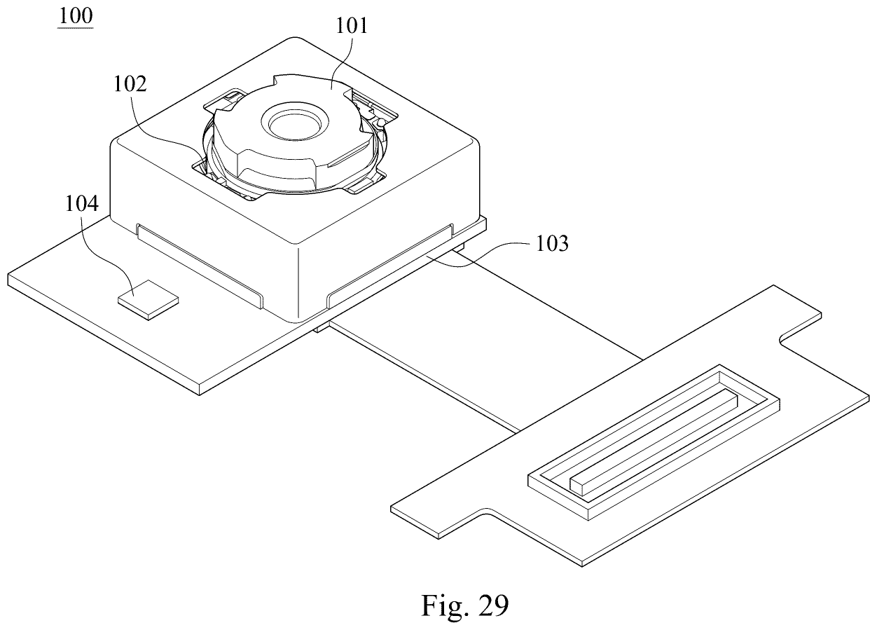

FIG. 29 is a schematic view of an imaging apparatus 100 according to the 14th embodiment of the present disclosure. In FIG. 29, the imaging apparatus 100 of the 14th embodiment is a camera module, the imaging apparatus 100 includes an imaging lens assembly 101, a driving apparatus 102 and an image sensor 103, wherein the imaging lens assembly 101 includes the image capturing optical lens assembly of the present disclosure and a lens barrel (not shown in drawings) for carrying the image capturing optical lens assembly. The imaging apparatus 100 can focus light from an imaged object via the imaging lens assembly 101, perform image focusing by the driving apparatus 102, and generate an image on the image sensor 103, and the imaging information can be transmitted.

The driving apparatus 102 can be an auto-focus module, which can be driven by driving systems, such as voice coil motors (VCM), micro electro-mechanical systems (MEMS), piezoelectric systems, and shape memory alloys etc. The image capturing optical lens assembly can obtain a favorable imaging position by the driving apparatus 102 so as to capture clear images when the imaged object is disposed at different object distances.

The imaging apparatus 100 can include the image sensor 103 located on the image surface of the image capturing optical lens assembly, such as CMOS and CCD, with superior photosensitivity and low noise. Thus, it is favorable for providing realistic images with high definition image quality thereof. Moreover, the imaging apparatus 100 can further include an image stabilization module 104, which can be a kinetic energy sensor, such as an accelerometer, a gyro sensor, and a Hall Effect sensor. In the 14th embodiment, the image stabilization module 104 is a gyro sensor, but is not limited thereto. Therefore, the variation of different axial directions of the image capturing optical lens assembly can adjusted so as to compensate the image blur generated by motion at the moment of exposure, and it is further favorable for enhancing the image quality while photographing in motion and low light situation. Furthermore, advanced image compensation functions, such as optical image stabilizations (OIS) and electronic image stabilizations (EIS) etc., can be provided.

### 15th Embodiment

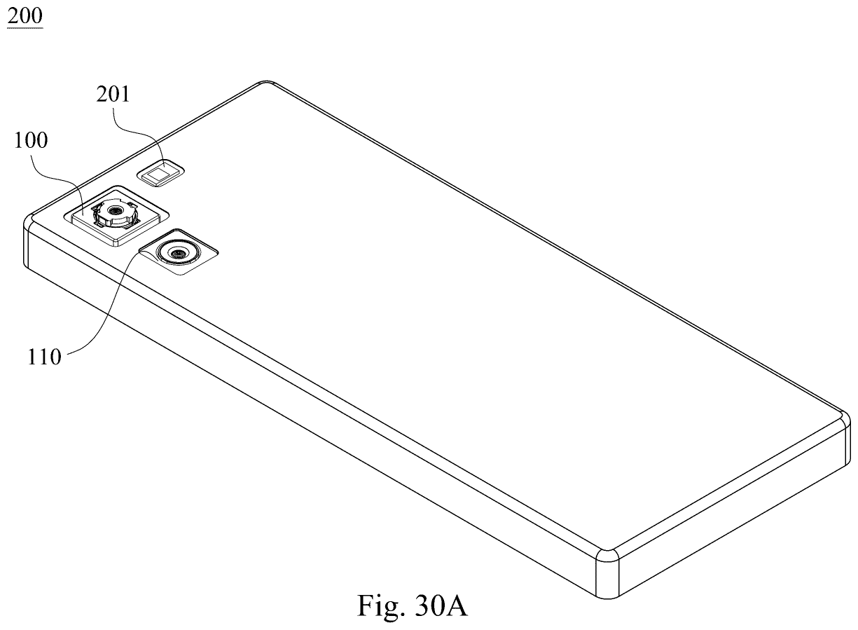

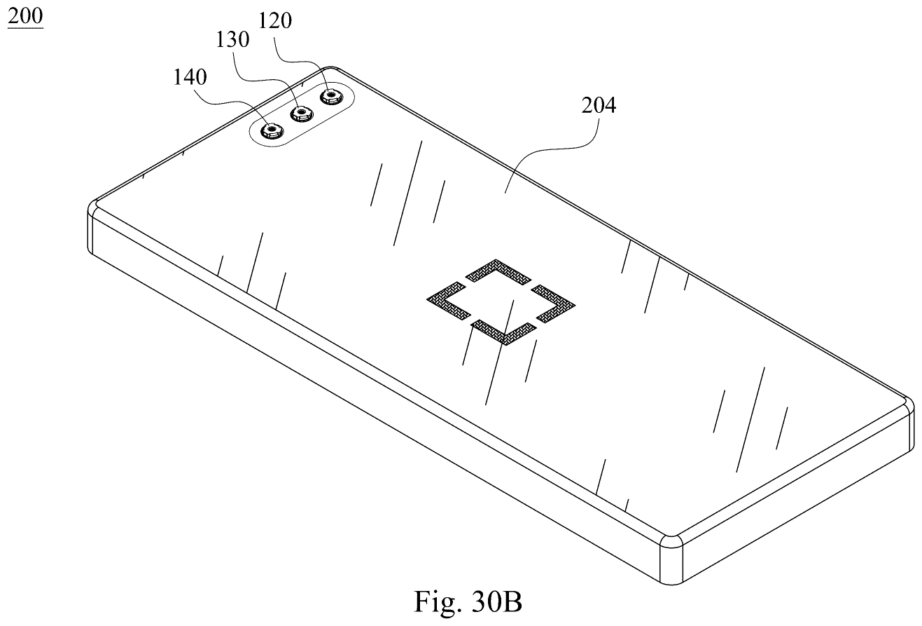

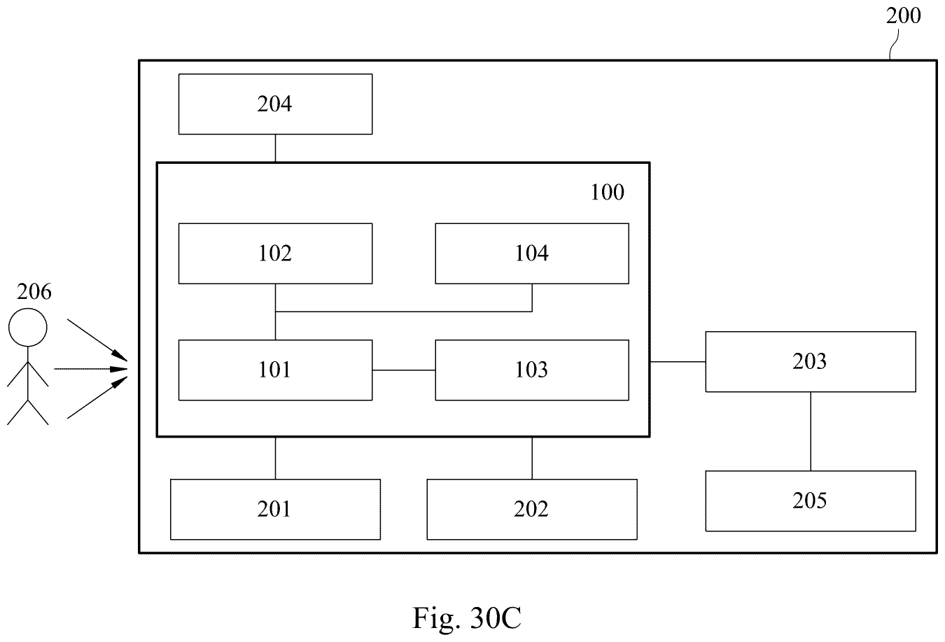

FIG. 30A is a schematic view of one side of an electronic device 200 according to the 15th embodiment of the present disclosure. FIG. 30B is a schematic view of another side of the electronic device 200 of FIG. 30A. FIG. 30C is a system schematic view of the electronic device 200 of FIG. 30A. In FIGS. 30A, 30B and 30C, the electronic device 200 according to the 15th embodiment is a smartphone, which include imaging apparatuses 100, 110, 120, 130, 140, a flash module 201, a focusing assisting module 202, an image signal processor (ISP) 203, a user interface 204 and an image software processor 205, wherein each of the imaging apparatuses 120, 130, 140 is a front camera. When the user captures images of an imaged object 206 via the user interface 204, the electronic device 200 focuses and generates an image via at least one of the imaging apparatuses 100, 110, 120, 130, 140, while compensating for low illumination via the flash module 201 when necessary. Then, the electronic device 200 quickly focuses on the imaged object 206 according to its object distance information provided by the focusing assisting module 202, and optimizes the image via the image signal processor 203 and the image software processor 205. Thus, the image quality can be further enhanced. The focusing assisting module 202 can adopt conventional infrared or laser for obtaining quick focusing, and the user interface 204 can utilize a touch screen or a physical button for capturing and processing the image with various functions of the image processing software.

Each of the imaging apparatuses 100, 110, 120, 130, 140 according to the 15th embodiment can include the image capturing optical lens assembly of the present disclosure, and can be the same or similar to the imaging apparatus 100 according to the aforementioned 14th embodiment, and will not describe again herein. In detail, according to the 15th embodiment, the imaging apparatuses 100, 110 can be wide angle imaging apparatus and ultra-wide angle imaging apparatus, respectively, or can be wide angle imaging apparatus and telephoto imaging apparatus, respectively. The imaging apparatuses 120, 130, 140 can be wide angle imaging apparatus, ultra-wide angle imaging apparatus and TOF (Time-Of-Flight) module, respectively, or can be others imaging apparatuses, which will not be limited thereto. Further, the connecting relationships between each of the imaging apparatuses 110, 120, 130, 140 and other elements can be the same as the imaging apparatus 100 in FIG. 30C, or can be adaptively adjusted according to the type of the imaging apparatuses, which will not be shown and detailed descripted again.

### 16th Embodiment

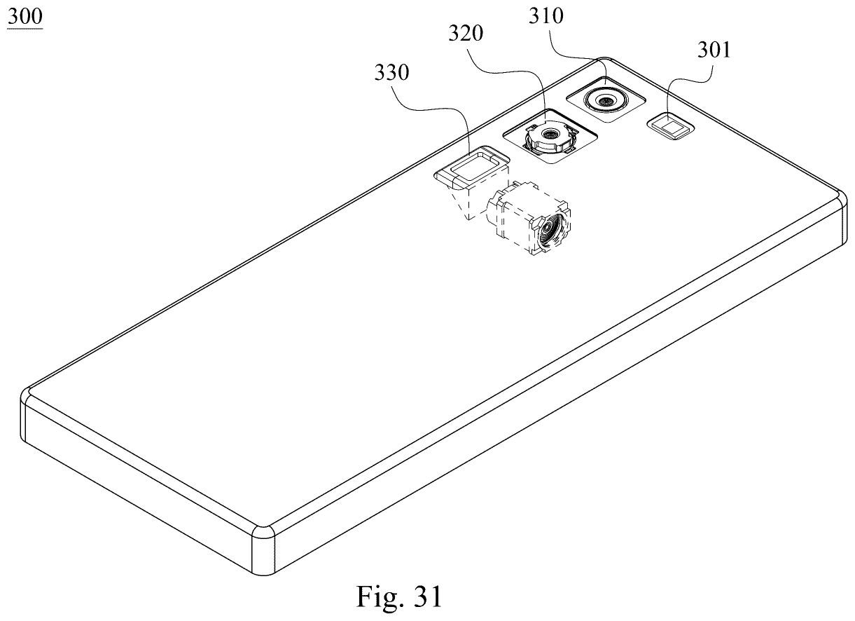

FIG. 31 is a schematic view of one side of an electronic device 300 according to the 16th embodiment of the present disclosure. According to the 16th embodiment, the electronic device 300 is a smartphone, which include imaging apparatuses 310, 320, 330 and a flash module 301.

The electronic device 300 according to the 16th embodiment can include the same or similar elements to that according to the 15th embodiment, and each of the imaging apparatuses 310, 320, 330 according to the 16th embodiment can have a configuration which is the same or similar to that according to the 15th embodiment, and will not describe again herein. In detail, according to the 16th embodiment, each of the imaging apparatuses 310, 320, 330 can include the image capturing optical lens assembly of the present disclosure, and can be the same or similar to the imaging apparatus 100 according to the aforementioned 14th embodiment, and will not describe again herein. In detail, the imaging apparatus 310 can be ultra-wide angle imaging apparatus, the imaging apparatus 320 can be wide angle imaging apparatus, the imaging apparatus 330 can be telephoto imaging apparatus (which can include light path folding element), or can be adaptively adjusted according to the type of the imaging apparatuses, which will not be limited to the arrangement.

### 17th Embodiment

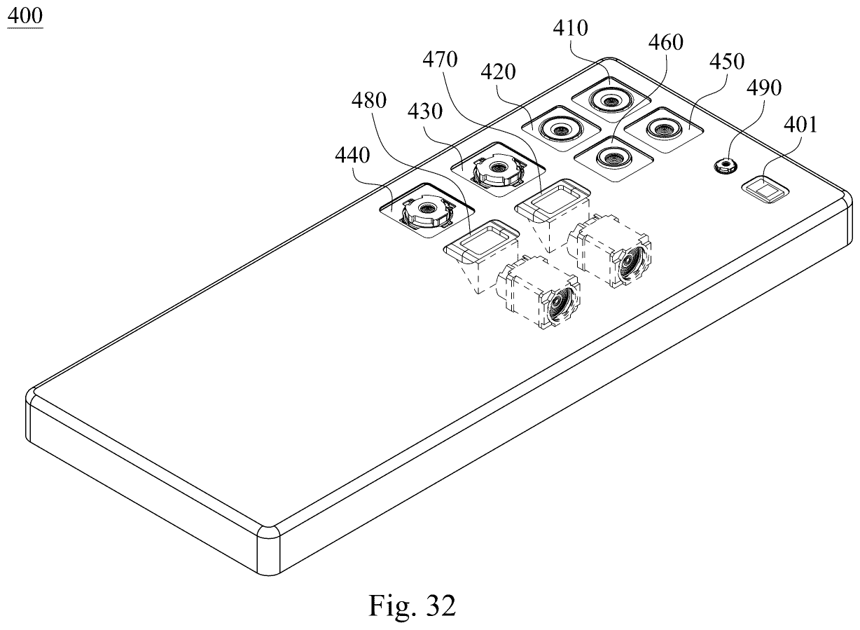

FIG. 32 is a schematic view of one side of an electronic device 400 according to the 17th embodiment of the present disclosure. According to the 17th embodiment, the electronic device 400 is a smartphone, which include imaging apparatuses 410, 420, 430, 440, 450, 460, 470, 480, 490 and a flash module 401.

The electronic device 400 according to the 17th embodiment can include the same or similar elements to that according to the 15th embodiment, and each of the imaging apparatuses 410, 420, 430, 440, 450, 460, 470, 480, 490 and the flash module 401 can have a configuration which is the same or similar to that according to the 15th embodiment, and will not describe again herein. In detail, according to the 1th embodiment, each of the imaging apparatuses 410, 420, 430, 440, 450, 460, 470, 480, 490 can include the image capturing optical lens assembly of the present disclosure, and can be the same or similar to the imaging apparatus 100 according to the aforementioned 14th embodiment, and will not describe again herein.

In detail, each of the imaging apparatuses 410, 420 can be ultra-wide angle imaging apparatus, each of the imaging apparatuses 430, 440 can be wide angle imaging apparatus, each of the imaging apparatuses 450, 460 can be telephoto imaging apparatus, each of the imaging apparatuses 470, 480 can be telephoto imaging apparatus (which can include light path folding element), the imaging apparatus 490 can be TOF module, or can be adaptively adjusted according to the type of the imaging apparatuses, which will not be limited to the arrangement.

### 18th Embodiment

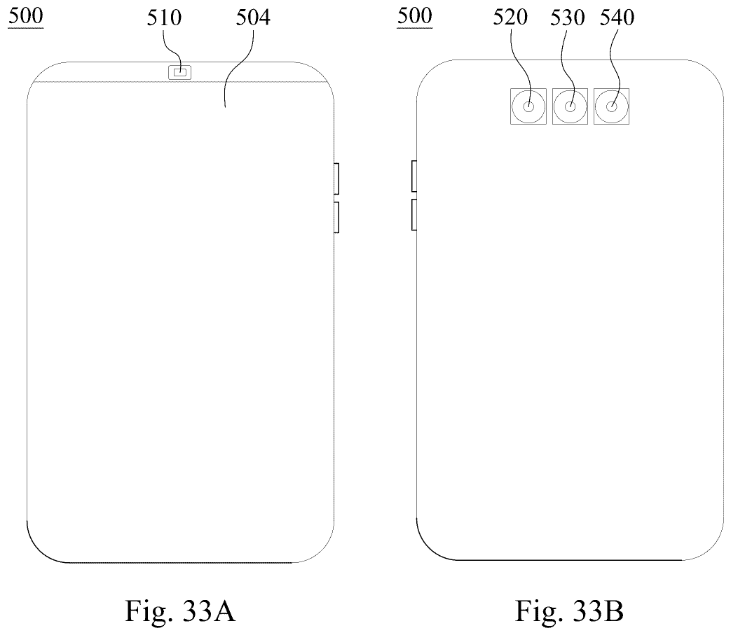

FIG. 33A is a schematic view of one side of an electronic device 500 according to the 18th embodiment of the present disclosure. FIG. 33B is a schematic view of another side of the electronic device 500 according to the 18th embodiment of FIG. 33A. In FIG. 33A and FIG. 33B, according to the 18th embodiment, the electronic device 500 is a smartphone, which include imaging apparatuses 510, 520, 530, 540 and a user interface 504.

The electronic device 500 according to the 18th embodiment can include the same or similar elements to that according to the 15th embodiment, and each of the imaging apparatuses 510, 520, 530, 540 and the user interface 504 can have a configuration which is the same or similar to that according to the 15th embodiment, and will not describe again herein. In detail, according to the 18th embodiment, the imaging apparatus 510 corresponds to a non-circular opening located on an outer side of the electronic device 500 for capturing the image, and the imaging apparatuses 520, 530, 540 can be telephoto imaging apparatus, wide angle imaging apparatus and ultra-wide angle imaging apparatus, respectively, or can be adaptively adjusted according to the type of the imaging apparatuses, which will not be limited to the arrangement.

### 19th Embodiment

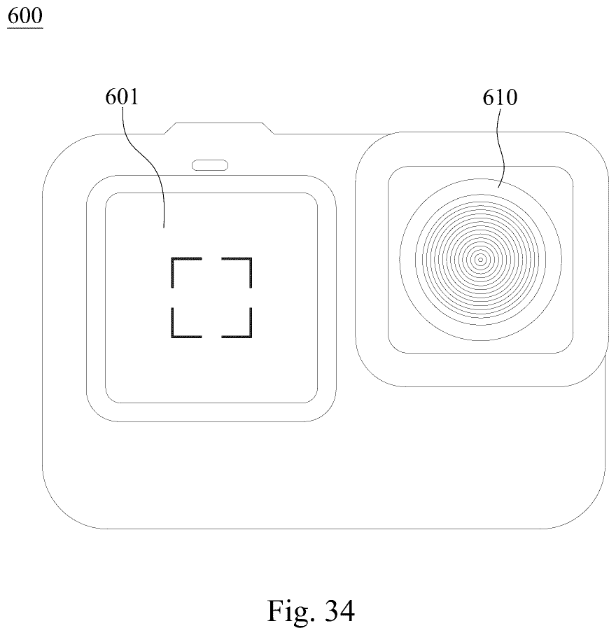

FIG. 34 is a schematic view of one side of an electronic device 600 according to the 19th embodiment of the present disclosure. In FIG. 34, according to the 19th embodiment, the electronic device 600 is an action camera, which includes an imaging apparatus 610 and a screen 601, wherein the imaging apparatus 610 is signally connected to the screen 601 so as to display the real-time image on the screen 601 which is captured by the imaging apparatus 610. The imaging apparatus 610 can include the image capturing optical lens assembly of the present disclosure, and can be the same or similar to the imaging apparatus 100 according to the aforementioned 14th embodiment, and will not describe again herein.

### 20th Embodiment

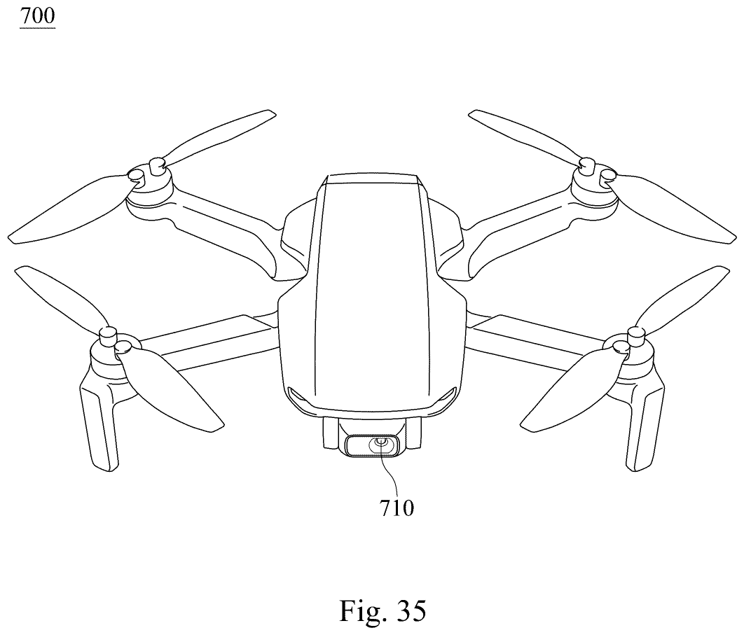

FIG. 35 is a schematic view of one side of an electronic device 700 according to the 20th embodiment of the present disclosure. In FIG. 35, according to the 20th embodiment, the electronic device 700 is an unmanned aerial vehicle, which includes an imaging apparatus 710. The imaging apparatus 710 can include the image capturing optical lens assembly of the present disclosure, and can be the same or similar to the imaging apparatus 100 according to the aforementioned 14th embodiment, and will not describe again herein.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An image capturing optical lens assembly comprising eight lens elements, the eight lens elements, in order from an object side to an image side along an optical path:
a first lens element, a second lens element, a third lens element, a fourth lens element, a fifth lens element, a sixth lens element, a seventh lens element and an eighth lens element; each of the eight lens elements has an object-side surface towards the object side and an image-side surface towards the image side;
wherein, the object-side surface of the second lens element is concave in a paraxial region thereof; the image-side surface of the second lens element is convex in a paraxial region thereof; the third lens element has positive refractive power; the image-side surface of the fifth lens element is concave in a paraxial region thereof; the eighth lens element has negative refractive power; the image-side surface of the eighth lens element is concave in a paraxial region thereof; the image-side surface of the eighth lens element comprises at least one inflection point;
wherein an axial distance between the first lens element and the second lens element is T12, an axial distance between the fourth lens element and the fifth lens element is T45, an axial distance between the fifth lens element and the sixth lens element is T56, an axial distance between the image-side surface of the eighth lens element and an image surface is BL, a focal length of the image capturing optical lens assembly is f, a curvature radius of the object-side surface of the second lens element is R3, and the following conditions are satisfied:
$$0 < T 45 / T 56 < 0.75 ;$$
$$0.2 < BL / T 12 < 0.95 ; and$$
$$- 1.3 < R 3 / f < - 0.25 .$$

2. The image capturing optical lens assembly of claim 1, wherein the object-side surface of the third lens element is convex in a paraxial region thereof; half of a maximum field of view of the image capturing optical lens assembly is HFOV, and the following condition is satisfied:
$$0.7 < tan ( HFOV ) < 1.45 .$$

3. The image capturing optical lens assembly of claim 1, further comprising:
an aperture stop located between the first lens element and the fifth lens element;
wherein the fifth lens element has negative refractive power; the focal length of the image capturing optical lens assembly is f, an entrance pupil diameter of the image capturing optical lens assembly is EPD, and the following condition is satisfied:
$$1. 20 < f / EPD < 2.00 .$$

4. The image capturing optical lens assembly of claim 1, wherein the axial distance between the fourth lens element and the fifth lens element is T45, the axial distance between the fifth lens element and the sixth lens element is T56, a focal length of the third lens element is f3, a focal length of the fourth lens element is f4, and the following conditions are satisfied:
$$0.01 < T 45 / T 56 < 0.45 ; and$$
$$- 0.3 \; 0 < f 3 / f 4 < 2.60 .$$

5. The image capturing optical lens assembly of claim 1, wherein the axial distance between the first lens element and the second lens element is T12, the axial distance between the image-side surface of the eighth lens element and the image surface is BL, an Abbe number of the third lens element is V3, an Abbe number of the seventh lens element is V7, and the following conditions are satisfied:
$$0.3 < BL / T 12 < 0.85 ; and$$
$$0.2 < V 7 / V 3 < 0.90 .$$

6. The image capturing optical lens assembly of claim 1, wherein an entrance pupil diameter of the image capturing optical lens assembly is EPD, a maximum image height of the image capturing optical lens assembly is ImgH, and the following condition is satisfied:
$$0.35 < EPD / ImgH < 0.9 .$$

7. The image capturing optical lens assembly of claim 1, wherein the focal length of the image capturing optical lens assembly is f, a maximum image height of the image capturing optical lens assembly is ImgH, a focal length of the first lens element is f1, a focal length of the eighth lens element is f8, and the following conditions are satisfied:
$$0.5 < f / ImgH < 1.5 ; and$$
$$- 0.2 \; 5 < f 8 / f 1 < 0. 65 .$$

8. The image capturing optical lens assembly of claim 1, wherein a curvature radius of the image-side surface of the second lens element is R4, a curvature radius of the object-side surface of the third lens element is R5, and the following condition is satisfied:
$$- 1.3 < R 4 / R 5 < - 0.40 .$$

9. The image capturing optical lens assembly of claim 1, wherein the focal length of the image capturing optical lens assembly is f, the curvature radius of the object-side surface of the second lens element is R3, and the following condition is satisfied:
$$- 0.80 < R 3 / f < - 0.40 .$$

10. The image capturing optical lens assembly of claim 1, wherein the seventh lens element has positive refractive power; the image-side surface of the seventh lens element is convex in a paraxial region thereof; the curvature radius of the object-side surface of the second lens element is R3, a curvature radius of the object-side surface of the fourth lens element is R7, and the following condition is satisfied:
$$- 1.5 < ( R 3 + R 7 ) / ( R 3 - R 7 ) < 0 .$$

11. The image capturing optical lens assembly of claim 1, wherein the focal length of the image capturing optical lens assembly is f, a focal length of the second lens element is f2, the curvature radius of the object-side surface of the second lens element is R3, a curvature radius of the image-side surface of the second lens element is R4, a curvature radius of the image-side surface of the eighth lens element is R16, and the following conditions are satisfied:
$$- 0.40 < f / f 2 < 0.3 ; and$$
$$0.8 < ( \vert R 3 \vert + \vert R 4 \vert + R 16 ) / f < 2.70 .$$

12. The image capturing optical lens assembly of claim 1, wherein a maximum effective radius of the object-side surface of the seventh lens element is Y7R1, a maximum effective radius of the image-side surface of the eighth lens element is Y8R2, a displacement in parallel with an optical axis from an axial vertex on the image-side surface of the third lens element to a maximum effective radius position on the image-side surface of the third lens element is SAG3R2, a central thickness of the third lens element is CT3, and the following conditions are satisfied:
$$1.4 < Y 8 R 2 / Y 7 R 1 < 2 \text{.20} ;$$
$$and$$
$$- 0.5 < SAG 3 R 2 / CT 3 < 0.30 .$$

13. The image capturing optical lens assembly of claim 1, wherein a displacement in parallel with an optical axis from an axial vertex on the object-side surface of the seventh lens element to a maximum effective radius position on the object-side surface of the seventh lens element is SAG7R1, a central thickness of the seventh lens element is CT7, the focal length of the image capturing optical lens assembly is f, the curvature radius of the object-side surface of the second lens element is R3, a curvature radius of the image-side surface of the second lens element is R4, a curvature radius of the image-side surface of the eighth lens element is R16, and the following conditions are satisfied:
$$- 2. 0 < SAG 7 R 1 / CT 7 < - 0 \text{.50} ;$$
$$and$$
$$1.3 < ( \vert R 3 \vert + \vert R 4 \vert + R 16 ) / f < 2.20 .$$

14. An imaging apparatus, comprising:
the image capturing optical lens assembly of claim 1; and
an image sensor disposed on the image surface of the image capturing optical lens assembly.

15. An image capturing optical lens assembly comprising eight lens elements, the eight lens elements, in order from an object side to an image side along an optical path:
a first lens element, a second lens element, a third lens element, a fourth lens element, a fifth lens element, a sixth lens element, a seventh lens element and an eighth lens element; each of the eight lens elements has an object-side surface towards the object side and an image-side surface towards the image side;
wherein, the object-side surface of the second lens element is concave in a paraxial region thereof; the image-side surface of the second lens element is convex in a paraxial region thereof; the third lens element has positive refractive power; the object-side surface of the third lens element is convex in a paraxial region thereof; the fifth lens element has negative refractive power; the image-side of the fifth lens element is concave in a paraxial region thereof; the eighth lens element has negative refractive power;
wherein an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, an axial distance between the fifth lens element and the sixth lens element is T56, an axial distance between the sixth lens element and the seventh lens element is T67, an axial distance between the seventh lens element and the eighth lens element is T78, a maximum among T12, T23, T34, T45, T56, T67, T78 is ATmax, a central thickness of the first lens element is CT1, a central thickness of the second lens element is CT2, a central thickness of the third lens element is CT3, a central thickness of the fourth lens element is CT4, a central thickness of the fifth lens element is CT5, a central thickness of the sixth lens element is CT6, a central thickness of the seventh lens element is CT7, a central thickness of the eighth lens element is CT8, a maximum among CT1, CT2, CT3, CT4, CT5, CT6, CT7, CT8 is CTmax, a focal length of the image capturing optical lens assembly is f, a curvature radius of the object-side surface of the seventh lens element is R13, and the following conditions are satisfied:
$$0 < T 45 / T 56 < 1. ;$$
$$0 < ( T 23 + T 34 + T 45 ) / T 12 < 0 \text{.65} ;$$
$$- 1.8 < f / R 13 < 0 \text{.30} ;$$
$$and$$
$$0.15 < CT max / AT max < 1.2 .$$

16. The image capturing optical lens assembly of claim 15, wherein the image-side surface of the eighth lens element is concave in a paraxial region thereof; the image-side surface of the eighth lens element comprises at least one critical point; the focal length of the image capturing optical lens assembly is f, an entrance pupil diameter of the image capturing optical lens assembly is EPD, and the following condition is satisfied:
$$1. 40 < f / EPD < 1.9 .$$

17. The image capturing optical lens assembly of claim 15, wherein the axial distance between the fourth lens element and the fifth lens element is T45, the axial distance between the fifth lens element and the sixth lens element is T56, a curvature radius of the object-side surface of the fifth lens element is R9, a curvature radius of the image-side surface of the eighth lens element is R16, and the following conditions are satisfied:
$$0 < T 45 / T 56 < 0.6 ;$$
$$and$$
$$- 0.6 \; 0 < R 16 / R 9 < 0.30 .$$

18. The image capturing optical lens assembly of claim 15, further comprising:
an aperture stop, wherein an axial distance between the aperture stop and the image-side surface of the eighth lens element is SD, the axial distance between the first lens element and the second lens element is T12, the axial distance between the second lens element and the third lens element is T23, the axial distance between the third lens element and the fourth lens element is T34, the axial distance between the fourth lens element and the fifth lens element is T45, an axial distance between the image-side surface of the eighth lens element and an image surface is BL, and the following conditions are satisfied:
$$0.03 < ( T 23 + T 34 + T 45 ) / T 12 < 0.35 ;$$
$$and$$
$$0.05 < BL / SD < 0. 35 .$$

19. The image capturing optical lens assembly of claim 15, wherein the focal length of the image capturing optical lens assembly is f, the curvature radius of the object-side surface of the seventh lens element is R13, the central thickness of the third lens element is CT3, the central thickness of the fifth lens element is CT5, and the following conditions are satisfied:
$$- 1.4 < f / R 13 < 0 ;$$
$$and$$
$$0.8 < CT 3 / CT 5 < 4.00 .$$

20. The image capturing optical lens assembly of claim 15, wherein the focal length of the image capturing optical lens assembly is f, the curvature radius of the object-side surface of the seventh lens element is R13, and the following condition is satisfied:
$$- 1.25 < f / R 13 < - 0.15 .$$

21. The image capturing optical lens assembly of claim 15, wherein the axial distance between the first lens element and the second lens element is T12, the axial distance between the second lens element and the third lens element is T23, the axial distance between the third lens element and the fourth lens element is T34, the axial distance between the fourth lens element and the fifth lens element is T45, the axial distance between the fifth lens element and the sixth lens element is T56, the axial distance between the sixth lens element and the seventh lens element is T67, the axial distance between the seventh lens element and the eighth lens element is T78, the maximum among T12, T23, T34, T45, T56, T67, T78 is ATmax, the central thickness of the first lens element is CT1, the central thickness of the second lens element is CT2, the central thickness of the third lens element is CT3, the central thickness of the fourth lens element is CT4, the central thickness of the fifth lens element is CT5, the central thickness of the sixth lens element is CT6, the central thickness of the seventh lens element is CT7, the central thickness of the eighth lens element is CT8, the maximum among CT1, CT2, CT3, CT4, CT5, CT6, CT7, CT8 is CTmax, a curvature radius of the object-side surface of the second lens element is R3, a curvature radius of the object-side surface of the fourth lens element is R7, and the following conditions are satisfied:
$$0.25 < CT max / AT max < 1.1 ;$$
$$and$$
$$- 1.35 < ( R 3 + R 7 ) / ( R 3 - R 7 ) < 0 .$$

22. The image capturing optical lens assembly of claim 15, wherein the axial distance between the sixth lens element and the seventh lens element is T67, the axial distance between the seventh lens element and the eighth lens element is T78, the central thickness of the first lens element is CT1, the central thickness of the eighth lens element is CT8, and the following condition is satisfied:
$$0.2 < ( T 67 + T 78 ) / ( CT 1 + CT 8 ) < 2.00 .$$

23. The image capturing optical lens assembly of claim 15, wherein the focal length of the image capturing optical lens assembly is f, a maximum image height of the image capturing optical lens assembly is ImgH, a curvature radius of the object-side surface of the second lens element is R3, a curvature radius of the image-side surface of the second lens element is R4, a curvature radius of the image-side surface of the eighth lens element is R16, and the following conditions are satisfied:
$$0.6 < f / ImgH < 1.4 ;$$
$$and$$
$$1.1 < ( \vert R 3 \vert + \vert R 4 \vert + R 16 ) / f < 2.50 .$$

24. The image capturing optical lens assembly of claim 15, further comprising:
an aperture stop, wherein an axial distance between the aperture stop and an image surface is SL, an axial distance between the object-side surface of the first lens element and the image surface is TL, an Abbe number of the third lens element is V3, an Abbe number of the fourth lens element is V4, and the following conditions are satisfied:
$$0.6 < V 3 / V 4 < 1.4 ;$$
$$and$$
$$0.55 < SL / TL < 0.80 .$$

25. The image capturing optical lens assembly of claim 15, wherein a distance in parallel with an optical axis between a maximum effective radius position on the object-side surface of the first lens element and a maximum effective radius position on the image-side surface of the first lens element is ET1, a distance in parallel with the optical axis between a maximum effective radius position on the object-side surface of the eighth lens element and a maximum effective radius position on the image-side surface of the eighth lens element is ET8, an incident angle between a chief ray in a maximum field of view of the image capturing optical lens assembly and an image surface is CRA, and the following conditions are satisfied:
$$0.35 < ET 8 / ET 1 < 2 \text{.50} ;$$
$$and$$
$$0.5 < tan ( CRA ) < 1. .$$

26. The image capturing optical lens assembly of claim 15, wherein a displacement in parallel with an optical axis from an axial vertex on the object-side surface of the second lens element to a maximum effective radius position on the object-side surface of the second lens element is SAG2R1, a displacement in parallel with the optical axis from an axial vertex on the object-side surface of the eighth lens element to a maximum effective radius position on the object-side surface of the eighth lens element is SAG8R1, the central thickness of the second lens element is CT2, the central thickness of the eighth lens element is CT8, and the following conditions are satisfied:
$$- 2. 0 < SAG 2 R 1 / CT 2 < - 0 \text{.50} ;$$
$$and$$
$$- 3. < SAG 8 R 1 / CT 8 < 0.10 .$$

27. The image capturing optical lens assembly of claim 15, wherein the axial distance between the first lens element and the second lens element is T12, the axial distance between the second lens element and the third lens element is T23, the axial distance between the third lens element and the fourth lens element is T34, the axial distance between the fourth lens element and the fifth lens element is T45, the axial distance between the fifth lens element and the sixth lens element is T56, the axial distance between the sixth lens element and the seventh lens element is T67, the axial distance between the seventh lens element and the eighth lens element is T78, the maximum among T12, T23, T34, T45, T56, T67, T78 is ATmax, the central thickness of the first lens element is CT1, the central thickness of the second lens element is CT2, the central thickness of the third lens element is CT3, the central thickness of the fourth lens element is CT4, the central thickness of the fifth lens element is CT5, the central thickness of the sixth lens element is CT6, the central thickness of the seventh lens element is CT7, the central thickness of the eighth lens element is CT8, the maximum among CT1, CT2, CT3, CT4, CT5, CT6, CT7, CT8 is CTmax, an axial distance between the image-side surface of the eighth lens element and an image surface is BL, the focal length of the image capturing optical lens assembly is f, a curvature radius of the object-side surface of the second lens element is R3, a curvature radius of the image-side surface of the second lens element is R4, the curvature radius of the object-side surface of the seventh lens element is R13, a curvature radius of the image-side surface of the eighth lens element is R16, and the following conditions are satisfied:
$$0.03 \leq T 45 / T 56 \leq 0 \text{.37} ;$$
$$0.35 \leq BL / T 12 \leq 0 \text{.81} ;$$
$$- 0.7 \; 5 \leq R 3 / f \leq - 0.48 ;$$
$$0.05 \leq ( T 23 + T 34 + T 45 ) / T 12 \leq 0 \text{.28} ;$$
$$- 1.06 \leq f / R 13 \leq 0 \text{.05} ;$$
$$0.36 \leq CT max / AT max \leq 0.98 ;$$
$$and$$
$$1.44 \leq ( \vert R 3 \vert + \vert R 4 \vert + R 16 ) / f \leq 1.94 .$$

28. An electronic device comprising an imaging apparatus, the imaging apparatus comprising:
the image capturing optical lens assembly of claim 15; and
an image sensor disposed on an image surface of the image capturing optical lens assembly.
